(19) United States
(12) Patent Application Publication
(10) Pub. No.: US 2026/0280469 A1
(43) Pub. Date: Sep. 17, 2026

(54) SOLAR ARRAY ONSITE ASSEMBLY AND DISTRIBUTION

(71) Applicant: M. A. Mortenson Company, Minneapolis, MN (US)

(72) Inventors: Trent Mostaert, Minneapolis, MN (US); Abhishek Kadam, Minneapolis, MN (US)

(73) Assignee: M. A. Mortenson Company, Minneapolis, MN (US)

(21) Appl. No.: 19/668,367

(22) Filed: May 5, 2026

Related U.S. Application Data
(63) Continuation of application No. 19/196,642, filed on May 1, 2025.
(60) Provisional application No. 63/642,472, filed on May 3, 2024.

(51) Int. Cl. H02S 20/10; H02S 30/10

(52) U.S. Cl. CPC H02S 20/10; H02S 30/10

(57) ABSTRACT

A resource management system comprises a user interface and a controller communicably coupled with the user interface. The controller is operable to obtain a geographical map including a plurality of target locations for at least one component. A location determiner is operably coupled to the controller, the location determiner operable to determine a first location of at least a portion of the resource management system. The user interface is operable to display at least one screen layout comprising a first indicator representing the first location, a second indicator representing a current location of a first component of the at least one component, and a third indicator representing at least one target location of the plurality of target locations of the at least one component.

### CROSS REFERENCE TO RELATED APPLICATION(S)

This is a continuation application of U.S. patent application Ser. No. 19/196,642, filed on May 1, 2025, which claims priority to U.S. Provisional Application No. 63/642,472, filed on May 3, 2024, entitled SOLAR ARRAY ONSITE ASSEMBLY AND DISTRIBUTION, the disclosures of which are hereby incorporated by reference in their entireties. To the extent appropriate, a claim of priority is made to each of the above-disclosed applications.

### FIELD

The present disclosure relates generally to apparatuses, systems, and methods for assembling and installing solar arrays at a solar farm. More specifically, the disclosure relates to apparatuses, systems, and methods navigating a worksite at a solar farm, assembling panels onto torque tubes, using temporary brackets for coupling panels onto torque tubes, and transporting assembled torque tubes to the installation site.

### BACKGROUND

Installation of solar farms presents unique challenges including distribution of materials, onsite assembly in sometimes difficult working conditions, wear on materials due to environmental factors such as weather, and so forth. All the various conditions make management of work sites difficult from a resource efficiency perspective including materials, tools, heavy equipment, and human resources.

### SUMMARY

The disclosure relates to apparatuses, systems, and methods navigating a worksite at a solar farm including a resource management platform, assembling panels onto torque tubes via a panel assembly device, using temporary brackets for coupling panels onto torque tubes, and transporting assembled torque tubes to the installation site via specialized equipment for handling the assembly torque tubes. According to one example (“Example 1”), a resource management system is provided including a user interface and a controller communicably coupled with the user interface. The controller is operable to obtain a geographical map including a plurality of target locations for at least one component, and a location determiner operably coupled to the controller, the location determiner operable to determine a first location of at least a portion of the resource management system. The user interface may be operable to display at least one screen layout comprising (i) a first indicator representing the first location, (ii) a second indicator representing a current location of a first component of the at least one component, and (iii) a third indicator representing at least one target location of the plurality of target locations of the at least one component.

In embodiments, the resource management system includes a memory storing instruction that, when executed by the controller, cause the resource management system to receive a first communication from a remote network, the first communication including a status of the at least one component.

In embodiments, the at least one screen layout may include a fourth indicator representing the status of the at least one component.

In embodiments, the status of the at least one component is one of a ready status and a not-ready status.

In embodiments, the plurality of target locations comprises a first class of target locations and a second class of target locations. The at least one component comprises a first component associated with the first class of target locations and a second component associated with the second class of target locations, and the third indicator represents a first target location of the first class of target locations when the at least one component is the first component.

In embodiments, the memory stores additional instructions that, when executed by the controller, cause the resource management system to perform a set of operations comprising providing a prompt to a user via the user interface when the location determiner is sensed at a position proximate to one of the current location of the first component and the at least one target location.

In embodiments, the prompt is selected from a plurality of prompts, wherein each of the plurality of prompts is associated with one of the current location of the at least one component and a target location of the at least one target location of the at least one component.

In embodiments, the set of operations further comprises: providing a confirmation of pickup prompt when the first location is sensed proximate to the current location of the at least one component.

In embodiments, the set of operations further comprises: to providing a confirmation of placement prompt when the first location is sensed proximate to the target location.

In embodiments, the resource management system includes a memory storing instructions that, when executed by the controller, cause the system to perform a set of operations comprising determining pre-staging positions for delivery of a bundle of a plurality of the at least one component.

In embodiments, the resource management system includes a database communicably coupled to the controller, wherein the database is operable to store component information.

In embodiments, the component information comprises an inventory count of the at least one component.

In embodiments, the component information comprises a location of the at least one component.

In embodiments, the at least one component includes a first class of components and a second class of components. Further, the component information includes a first inventory count of the first class of components and a second inventory count of the second class of components.

In embodiments, the resource management system includes a memory storing instructions that, when executed by the controller, cause the resource management system to perform a set of operations comprising providing instructions to the user interface. The instructions may include to display a first indicator on the at least one screen layout representative of the first class of components and a second indicator on the at least one screen layout representative of the second class of components.

In embodiments, the at least one component includes a third class of components, and the set of operations further comprises operating according to a first module associated with the first class of components and a second module associated with the third class of components.

In embodiments, the set of operations further comprises switching between the first module and the second module based upon a user input from a user.

In embodiments, the resource management system includes an optical sensor operably coupled to the controller. Further, the at least one screen layout is a first screen layout, and the set of operations further comprises operating according to a third module displaying a second screen layout including a view of the optical sensor.

In embodiments, the at least one screen layout is a first screen layout, and the set of operations further comprises operating according to a third module displaying a second screen layout. Further, the second screen layout includes viewing a path traveled by a remote vehicle.

In embodiments, the resource management system includes a memory storing instructions that, when executed by the controller, cause the resource management system to perform a set of operations comprising determining a pre-staging position and displaying the pre-staging position on the geographical map.

In embodiments, the set of operations further comprises generating a route map on the geographical map for moving the at least one component between the current location of the at least one component and the at least one target location.

In embodiments, the set of operations further comprises determining a pre-staging position based on the current location of the at least one component and the at least one target location.

In yet another embodiment of the present disclosure, a method is provided. The method includes obtaining, at a controller, a geographical map from a remote network. The geographical map includes a plurality of target locations for at least one component, and the plurality of target locations comprises a first class of target locations for a first component of the at least one component and a second class of target locations for a second component of the at least one component. The method further comprising obtaining, at the controller, a first communication from a remote communication device, the first communication comprising a component identifier indicating the at least one component is one of the first component and the second component. The method further comprising determining, using a GPS sensor, a first location of a utility vehicle and determining, a first intended location of the first class of intended locations when the component identifier is the first component. The method further comprising displaying on a display at least one screen layout, the at least one screen layout including (i) a marker indicating the first location, (ii) a marker indicating a current location of the at least one component, and (iii) a marker indicating the first target location.

In embodiments, the at least one component is a solar assembly.

In embodiments, the first communication comprises a status of the at least one component.

In embodiments, the at least one screen layout further includes (iv) the status of the at least one component.

In embodiments, the method further comprises determining a second target location of a second class of target locations when the component identifier is the second component.

In embodiments, the method further comprises generating a route between the current location of the at least one component and the first target location.

In embodiments, the at least one screen layout includes at least one indicator representative of an inventory of the at least one component.

In embodiments, the at least one indicator comprises a first indicator representative of a first inventory of the first class of component and a second indicator representative of a second inventory of the second class of components.

In yet another embodiment of the present disclosure, a conveying system for assembly of a plurality of solar panels onto a torque tube is provided. The conveying system includes a frame assembly configured to support the torque tube and plurality of solar panels during assembly of the plurality of solar panels onto the torque tube. The frame assembly comprises a first portion including a torque tube support member and a panel support member, the torque tube support member being configured to support at least a portion of the torque tube at a predetermined height as the torque advances along the first portion and the panel support member to position each panel of the plurality of panels proximate the torque tube for securing of each panel to the torque tube. The frame assembly further comprising a second portion positioned adjacent to the first portion and a third portion positioned adjacent to the second portion and defining an egress configured to provide access to the torque tube for removal from the frame assembly. The conveying system further comprising a first conveyance positioned within the first portion of the frame assembly, the first conveyance operable to move at least one of the torque tube and plurality of solar panels at a first rate. The conveying system further comprising a second conveyance positioned with the second portion of the frame assembly, the second conveyance operable to move the torque tube and plurality of solar panels at a second rate that is greater than the first rate.

In embodiments, the panel support member of the first portion of the frame assembly includes a first rail and a second rail, the first rail defining a trough operable to receive an end of each of the plurality of solar panels and the second rail configured to receive a surface of the each of the plurality of solar panels.

In embodiments, the first conveyance is positioned adjacent to the trough.

In embodiments, the second rail provides a surface along which the plurality of panels are configured to translate.

In embodiments, the first portion of the frame assembly includes a bracket support rail configured to support a bracket during assembly of a panel of the plurality of panels onto the torque tube.

In embodiments, the frame extends along a longitudinal axis, and the second conveyance includes a rotating member defining a surface. Further, at least a portion of the surface is configured to move generally parallel to the longitudinal axis toward the third portion of the frame assembly.

In embodiments, the torque tube support member includes a free rotating member.

In embodiments, the frame assembly includes a fourth portion coupled to the first portion, and the fourth portion includes a collection assembly. Further, the collection assembly includes a laterally extending frame member.

In embodiments, the collection assembly defines a collection torque tube raceway extending along a first axis.

In embodiments, the laterally extending frame member is angled downwardly between a position laterally outwardly of the first axis and a position adjacent the first axis.

In embodiments, the collection assembly includes a stop member extending upwardly from the laterally extending frame member.

In embodiments, the collection assembly includes a third conveyance, and the third conveyance includes a rotating member defining a surface. Further, at least a portion of the surface is configured to move generally parallel to the first axis toward the first portion of the frame assembly.

In embodiments, a sprocket may be rotatably coupled to the rotating member about a sprocket axis and a motor may be offset from the sprocket axis. Further, an endless member may be coupled between the motor and the sprocket.

In embodiments, the conveying system includes a frame member defining a portion of an aperture and the aperture is generally aligned with the first axis.

In embodiments, the at least one roller may be positioned adjacent the aperture and the at least one roller defines a rolling axis non-parallel to the first axis.

In embodiments, the at least one roller includes a first roller and a second roller. Further, the first roller defines a first roller axis, the second roller defines a second roller axis offset from the first roller axis, and each of the first roller axis and the second roller axis are non-parallel to the first axis.

In embodiments, the conveying system includes a funnel extending outwardly from the frame member, the funnel generally coaxial with the first axis.

In embodiments, the frame assembly extends along a longitudinal axis and the frame assembly defines a first frame side on a first lateral side of the longitudinal axis. Further, a second frame side on a second lateral side of the longitudinal axis opposite the first frame side, an ingress is positioned on the first frame side, the egress is positioned on the second frame side, and the torque tube support member is positioned on the second frame side and extending generally parallel to the longitudinal axis.

In embodiments, the torque tube support member defines a face with a low coefficient of friction.

In yet another embodiment of the present disclosure, a bracket for temporarily securing a panel to a support member is provided. The bracket includes a body defining a first receiving portion configured to receive a portion of a support member and a second receiving portion configured to receive a portion of a panel. The bracket includes a first clamping member moveably coupled to the body proximate the first receiving portion, and the first clamping member and the body are configured to be secured to and surround the portion of the support member. The bracket also includes a second clamping member moveably coupled to the body proximate the second receiving portion, and the second clamping member and the body are configured to sandwich the portion of the panel.

In embodiments, the bracket includes a first fastener operable to restrict movement of the first clamping member relative to the body when in an engaged configuration.

In embodiments, the first clamping member is hinged relative to the body.

In embodiments, the first fastener is supported by one of the body and the first clamping member.

In embodiments, the first fastener is a tool-less member.

In embodiments, the second receiving portion of the body includes a first substantially planar surface and the second clamping member includes a second substantially planar surface that is positioned substantially parallel to and moveable relative to the first substantially planar surface.

In embodiments, the bracket includes a second fastener, and the second fastener is configured to restrict movement of the second clamping member relative to the body.

In embodiments, the second fastener is a tool-less fastener.

In embodiments, at least one of the first substantially planar surface and the second substantially planar surface includes at least one of a surface texture and surface treatment configured to increase friction or grip on the portion of the panel.

In yet another embodiment of the present disclosure, a removable attachment configured to be removably coupled to a vehicle for transportation of an object at a worksite, the vehicle including a mount and a hydraulic pressure source. The removable attachment includes a mounting portion includes at least one coupling member configured to be removably coupled to the mount of the vehicle. Further, the removable attachment includes a material handling assembly including a grasping assembly configured to secure the object. The grasping assembly includes a contact portion and at least one first actuator coupled to the contact portion and operable to actuate the contact portion. The material handling assembly of the removable attachment includes a lateral movement assembly supporting the grasping assembly, the lateral support member including a second actuator operably coupled to the grasping assembly and operable to cause lateral movement of the grasping assembly.

In embodiments, the mounting portion includes at least one hollow tube member within which forks of a telehandler are received.

In embodiments, the mounting portion includes at least one pin operable to constrain the forks of the telehandler within the at least one hollow tube member.

In embodiments, the at least one hollow tube member extends longitudinally, and the material handling assembly includes at least one secondary hollow tube member extending laterally and supported by the at least one hollow member of the mounting portion.

In embodiments, the material handling assembly includes at least one sliding tube slidably received within the at least one secondary hollow tube m ember, the at least one sliding tube supporting the grasping assembly.

In embodiments, the second actuator is operable to cause the at least one sliding tube to slide within the at least one secondary hollow tube member.

In embodiments, the lateral movement assembly includes wear pads positioned between the at least one sliding tube and the at least one secondary hollow tube member.

In embodiments, the wear pads are shims that are configured to be repositioned after wear.

In embodiments, the contact portion of the grasping assembly includes a first arm and a second arm. Further, the first arm is stationary relative to the at least one sliding member of the lateral movement assembly and the second arm is moveable relative to the at least one sliding member of the lateral movement assembly.

In embodiments, the at least one actuator is operable to translate the second arm toward and away from the first arm.

In embodiments, the first and second arms of the contact portion include receiving surfaces, the receiving surfaces including replaceable grip pads.

In yet another embodiment of the present disclosure a panel assembly device for assembly of a plurality of solar panels onto a torque tube comprises a frame assembly configured to support the torque tube and the plurality of solar panels during assembly of the plurality of solar panels onto the torque tube. The frame assembly comprises a first portion including a torque tube alignment frame and a panel support member. The torque tube alignment frame comprises a plurality of rollers. The plurality of rollers are configured to contact and support at least a portion of the torque tube at a predetermined height as the torque tube advances along the first portion. The panel support member is configured to position a solar panel of the plurality of solar panels proximate the torque tube for securing of the solar panel to the torque tube. A second portion is positioned adjacent to the first portion. A third portion is positioned adjacent to the second portion. The third portion defines an egress configured to provide access to the torque tube of the assembly of the torque tube and the plurality of solar panels for removal from the frame assembly. A conveyance is positioned on the frame assembly, the conveyance is operable to move at least one of the torque tube and the plurality of solar panels.

The foregoing examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an illustration of a vehicle in accordance with an embodiment;

FIG. 2 is a control diagram of a resource management system in accordance with an embodiment;

FIG. 3 is a control diagram of a controller of the resource management system of FIG. 2 in accordance with an embodiment;

FIG. 4 is a screen layout of a display of a first module of the resource management system of FIG. 2 in accordance with an embodiment;

FIG. 5 is a screen layout of a display of a second module of the resource management system of FIG. 2 in accordance with an embodiment;

FIG. 6 is a screen layout of a display of a third module of the resource management system of FIG. 2 in accordance with an embodiment;

FIG. 7 is a process of the resource management system of FIG. 2 in accordance with an embodiment;

FIG. 8 is a screen layout of a display of a fourth module of the resource management system of FIG. 2 in accordance with an embodiment;

FIG. 9 is a screen layout of a display of the fourth module of the resource management system of FIG. 2 in accordance with an embodiment;

FIG. 10 is a screen layout of a display of a fifth module of the resource management system of FIG. 2 in accordance with an embodiment;

FIG. 11 is a screen layout of a display of the fifth module of the resource management system of FIG. 2 in accordance with an embodiment;

FIG. 12 is a screen layout of a display of a sixth module of the resource management system of FIG. 2 in accordance with an embodiment;

FIG. 13 is a screen layout of a display of the sixth module of the resource management system of FIG. 2 in accordance with an embodiment;

FIG. 14 is a screen layout of a display of a seventh module of the resource management system of FIG. 2 in accordance with an embodiment;

FIG. 15 is a process of the resource management system of FIG. 2 in accordance with an embodiment;

FIG. 16 is a perspective view of a panel assembly device in accordance with an embodiment;

FIG. 17 is a portion of the panel assembly device of FIG. 16 in accordance with an embodiment;

FIG. 18 is a portion of the panel assembly device of FIG. 16 in accordance with an embodiment;

FIG. 19 is a side view of the panel assembly device of FIG. 16 in accordance with an embodiment;

FIG. 20 is a perspective view of a base portion of the panel assembly device of FIG. 16 in accordance with an embodiment;

FIG. 21 is a perspective view of a support portion of the panel assembly device of FIG. 16 in accordance with an embodiment;

FIG. 22 is a side view of the support portion of FIG. 21 in accordance with an embodiment;

FIG. 23 is a perspective view of a conveyance of the panel assembly device of FIG. 16 in accordance with an embodiment;

FIG. 24A is a perspective view of a collection frame of the panel assembly device of FIG. 16 in accordance with an embodiment;

FIG. 24B is a side view of the collection frame of FIG. 24A in accordance with an embodiment;

FIG. 24C is a side of a collection assembly of the panel assembly device of FIG. 16 in accordance with an embodiment;

FIG. 25A is a side view of an alignment assembly of the panel assembly device of FIG. 16 in accordance with an embodiment;

FIG. 25B is a perspective view of the alignment assembly of FIG. 25A in accordance with an embodiment;

FIG. 26A is a perspective view of a portion of the panel assembly device of FIG. 16 with a first panel coupled to a torque tube in accordance with an embodiment;

FIG. 26B is a perspective view of a portion of the panel assembly device of FIG. 16 with a first and second panel coupled to a torque tube in accordance with an embodiment;

FIG. 27 is a perspective view of an exit portion of the panel assembly device of FIG. 16 in accordance with an embodiment;

FIG. 28 is a front view of the exit portion of FIG. 27 in accordance with an embodiment;

FIGS. 29A and 29B are illustrations of temporary bracket coupled to a torque tube in accordance with an embodiment;

FIGS. 29C-29E are perspective views of a temporary bracket in accordance with an embodiment;

FIG. 29F is a perspective view of a clamp of a temporary bracket in accordance with an embodiment;

FIG. 30A is a vehicle with an attachment 402 provided for grabbing, transporting, and positioning assembled torque tubes, in accordance with an embodiment;

FIG. 30B is a schematic of the vehicle and attachment of FIG. 30A;

FIGS. 31 and 32 are perspective views of the attachment positioned on a fork, in accordance with an embodiment;

FIG. 33 is an illustration of a coupling of the attachment to forks, in accordance with an embodiment;

FIGS. 34A-34C are various views of an attachment with a lateral movement assembly positioned in various positions, in accordance with an embodiment; and

FIGS. 35-37 are various views of a grasping assembly, in accordance with an embodiment.

FIG. 38 is a perspective view of another example vehicle in accordance with an embodiment;

FIG. 39 is a detailed perspective view of an implement of the utility vehicle of FIG. 38.

FIG. 40 is a screen layout of a display of a eighth module of the resource management system of FIG. 2 in accordance with an embodiment;

FIG. 41 is a screen layout of a display of a ninth module of the resource management system of FIG. 2 in accordance with an embodiment;

FIG. 42 is a screen layout of a display of a tenth module of the resource management system of FIG. 2 in accordance with an embodiment;

FIG. 43 is a screen layout of a display of a eleventh module of the resource management system of FIG. 2 in accordance with an embodiment;

FIG. 44 is a perspective view of a panel assembly device in accordance with a second embodiment;

FIG. 45 is a perspective view of a first portion of the panel assembly device of FIG. 44;

FIG. 46 is another perspective view of the first portion of the panel assembly device of FIG. 44;

FIG. 47 is a perspective view of an second portion of the panel assembly device of FIG. 44;

FIG. 48 is a perspective view of a lower panel support portion of the second portion of FIG. 47.

FIG. 49 is a side view of the second portion of the panel assembly device of FIG. 44 with a panel 14 inserted therein.

FIG. 50 is a perspective view of a panel top support portion of the second portion of FIG. 47.

FIG. 51 is a perspective view of a third portion of the panel assembly device of FIG. 44.

FIG. 52 is a perspective view of a fourth portion of the panel assembly device of FIG. 44.

FIG. 53 is a rear perspective view of a first tower assembly of the fourth portion of FIG. 52.

FIG. 54 is a rear view of the fourth portion of the panel assembly device of FIG. 16.

FIG. 55 is a side view of the fourth portion of the panel assembly device of FIG. 16.

FIG. 56 is a rear perspective view of the fourth portion of the panel assembly device of FIG. 16.

FIG. 57 is a rear perspective view of another example attachment of the vehicle of FIG. 30A.

FIG. 58 is a detailed perspective view of the attachment of FIG. 57.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Onsite assembly of solar farms require many different materials, tools and resources to accomplish the task. Typically, solar farms are installed on large parcels of land which require movement of materials around the worksite in a safe and efficient manner. One aspect of the present disclosure relates to the coordination of the distribution of materials on the worksite. Those materials range from piles 10 in their various forms and sizes, torque tubes 12, panels 14, and so forth. A resource management platform 100 is provided for distributing and installing those materials at the worksite in an efficient manner, including distribution to their installation or target position as well as distribution to staging positions.

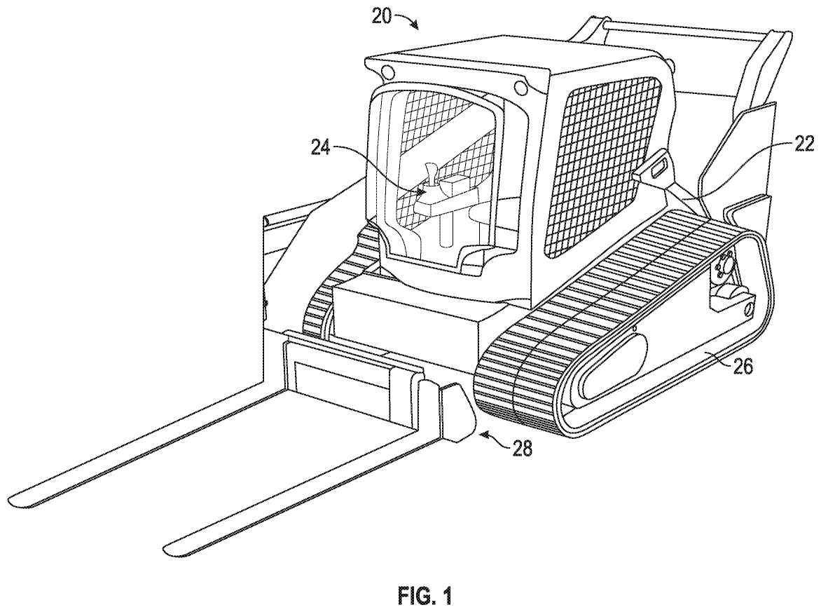

Referring now to FIG. 1, a utility vehicle 20 includes a cab portion 22 including a set of controls 24. The vehicle 20 includes at least one ground engaging member 26. In embodiments, the at least one ground engaging member 26 includes a plurality of ground engaging members 26 and may be one or more tracks, wheels, or other ground engaging members. The vehicle 20 may also include an implement 28 which may be a utility implement. In embodiments, the utility implement 28 is a movable fork. In embodiments, the controls 24 may be one or more of a joystick, steering wheel, inputs, display, or other controls. The controls 24 may be used to control movement of the one or more of the ground engaging members 26 or to control movement of the utility implement 28. In embodiments, the utility implement 28 may include one or more tools, such as a bracket, a pile driver, a fastener, or another type of the utility implement 28.

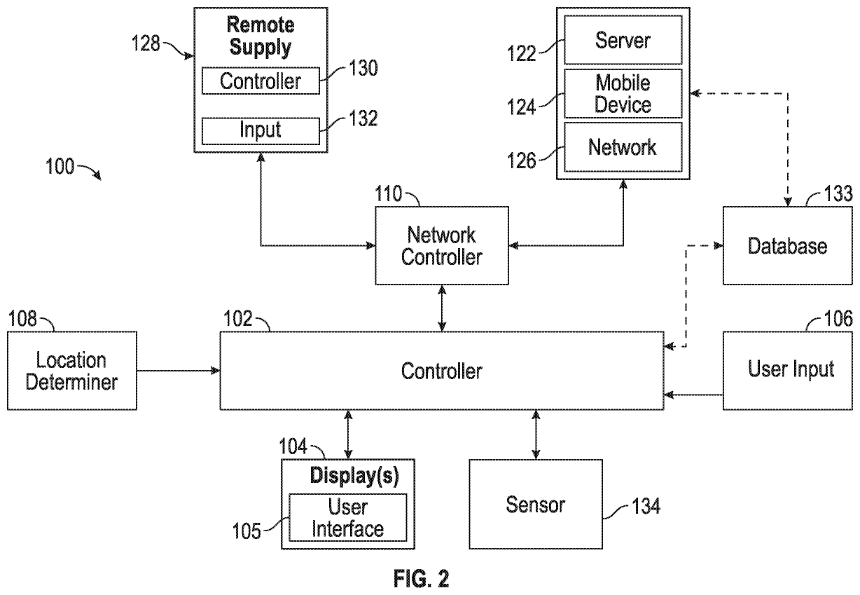

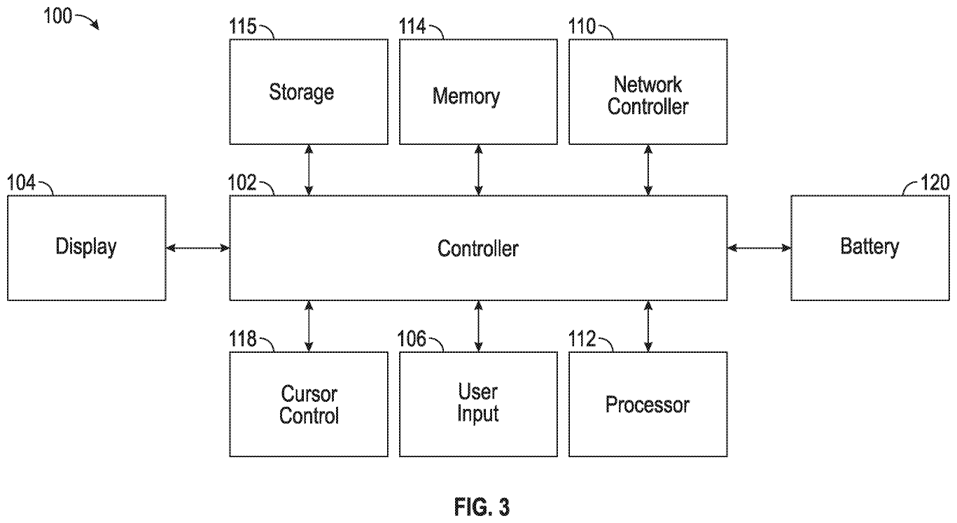

Referring now to FIGS. 2-3, the resource management platform 100 includes a controller 102 operably coupled to a user interface or display 104, a user input 106 and a location determiner 108. In embodiments, the display 104 is an LCD display, an LED display, a touch screen display, a cathode ray tube (CRT) display, or another type of display. In embodiments, the user input 106 is on the display 104, or may be separate from the display 104. In embodiments, the display 104 is at least one display 104, and may be two displays, three displays, or more displays. In embodiments, the location determiner 108 is a global positioning system (GPS) receiver and is operable to provide a location of a portion of the resource management system (e.g., the controller 102, the display 104, the vehicle 20). In embodiments, at least one sensor 134 may be operably coupled to controller 102. In embodiments, sensor 134 may be an optical sensor, a camera, an ultrasonic sensor, a lidar sensor, a radar sensor, or another type of sensor 134 as appropriate.

Still referring to FIGS. 2-3, the resource management platform 100 includes a network controller 110 communicably coupled to the controller 102. The network controller 110 may be operable to communicably couple the controller 102 to a server 122, a mobile device 124, a network 126 or another type of network-based device. In embodiments, the server 122 may be a remote server, the mobile device 124 may be a remote device such as a cell phone, a computer, or another type of mobile device. In embodiments, the network 126 may be a Bluetooth network, a wi-fi network, a cellular network, or another type of wireless network. In embodiments, the controller 102 may be operably coupled to a database 133 which may store, temporarily or indefinitely, information related to the resource management platform 100. In embodiments, the database 133 is communicably coupled to one or more of the server 122, the mobile device 124, and the network 126, and the controller 102 is communicably coupled to the database 133 through the network controller 110. In embodiments, the database 133 is directly coupled to the controller 102 independent of the network controller 110.

In embodiments, the resource management platform 100 includes one or more remote components. In embodiments, the resource management platform 100 includes a remote supply source 128 which may include a controller 130 and an input 132.

Still referring to FIGS. 2-3, the resource management platform 100 may include a processor 112 operably coupled to the controller 102 and a memory 114 which may store instructions to be executed by the processor 112 at the controller 102. A storage 115 (e.g., a disc drive) may be communicably coupled to the controller 102 to store data, maps, lists, tables, or other information related to the resource management platform 100. In embodiments, a cursor control 118 may be coupled to the controller 102 which may control movement around the display 104 and a battery 120 may be operably coupled to the controller 102 and the battery 120 may be used to provide power to the controller 102, the display(s) 104, and other components of the resource management platform 100. In embodiments, the cursor control 118 may represent a touch screen control of the display 104.

Referring still to FIGS. 2-3, the memory 114 may store instructions, which may include one or more screen layouts 105, which may be displayed on one or more of the display(s) 104.

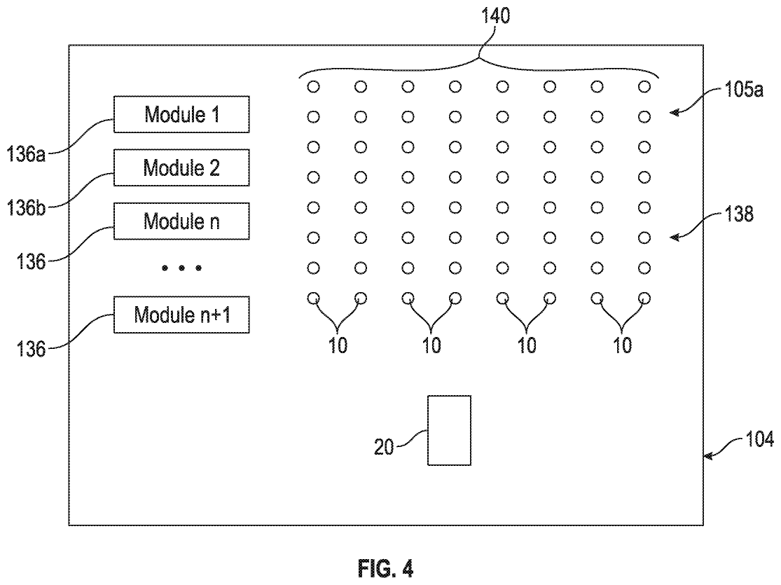

Referring now to FIG. 4, the display 104 (see FIG. 2) may be positioned within the cab portion 22 (see FIG. 1) of the utility vehicle 20 (see FIG. 1). The controller 102 (see FIG. 2) may be operable to display a first screen layout 105a on the display 104 which may include one or more selectable inputs 136a, 136b, etc. which may each correspond to a separate Module, or Operating Mode. In one embodiment, the selectable input 136a corresponds to a first Module and the selectable input 136b corresponds to a second Module. In embodiments, the selectable input 136a corresponds to the first Module displaying the first screen layout 105a.

Still referring to FIG. 4, the first screen layout 105a may display a geographical map 138 which shows a component layout 140 (e.g., arrangement of the piles 10, the torque tubes 12, the panels 14) on the geographical map 138. In embodiments, the controller 102 (see FIG. 2) is operable to download the geographical map 138 by the network controller 110 (see FIG. 2) from one or more of the server 122 (see FIG. 2), the mobile device 124 (see FIG. 2), or the network 126 (see FIG. 2). In embodiments, the controller 102 is operable to download the component layout 140 (e.g., a matrix of piles 10) which is overlaid on the geographical map 138 from one or more of the server 122, the mobile device 124, or the network 126. In embodiments, the component layout 140 is a targeted component layout and describes a target position for various components (e.g., the piles 10, the torque tubes 12, the panels 14). In embodiments, the screen layout 105a displays a view of vehicle 20 ((see FIG. 1); i.e., the position of vehicle 20) relative to the geographical map 138 and the component layout 140.

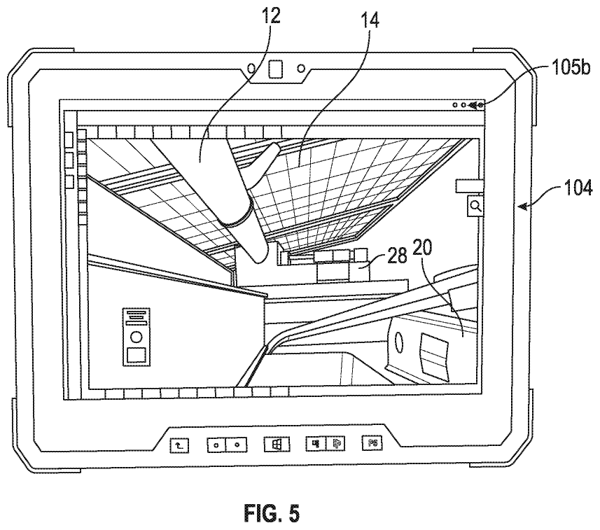

Referring now to FIG. 5, the display 104 (see FIG. 2) may be positioned within the cab portion 22 (see FIG. 1) of the utility vehicle 20 (see FIG. 1). In embodiments, the controller 102 (see FIG. 2) may be operable to execute instructions from the memory 114 (see FIG. 3), including displaying a second screen layout 105b, and the selectable input 136b (see FIG. 4) corresponds to the second Module displaying the second screen layout 105b which may display a view from sensor 134 (see FIG. 2). In embodiments, the second screen layout 105b may display a view from the sensor 134 positioned adjacent the implement 28 (see FIG. 1) and an operator (e.g., seated within cab portion 22) may better visualize the proximity of implement 28 to various other components. In embodiments, the second screen layout 105b may display a view of the implement 28 in proximity to or adjacent to the torque tubes 12 and the panels 14. In embodiments, the controller 102 may be operable to display the second screen layout 105b and the visual output from the sensor 134 when the second Module (e.g., the selectable input 136b) is selected.

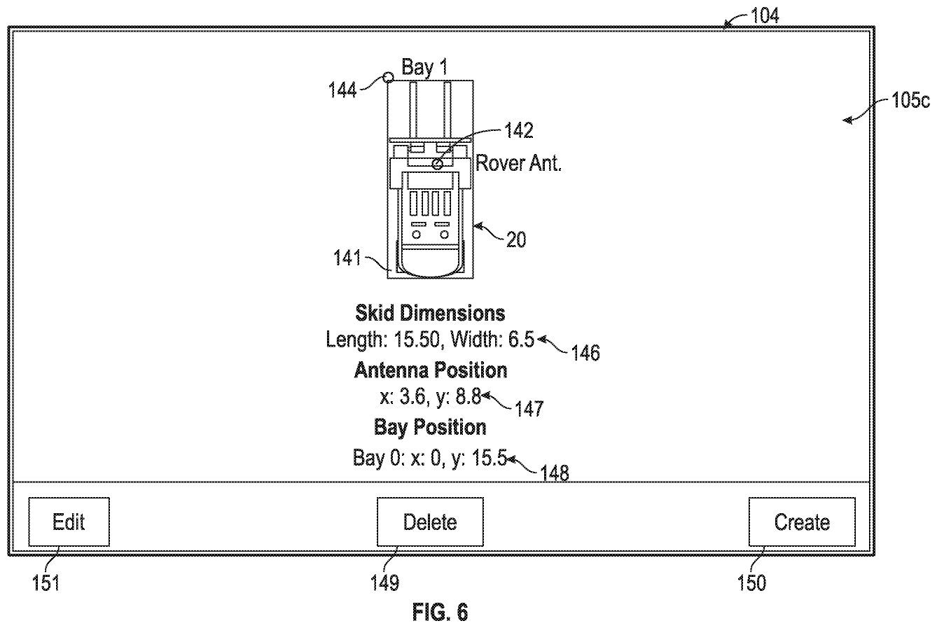

Referring now to FIG. 6, the controller 102 (see FIG. 2) may be operable to facilitate a calibration process of the resource management platform 100 (see FIG. 2). In embodiments, the controller 102 may be operable to execute instructions from the memory 114 (see FIG. 3), including displaying on the display 104 (see FIG. 2) a third screen layout 105c and the selectable input 136 ((see FIG. 4), e.g., a third selectable input) corresponds to a third Module displaying the third screen layout 105c, including a representation of vehicle 20 (see FIG. 1) and a visual indication of an antenna location 142 (e.g., location determiner 108 (see FIG. 2)) on the vehicle 20. In embodiments, the vehicle 20 includes a plurality of bay positions (e.g., within implement 28) and the third screen layout 105c may also include a visual indication of a bay location 144 of at least one bay of the plurality of bay positions on the vehicle 20 and relative to the antenna location 142. In embodiments, the implement 28 includes a plurality of bay positions which define predetermined locations for components (e.g., piles 10) within implement 28. That is, implement 28 may be operable to hold two piles 10 in predetermined bay positions. In embodiments, implement may be operable to hold three piles 10, four piles 10, five piles 10, six piles 10, or more piles in predetermined bay positions. In embodiments, controller 102 may be operable to execute instructions from the memory 114, including displaying on the display locations of one or more of the bay positions of implement 28, and each bay position may have a predetermined coordinate (e.g., a relative coordinate or an absolute coordinate) accessible by the controller 102. In embodiments, the screen layout 105c defines a vehicle profile 141 of the vehicle 20 and also displays a set of dimensions 146 of the vehicle profile 141. In embodiments, the screen layout 105c displays a dimensional coordinate 147 of the antenna location 142 and a dimensional coordinate 148 of at least one bay location 144.

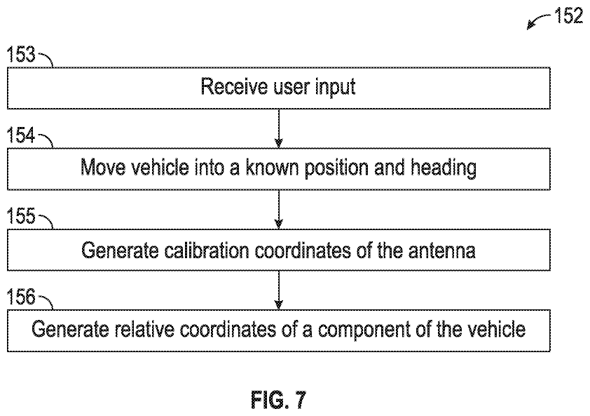

Still referring now to FIG. 6, the screen layout 105c includes a first selectable input 149, a second selectable input 150, and a third selectable input 151 which may assist in the calibration process of the relative positions of the antenna location 142 and the at least one bay location 144. In embodiments, the first selectable input 149 may be a selectable input labeled ‘DELETE’ and may delete any current calibration (e.g., the current relative coordinates of the antenna location 142 and at least one bay location 144). In embodiments, the second selectable input 150 is a selectable input labeled ‘CREATE’ and may be used to start a calibration sequence 152 (FIG. 7). The calibration sequence 152 includes receiving a user input (e.g., at a second selectable input 150) as indicated in a block 153 (FIG. 7), and subsequently moving the vehicle 20 into a known or predetermined position and heading (e.g., at a predetermined spot on the geographical map 138 with a ‘NORTH’ heading), as indicated in a block 154 (FIG. 7). In embodiments, block 153 and block 154 are switched and the vehicle 20 is first moved into a known or predetermined position and heading (e.g., at a predetermined spot on the geographical map 138 with a ‘NORTH’ heading) and a user subsequently selects the second selectable input 150 to generate one or more calibration coordinates of the antenna or GPS, as indicated in a block 155 (FIG. 7) and to generate one or more calibration coordinates of a component of the vehicle 20 (e.g., a bay of the plurality of bays), as indicated by a block 156 (FIG. 7). That is, the calibration sequence 152 may be used to generate the locations 142, 144 on the vehicle 20. The locations 142, 144 may be used to determine relative locations to at least one component (e.g., the piles 10, the torque tubes 12, the panels 14), as further described below.

Referring again to FIG. 6, the screen layout 105c includes the third selectable input 151 which may be selected to edit one or more of the calibration coordinates. In embodiments, the calibration coordinates may be edited manually or automatically.

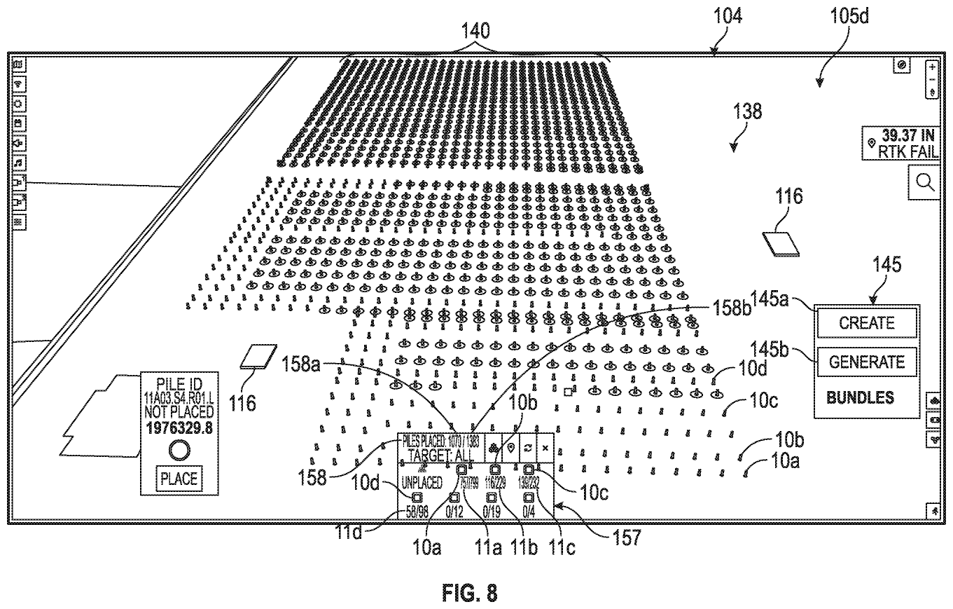

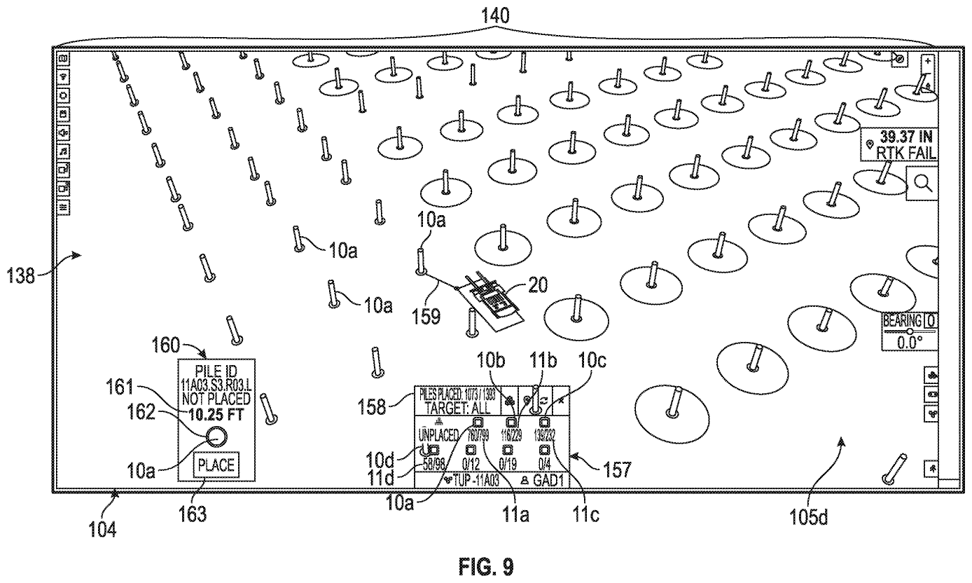

Referring now to FIGS. 8-9, the controller 102 (FIG. 2) may be operable to execute instructions from the memory 114 (FIG. 3), including displaying on the display 104 (FIG. 2) a fourth screen layout 105d and the selectable input 136 ((FIG. 4); e.g., a fourth selectable input) corresponds to a fourth Module displaying the fourth screen layout 105d. The fourth screen layout 105d may include the geographical map 138 and the component layout 140. The component layout 140 may display at least one component and may display a plurality of components. In embodiments, the component layout 140 includes a first class of components (e.g., first class of piles 10a), a second class of components (e.g., second class of piles 10b), a third class of components (e.g., third class of piles 10c), and a fourth class of components (e.g., fourth class of piles 10d). In embodiments, the fourth screen layout 105d is representative of a component layout 140 for the piles 10. In embodiments, the varying classes of piles 10 may be similar but distinct. That is, the classes of piles 10 may represent similar piles 10 that have distinct characteristics (e.g., distinct fasteners, electrical couplings, etc.). It may be helpful and efficient to place specific classes or types of components in specific places or orientations to ensure the proper installation and assembly of the various components of the solar field (e.g., piles 10, torque tubes 12, panels 14).

Still referring to FIGS. 8-9, the component layout 140 displays distinct indicators for the various classes of components (e.g., piles 10). In embodiments, the first class of piles (e.g., first class 10a) is displayed on the fourth screen layout 105d with a first indicator of a first color, the second class of piles (e.g., second class 10b) is displayed on the fourth screen layout 105d with a second color, the third class of piles (e.g., third class 10c) is displayed on the fourth screen layout 105d with a third color, and the fourth class of piles (e.g., fourth class 10d) is displayed on the fourth screen layout 105d with a fourth color.

Still referring to FIGS. 8-9, the fourth screen layout 105d may include an inventory 157 which may include inventory indicators for each class of component (e.g., the first class 10a has an inventory indicator 11a, the second class 10b has an inventory indicator 11b, the third class 10c has an inventory indicator 11c, the fourth class 10d has an inventory indicator 11d). The inventory 157 may include a total count 158 which provides a proportion of the number of components (e.g., piles 10) that have been placed (e.g., placed components 158a) to the total number of components that need to be placed (e.g., total components 158b). In embodiments, the inventory 157 may include a proportion of the number of components that have been placed to the total number of components that need to be placed for each class of components.

Referring now to FIG. 9, the fourth screen layout 105d may include an indicator of the vehicle 20 and a route 159 between the vehicle 20 and a targeted location or targeted component location within the component array 140.

Referring still to FIG. 9, the fourth screen layout 105d may include a component status indicator 160 which includes a distance 161 between the vehicle 20 (FIG. 1) and the targeted component location. The screen layout 105d may also include an indicator 162 representative of the component class (e.g., the first class 10a, the second class 10b, the third class 10c, the fourth class 10d) and a selectable input 163. The selectable input 163 may be labeled ‘PLACE’ and a user may select the input 163 when an operator of the vehicle 20 places a respective component at the target component location. Selecting the input 163 may update the inventory 157 (e.g., the number of placed components may be updated). In embodiments, the class of components is identified by the indicator 162 and each component inventory is updated for the respective class of components identified by the indicator 162 within the inventory 157 when the selectable input 163 is selected.

Referring again to FIG. 8, the fourth screen layout 105d may include a component bundle indicator 145 which may be used to create and track pre-staged bundles of components (e.g., an accumulation of components grouped together in general proximity to each other to increase efficiency of vehicle 20 moving between components and target locations of components). In embodiments, the component bundle indicator 145 includes a first selectable input 145a and a second selectable input 145b. In embodiments, the first selectable input 145a is an input labeled CREATE and used to originate a pre-staged bundle of components. That is, a user of the vehicle 20 (FIG. 1) may select the first selectable input 145a when the vehicle 20 is positioned at a target bundle location for the pre-staged bundle of components. That is, in response to an input at the first selectable input 145a, an indicator 116 may be placed on geographical map 138 at the target bundle location so that a user of the vehicle 20 may visualize the location of the pre-staged bundle of components on the display 104. In embodiments, the second selectable input 145b is an input labeled GENERATE and in response to an input at the second selectable input 145b, the controller 102 may be operable to generate a bundle list of piles 10 which are next up to be placed. That is, an operator of the vehicle 20 may be in a position to place a subsequent row of piles 10 that includes a first number of piles 10a, a second number of piles 10b, a third number of piles 10c, and any number of piles for any class of piles 10. In embodiments, in response to an input to second selectable input 145b, the controller 102 is operable to generate the bundle list including an inventory of the piles 10 required in the subsequent row of piles 10. In one example, the next row requires four piles 10a, three piles 10b, and three piles 10c. Controller 102 is operable to generate an inventory of the bundle list, and display the inventory of the bundle list on display 104, including the four piles 10a, three piles 10b, and three piles 10c. An operator of vehicle 20 may subsequently move to one of the pre-staged bundle locations, or another location, and retrieve the inventory of the bundle list (e.g., four piles 10a, three piles 10b, three piles 10c) and bring them back to the next row. Referring to FIG. 8, the fourth screen layout 105d may include one or more of the indicators 116 representing a location of the pre-staged remote supply (e.g., remote supply 128) of the piles 10. In embodiments, the remote supply indicated by the indicator 116 is a pre-staged supply of components (e.g., piles 10) to provide a shorter route for vehicle 20 to travel between the pre-staged supply and the target location of the at least one component.

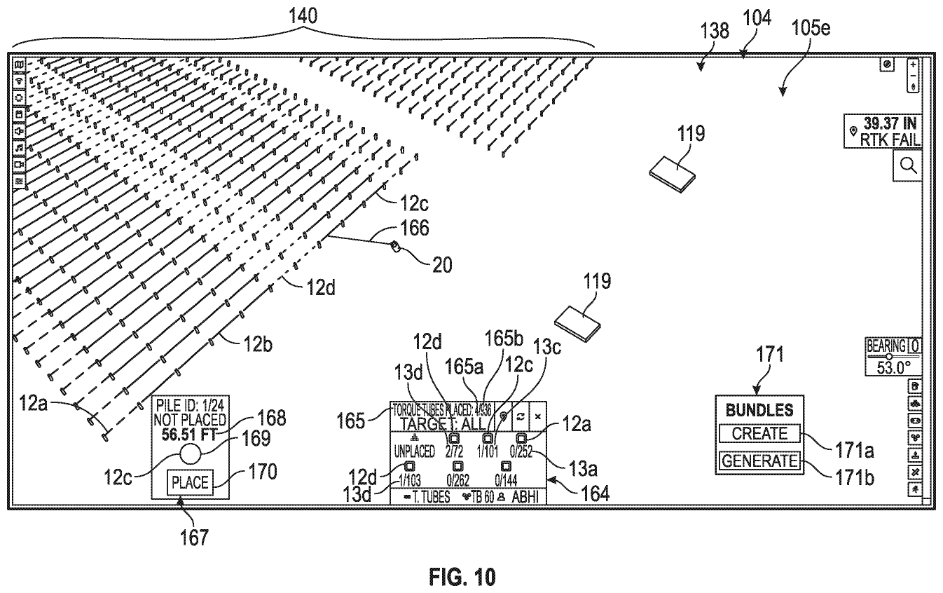

Referring now to FIG. 10, the controller 102 (FIG. 2) may be operable to execute instructions from the memory 114 (FIG. 3), including displaying on the display 104 (FIG. 2) a fifth screen layout 105e and the selectable input 136 ((FIG. 4); e.g., a fifth selectable input) corresponds to a fifth Module displaying the fifth screen layout 105e. The fifth screen layout 105e may include the geographical map 138 and the component layout 140. The component layout 140 may display at least one component (e.g., torque tubes) and may display a plurality of components. In embodiments, the component layout 140 includes a first class of components (e.g., first class of torque tubes 12a), a second class of components (e.g., second class of torque tubes 12b), a third class of components (e.g., third class of torque tubes 12c), and a fourth class of components (e.g., fourth class of torque tubes 12d). In embodiments, the fifth screen layout 105e is representative of a component layout 140 for torque tubes 12. In embodiments, the varying classes of torque tubes 12 may be similar but distinct. That is, the classes of torque tube 12 may represent similar torque tubes 12 that have distinct characteristics (e.g., distinct fasteners, electrical couplings, etc.). It may be helpful and efficient to place specific classes or types of components in specific places or orientations to ensure the proper installation and assembly of the various components of the solar field (e.g., piles 10, torque tubes 12, panels 14).

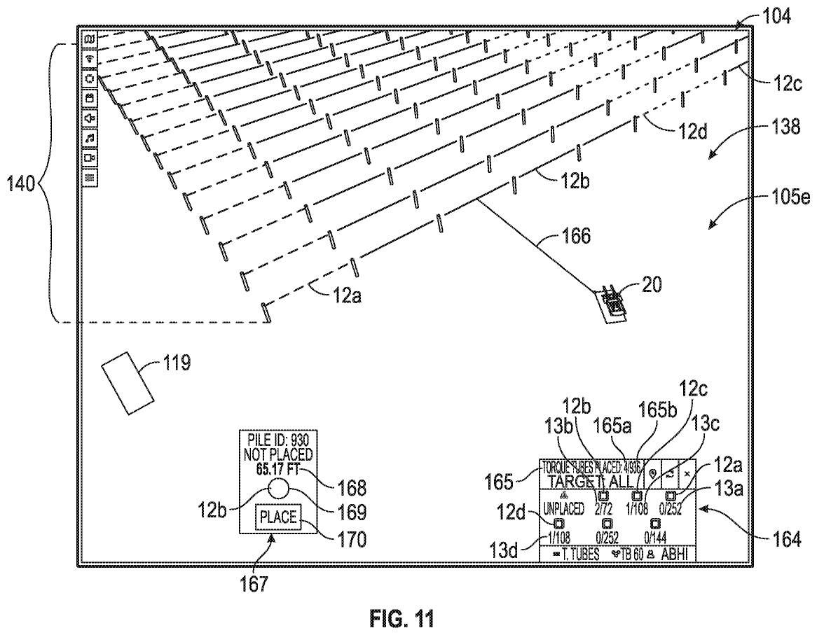

Still referring to FIGS. 10-11, the component layout 140 displays distinct indicators for the various classes of components (e.g., torque tubes 12). In embodiments, the first class of torque tubes (e.g., first torque tube 12a) is displayed on the fifth screen layout 105e with a first indicator of a first color, the second class of torque tubes (e.g., second torque tube 12b) is displayed on the fifth screen layout 105e with a second color, the third class of torque tubes (e.g., third torque tube 12c) is displayed on the fifth screen layout 105e with a third color, and the fourth class of torque tubes (e.g., fourth torque tube 12d) is displayed on the fifth screen layout 105e with a fourth color.

Still referring to FIGS. 10-11, the fifth screen layout 105e may include an inventory 164 which may include inventory indicators for each class of component (e.g., first class 12a has an inventory indicator 13a, second class 12b has an inventory indicator 13b, third class 12c has an inventory indicator 13c, fourth class 12d has an inventory indicator 13d). The inventory 164 may include a total count 165 which provides a proportion of the number of components (e.g., torque tubes 12) that have been placed (e.g., placed components 165a) to the total number of components that need to be placed (e.g., total components 165b). In embodiments, the inventory 164 may include a proportion of the number of components that have been placed to the total number of components that need to be placed for each class of components.

Referring now to FIG. 11, the fifth screen layout 105e may include an indicator of the vehicle 20 (FIG. 1) and a route 166 between the vehicle 20 and a targeted location or targeted component location within the component array 140.

Referring still to FIG. 11, the fifth screen layout 105e may include a component status indicator 167 which includes a distance 168 between the vehicle 20 and the targeted component location. The fifth screen layout 105e may also include an indicator 169 representative of the component class (e.g., first class 12a, second class 12b, third class 12c, fourth class 12d) and a selectable input 170. The selectable input 170 may be labeled ‘PLACE’ and a user may select the input 170 when an operator of the vehicle 20 places a respective component at the target component location. Selecting the input 170 may update the inventory 164 (e.g., the number of placed components may be updated). In embodiments, the class of components is identified by the indicator 169 and each component inventory is updated for the respective class of components identified by the indicator 169 within the inventory 164 when the selectable input 170 is selected.

Referring again to FIG. 10, the fifth screen layout 105e may include a component bundle indicator 171 which may be used to create and track pre-staged bundles of components (e.g., an accumulation of components grouped together in general proximity to each other to increase efficiency of vehicle 20 moving between components and target locations of components). In embodiments, the component bundle indicator 171 includes a first selectable input 171a and a second selectable input 171b. In embodiments, the first selectable input 171a is an input labeled CREATE and used to originate a pre-staged bundle of components. That is, a user of the vehicle 20 (FIG. 1) may select the first selectable input 171a when the vehicle 20 is positioned at a target bundle location for the pre-staged bundle of components. That is, in response to an input to the first selectable input 171a, an indicator 119 may be placed on geographical map 138 at the target bundle location so that a user of the vehicle 20 may visualize the location of the pre-staged bundle of components on the display 104. In embodiments, the second selectable input 171b is an input labeled GENERATE and in response to an input at second selectable input 171b, controller 102 may be operable to generate a bundle list of torque tubes 12 and panels 14 which are next up to be placed. That is, an operator of vehicle 20 may be in a position to place a subsequent row of torque tubes 12 and/or panels 14 that includes, in one example, a first number of torque tubes 12a, a second number of torque tubes 12b, a third number of torque tubes 12c, and any number of torque tubes for any class of torque tubes 12. In embodiments, in response to an input to the second selectable input 171b, the controller 102 is operable to generate the bundle list including an inventory of the torque tubes 12 and/or panels 14 required in the subsequent row of the torque tubes 12 and/or panels 14. In one example, the next row requires four torque tubes 12a, three torque tubes 12b, and torque tubes 12c. Controller 102 is operable to generate an inventory of the bundle list, and display the inventory of the bundle list on display 104, including the four torque tubes 12a, three torque tubes 12b, and three torque tubes 12c. An operator of the vehicle 20 may subsequently move to one of the pre-staged bundle locations, or another location, and retrieve the inventory of the bundle list (e.g., four torque tubes 12a, three torque tubes 12b, three torque tubes 12c) and bring them back to the next row. Referring to FIG. 10, the fifth screen layout 105e may include one or more of the indicators 119 representing a location of the pre-staged remote supply (e.g., remote supply 128) of the torque tubes 12 and/or the panels 14. In embodiments, the remote supply indicated by the indicator 119 is a pre-staged supply of components (e.g., torque tubes 12 and/or panels 14) to provide a shorter route for vehicle 20 to travel between the pre-staged supply and the target location of the at least one component.

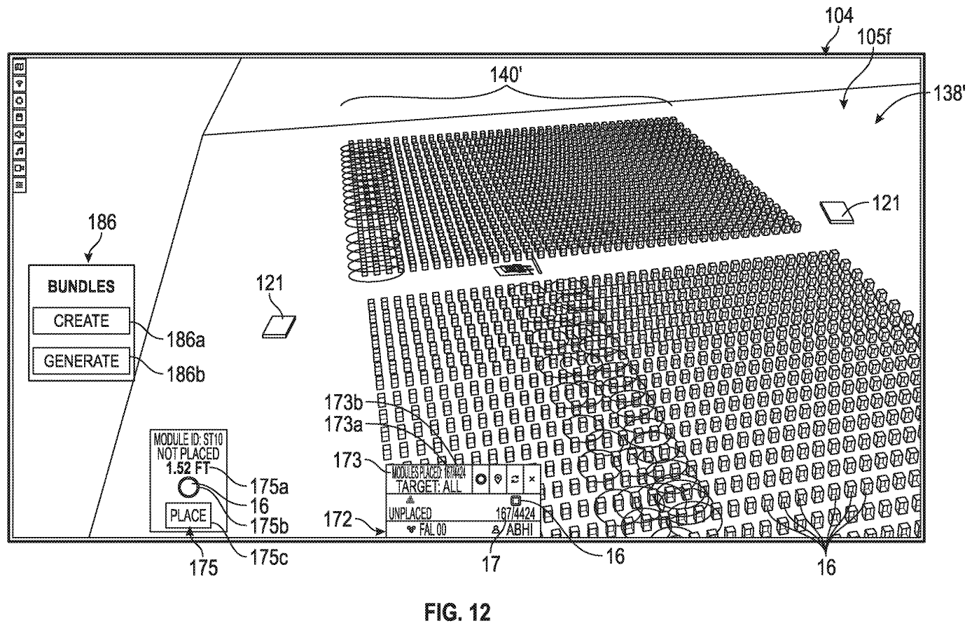

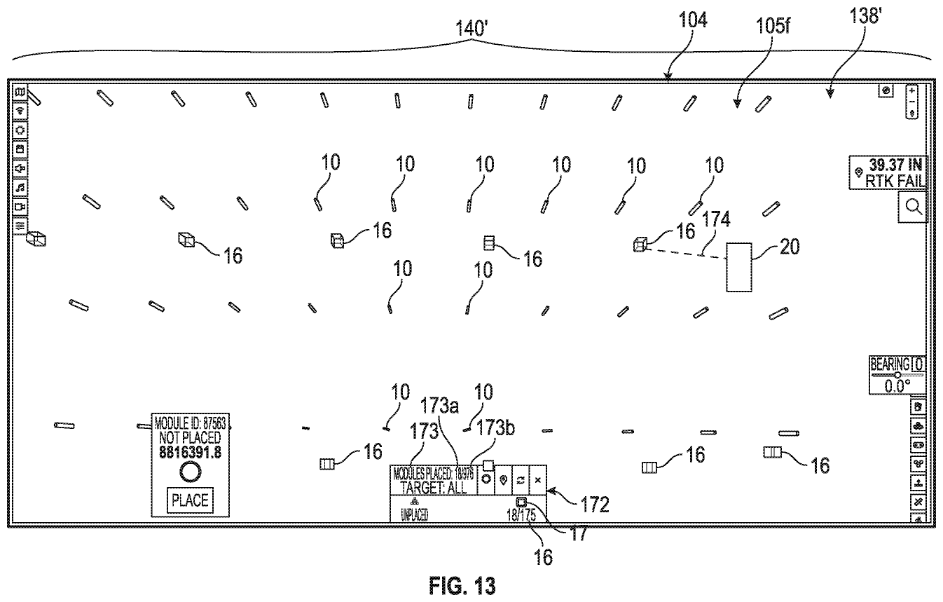

Referring now to FIGS. 12-13, the controller 102 (FIG. 2) may be operable to execute instructions from the memory 114 (FIG. 3), including displaying on the display 104 (FIG. 2) a sixth screen layout 105f and the selectable input 136 ((FIG. 4); e.g., a sixth selectable input) corresponds to a sixth Module displaying the sixth screen layout 105f. The sixth screen layout 105f may include a geographical map 138′ and a component layout 140′ including the piles 10 and a plurality of modules 16. In embodiments, the geographical map 138′ of sixth screen layout 105f shows component layout 140′ (e.g., arrangement of the piles 10 and modules 16) on the geographical map 138′. In embodiments, the controller 102 (see FIG. 2) is operable to download the geographical map 138′ by the network controller 110 (see FIG. 2) from one or more of the server 122 (see FIG. 2), the mobile device 124 (see FIG. 2), or the network 126 (see FIG. 2). In embodiments, the controller 102 is operable to download the component layout 140′ (e.g., a matrix of piles 10) which is overlaid on the geographical map 138′ from one or more of the server 122, the mobile device 124, or the network 126. In embodiments, the component layout 140 is a targeted component layout and describes a target position for various components (e.g., the piles 10, the torque tubes 12, the panels 14). In embodiments, the screen layout 105a displays a view of vehicle 20 ((see FIG. 1); i.e., the position of vehicle 20) relative to the geographical map 138′ and the component layout 140′.

The component layout 140′ may display at least one component (e.g., a module 16) and may display a plurality of components (e.g., a plurality of piles 10 and a plurality of modules 16). In embodiments, the modules 16 are arrangements (e.g., groups) of raw materials, partially-assembled materials, or assembled materials which may be placed at predetermined locations (e.g., the locations of modules 16 in FIGS. 12-13). In embodiments, the modules 16 include one or more torque tubes 12, one or more panels 14, and associated materials to assembly the torque tubes 12 and panels 14 to the piles 10. In embodiments, modules 16 may include fasteners, adhesives, brackets, electrical wiring, electrical motors, power transmission components (e.g., gears, belts), and other components.

Still referring to FIGS. 12-13, modules 16 may be placed or positioned interspersed within piles 10 to provide a plurality of central locations for material to be staged for assembling torque tubes 12 and panels 14.

Still referring to FIGS. 12-13, the sixth screen layout 105f may include an inventory 172 which may include an inventory indicator 17 for the modules 16. The inventory 172 may include a total count 173 which provides a proportion of the number of components (e.g., modules 16) that have been placed (e.g., placed components 173a) to the total number of components that need to be placed (e.g., total components 173b).

Referring now to FIG. 12, the sixth screen layout 105f may include an indicator of the vehicle 20 (FIG. 1) and a route 174 between the vehicle 20 and a targeted location or targeted component location within the component array 140.

Referring still to FIG. 12, the sixth screen layout 105f may include a component status indicator 175 which includes a distance 175a between the vehicle 20 (FIG. 1) and the targeted component location. The sixth screen layout 105f may also include an indicator 175b representative of the component (e.g., module 16) and a selectable input 175c. The selectable input 175c may be labeled ‘PLACE’ and a user may select the input 175c when an operator of the vehicle 20 places a respective component at the target component location. Selecting the input 175c may update the inventory 172 (e.g., the number of placed components may be updated). In embodiments, the modules 16 are represented by the indicator 175b and the inventory indicator 17 is updated within the inventory 172 when the selectable input 175c is selected.

Referring again to FIG. 12, the sixth screen layout 105f may include a component bundle indicator 186 which may be used to create and track pre-staged bundles of components (e.g., an accumulation of components grouped together in general proximity to each other to increase efficiency of vehicle 20 moving between components and target locations of components). In embodiments, the component bundle indicator 186 includes a first selectable input 186a and a second selectable input 186b. In embodiments, the first selectable input 186a is an input labeled CREATE and used to originate a pre-staged bundle of components. That is, a user of the vehicle 20 (FIG. 1) may select the first selectable input 186a when the vehicle 20 is positioned at a target bundle location for the pre-staged bundle of components. In response to an input to first selectable input 186a, an indicator 121 may be placed on geographical map 138′ at the target bundle location so that a user of the vehicle 20 may visualize the location of the pre-staged bundle of components on the display 104. In embodiments, the second selectable input 186b is an input labeled GENERATE and in response to an input at second selectable input 186b, controller 102 may be operable to generate a bundle list of modules 16 which are next up to be placed. That is, an operator of vehicle 20 may be in a position to place a subsequent row of modules 16 that includes, in one example, a first number of a first type of modules 16, a second number of a second type of modules 16, a third number of a third type of modules 16, and any number of modules for any class of torque tubes 12. In embodiments, in response to an input to second selectable input 171b, controller 102 is operable to generate the bundle list including an inventory of the modules 16 required in the subsequent row of modules 16. In one example, the next row requires four of the first type of modules 16, three of the second type of modules 16, and three of the third type of modules 16. The controller 102 is operable to generate an inventory of the bundle list, and display the inventory of the bundle list on the display 104, including the four of the first type of modules 16, three of the second type of modules 16, and three of the third type of modules 16. An operator of the vehicle 20 may subsequently move to one of the pre-staged bundle locations, or another location, and retrieve the inventory of the bundle list (e.g., four of the first type of modules 16, three of the second type of modules 16, and three of the third type of modules 16) and bring them back to the next row. Referring to FIG. 12, the sixth screen layout 105f may include one or more of the indicators 121 representing a location of the pre-staged remote supply (e.g., remote supply 128) of the modules 16. In embodiments, the remote supply indicated by the indicator 121 is a pre-staged supply of components (e.g., modules 16) to provide a shorter route for vehicle 20 to travel between the pre-staged supply and the target location of the at least one component.

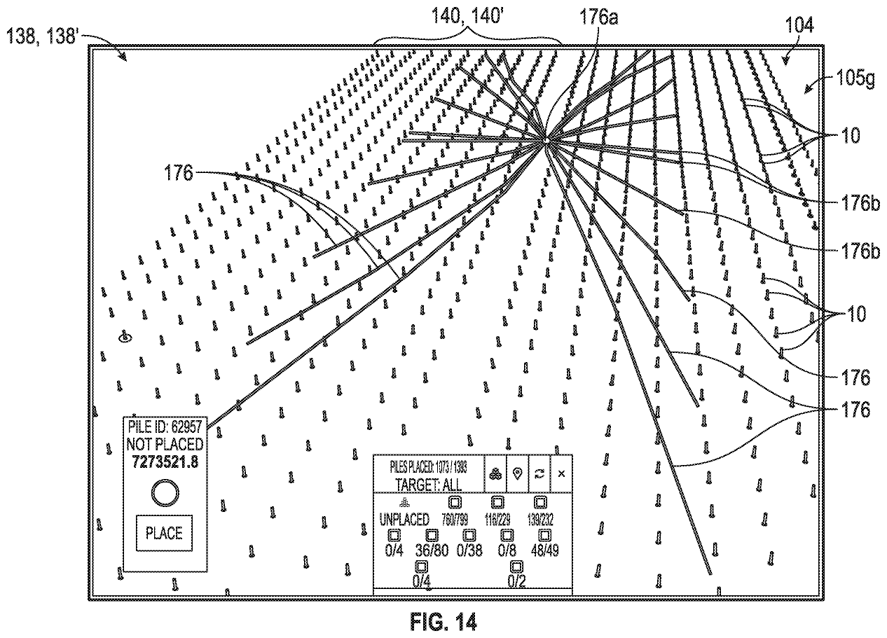

Referring now to FIG. 14, the controller 102 (FIG. 2) may be operable to execute instructions from the memory 114 (FIG. 3), including displaying on the display 104 (FIG. 2), a seventh screen layout 105g and the selectable input 136 ((FIG. 4); e.g., a seventh selectable input) corresponds to a seventh module displaying seventh screen layout 105g. Seventh screen layout 105g may include geographical map 138 and component layout 140. Component layout 140 may display at least one component (e.g., a pile 10) and may display a plurality of components (e.g., at least one pile 10, at least one torque tube 12, at least one panel 14, at least one module 16).

Referring still to FIG. 14, the seventh screen layout 105g may include a plurality of guiding lines 176 which each represent a trench (not shown), or targeted locations of trenches, for conduits, electrical wires, or other underground raceways. In embodiments, a remote vehicle (not shown; e.g., a robot, a vehicle, a drone, or another type of vehicle) travels between a central location 176a and a plurality of target locations 176b and the path of travel (e.g., guiding lines 176) of the remote vehicle is displayed on the geographical map 138, 138′ of the seventh screen layout 105g. In embodiments, the guiding lines 176 may be formed such that each guiding line 176 is a branch stemming from the central location 176a to centralize connection points for conduits, electrical wires, or other underground raceways. In embodiments, the guiding line target locations 176b are dispersed among the component layout 140 among the components (e.g., piles 10, torque tubes 12, panels 14, modules 16) such that a plurality of the components (e.g., piles 10, torque tubes 12, panels 14, modules 16) may be served or coupled to conduits, electrical wires, or underground raceways at the target locations 176b. In embodiments, the target locations 176b are dispersed among the component layout 140, generally equally, such that each target location 176b may serve or couple to the same number of components (e.g., piles 10, torque tubes 12, panels 14, modules 16). In embodiments, the target locations 176b are dispersed among the component layout 140 such that each target location 176b may serve or couple to a different number of components (e.g., piles 10, torque tubes 12, panels 14, modules 16). In some examples, each target location 176a represents a location of a power inverter to which one or more panels 14 are electrically connected.

In embodiments, the guiding lines 176 may be formed before placement of the piles 10 or after placement of the piles 10. In embodiments, the guiding lines 176 may be formed before placement of the torque tubes 12 or after placement of the torque tubes 12. In embodiments, the guiding lines 176 may be formed before placement of the panels 14 or after placement of the panels 14. In embodiments, the guiding lines 176 may be formed before placement of the modules 16 or after placement of the modules 16.

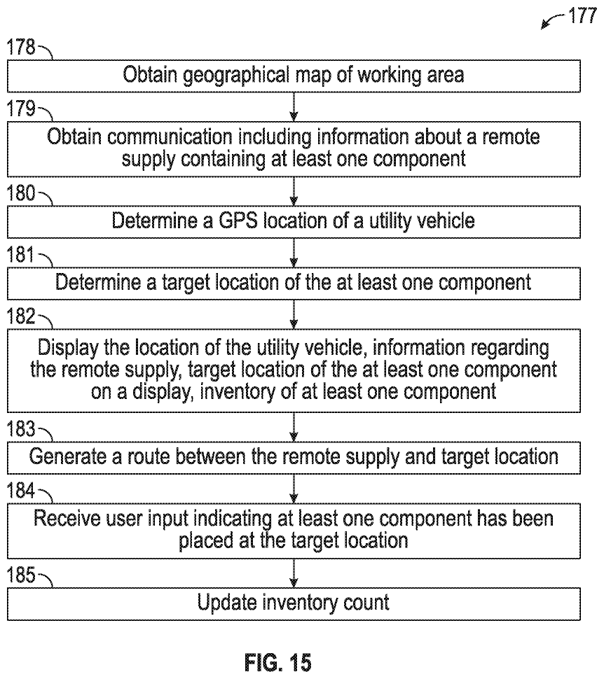

Referring now to FIG. 15, a process 177 for operating the resource management platform 100 is provided. In embodiments, the controller 102 (FIG. 2) may be operable to execute instructions from the memory 114 (FIG. 3), including the process 177. The process 177 includes obtaining a geographical map (e.g., geographical map 138 or geographical map 138′) of a working area (e.g., the area around component layout 140 or component layout 140′) from one or more of a wireless network (e.g., by the network controller 110 (FIG. 2) from the server 122 (FIG. 2), the mobile device 124 (FIG. 2), or the network 126 (FIG. 2)), as indicated by the block 178. In embodiments, the process 177 also includes obtaining the component layout 140, 140′ from one or more of a wireless network (e.g., by the network controller 110 from the server 122, the mobile device 124, or the network 126).

Referring still to FIG. 15, the process 177 includes obtaining communication, including information regarding a remote supply (e.g., the remote supply 128 (FIG. 2)) comprising at least one component, as indicated in block 179. In embodiments, the information regarding a remote supply may be a location of the remote supply (e.g., the remote supply indicators 116 (FIG. 8) for the piles 10, the remote supply indicators 119 (FIG. 10) for the torque tubes 12 or the panels 14, the remote supply indicators 121 (FIG. 12) for the modules 16). The information regarding a remote supply (e.g., the remote supply 128) may be a status of at least one component of the remote supply (e.g., ready to be picked up, not ready to be picked up). The information regarding a remote supply (e.g., the remote supply 128) may also include inventory information, class of component of the remote supply, distance to the remote supply, target location of at least one component of the remote supply, and other associated information about the remote supply. In embodiments, the information is obtained over a network (e.g., by the network controller 110 (FIG. 2)) such as a Bluetooth network, a wi-fi network, a cellular network, a vehicle-to-vehicle network, or another type of network. In embodiments, the information related to the remote supply may be stored in the database 133 and accessed by the operator of the vehicle 20 and any other remote device which has access to the database 133 ((FIG. 2); e.g., through the server 122 (FIG. 2), the mobile device 124 (FIG. 2), or the network 126 (FIG. 2)).

Still referring to FIG. 15, the process 177 includes determining a location of at least a portion of the resource management platform 100 (FIG. 2), as indicated in block 180. In embodiments, the location determiner 108 provides GPS coordinates to the controller 102 (FIG. 2) for the vehicle 20 (FIG. 1). In embodiments, the controller 102 (FIG. 2) determines the position of one of the display 104 (FIG. 2), the implement 28 (FIG. 1), the GPS or antenna location 142 (FIG. 6), or the bay location 144 (FIG. 6) of the implement 28 (FIG. 1) by determining the relative position of the at least one portion of the resource management system relative to the GPS coordinates.

Still referring to FIG. 15, the process 177 includes determining a target location of at least one component (e.g., piles 10, torque tubes 12, panels 14, modules 16), as indicated in block 181. The controller 102 (FIG. 2) may be operable to execute instructions stored in the memory 114 (FIG. 3) to determine the target location of the at least one component by determining the type of component (e.g., piles 10, torque tubes 12, panels 14, modules 16) and class of component (e.g., first class, second class, third class, etc.) and determining a corresponding placement or location for the at least one component on the component layout 140, 140′ and the geographical map 138, 138′.

Still referring to FIG. 15, the process 177 includes displaying relevant information on the display 104 (FIG. 2), including one or more of the geographical map 138, 138′, the component layout 140, 140′, location of the utility vehicle 20 (FIG. 1), information regarding the remote supply 128 (FIG. 2) such as the location of the remote supply and status of the at least one component of the remote supply, the target location of the at least one component and inventory of the at least one component, as indicated by block 182.

Still referring to FIG. 15, the process 177 may also include determining or generating a route between the at least one component of the remote supply and a target location of the at least one component, as indicated by block 183. The controller 102 (FIG. 2) may be operable to execute instructions stored on the memory 114 (FIG. 3) to generate an efficient route between the at least one component of the remote supply and the target location of the at least one component. The controller 102 may be operable to generate the route based upon the distance between the vehicle 20 (FIG. 1) and the remote supply, the distance between the remote supply and the target location, the number of components at the remote supply, the status of the at least one component at the remote supply, the class of component of the at least one component at the remote supply, and other considerations. The controller 102 may be operable to generate a first route between a first remote supply and the target location, and a second route between a second remote supply and the target location, and determine if the first route or the second route is the more efficient (i.e., faster, more fuel efficient, etc.) route.

In embodiments, the process 177 also includes receiving a user input that the at least one component has been placed in the target location, as indicated by block 184. The controller 102 (FIG. 2) may be operable to execute instructions stored on the memory 114 (FIG. 3) to monitor a user input (e.g., the user input 106 (FIG. 2), the selectable input 163 (FIG. 9), the selectable input 170 (FIG. 10), the selectable input 175c (FIG. 12)) and determine when a user input has been received that the at least one component has been placed. The controller 102 may be operable to update one or more inventories representative of the at least one component based upon the user input (e.g., the inventory 157 (FIG. 9), the inventory 164 (FIG. 10), the inventory 172 (FIG. 12)), as indicated by block 185. That is, the controller 102 may be operable to determine when a pile 10 has been placed in response to the selectable input 163 being selected by a user, and the controller 102 may be operable to update the overall inventory 157 of the piles 10 and a class specific component inventory (e.g., the inventory indicator 11a for the first class of piles 10a). Further, the controller 102 may be operable to determine that when the selectable input 170 has been selected by a user, that a torque tube 12 or panel 14 has been placed, and the controller 102 may be operable to update the overall inventory 164 of the torque tubes 12 and the panels 14 and a class specific component inventory (e.g., the component inventory 13a for the first class of torque tubes 12a). Further, the controller 102 may be operable to determine that when the selectable input 175c has been selected by a user, that a module 16 has been placed, and the controller 102 may be operable to update the overall inventory 173 of modules 16 and a specific component inventory (e.g., the inventory indicator 17 for the modules 16).

In embodiments, the process 177 may include providing a prompt on the display 104 (FIG. 2) when the vehicle 20 (FIG. 1) is proximate one of the location of the at least one component and the location of the target location. The controller 102 (FIG. 2) may be operable to execute instructions stored on the memory 114 (FIG. 3) to monitor a location of the vehicle 20 (e.g., by the location determiner 108) and provide a prompt on a screen layout (e.g., screen layout 105a, 105b, 105c, 105d, 105e, 105f, 105g) when the vehicle 20 is positioned close to, or proximate to, the at least one component (e.g., piles 10, torque tubes 12, panels 14, modules 16), and the prompt may query the operator of the vehicle 20 if they have picked up or otherwise acquired the at least one component. The controller 102 may be operable to execute instructions stored on the memory 114 to monitor a location of vehicle 20 (e.g., by the location determiner 108 (FIG. 2)) and provide a prompt on a screen layout (e.g., screen layout 105a, 105b, 105c, 105d, 105e, 105f, 105g) when the vehicle 20 is positioned close to, or proximate to, the at least one target location of the at least one component on the component layout 140, 140′ of the geographical map 138, 138′, and the prompt may query the operator of the vehicle 20 if they have placed or otherwise dropped off the at least one component.

Another aspect of the disclosure relates to the assembly of the various components that are used on the solar farm. One portion of the assembly includes securing the panels 14 to the torque tubes 12 in preparation for the panels to be installed at their installation positions. A panel assembly device 200 is disclosed to facilitate efficient assembly of the panels 14 to the torque tubes 12 in terms of time and human resources.

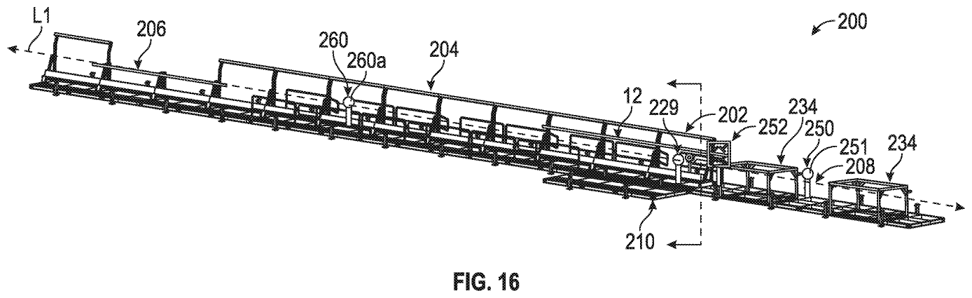

Referring now to FIG. 16, the panel assembly device 200 includes a first portion or collection assembly 208, a second or assembly portion 202, a third or transition portion 204, and a fourth or egress portion 206. In embodiments, the panel assembly device 200 extends along a longitudinal axis L1 and the second portion 202 is coupled to the third portion 204, the third portion 204 is coupled longitudinally intermediate the second portion 202 and the third portion 204, and the third portion 204 is coupled longitudinally intermediate the third portion 204 and the fourth portion 206. In embodiments, a collection assembly 208 extends generally along longitudinal axis L1 and is coupled to the second portion 202. In embodiments, the collection assembly 208 is utilized to stage one or more of the torque tubes 12 prior to assembly with the panels 14. In embodiments, the collection assembly 208 includes at least one collection frame 234. In embodiments, the collection assembly 208 includes two collection frames 234, and the first collection frame is longitudinally spaced from the second collection frame. In embodiments, the collection assembly 208 includes two collection frames 234 and the first collection frame is laterally spaced from the second collection frame. In embodiments, the collection assembly 208 includes three collection frames, four collection frames, or more collection frames that may be longitudinally and/or laterally spaced from each other.

Still referring to FIG. 16, the panel assembly device 200 may include an ingress frame portion 210 which is coupled to first portion laterally offset from the collection assembly 208. In embodiments, the ingress frame portion 210 is utilized to stage one or more of the panels 14 prior to assembly with the torque tubes 12.

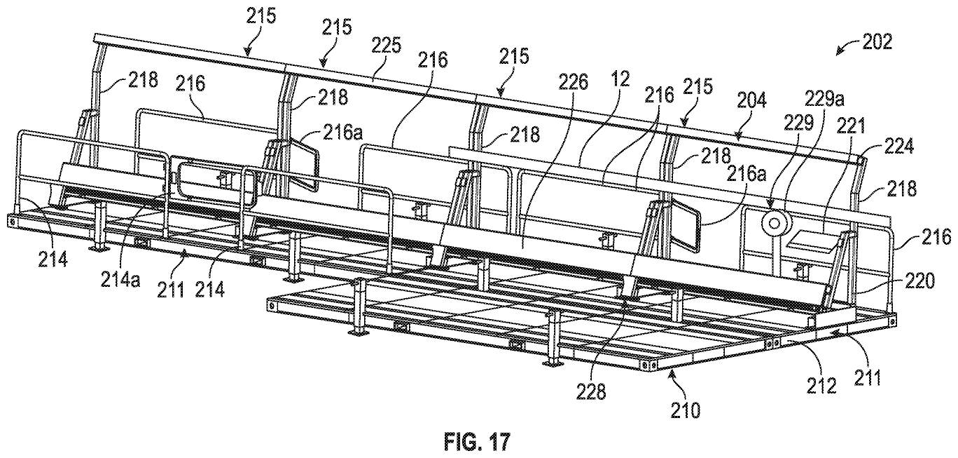

Referring now to FIG. 17, the panel assembly device 200 includes a plurality of base assemblies 211 and a plurality of support assemblies 215. In embodiments, the base assemblies 211 generally include a first rail portion 214 on a first lateral side of the panel assembly device 200 and a second rail portion 216 on a second lateral side of the panel assembly device 200 opposite of the first rail portion 214. In embodiments, the first rail portion 214 defines a first door 214a and the second rail portion 216 defines a second door 216a. In embodiments, the assembly portion 202 includes only a second rail portion 216 and the third portion 204 includes both the first rail portion 214 and the second rail portion 216. In embodiments, the base assemblies 211 support each support assembly 215. In embodiments, a single base assembly 211 supports two support assemblies 215. In embodiments, a single base assembly 211 supports a single support assembly 215.

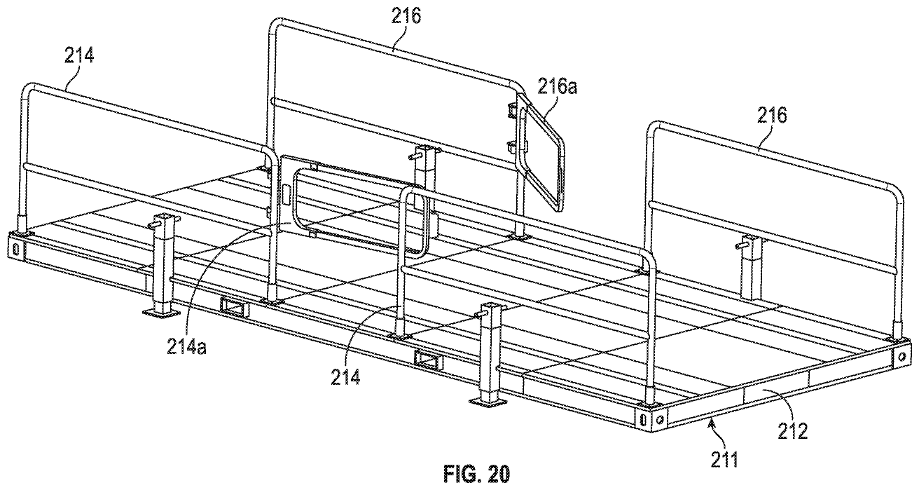

Referring now to FIG. 20, the base assembly 211 includes a floor member 212 and each rail portion 214, 216 is supported by the floor member 212. In embodiments, each rail portion 214, 216 is supported at a generally lateral extents of the floor member 212.

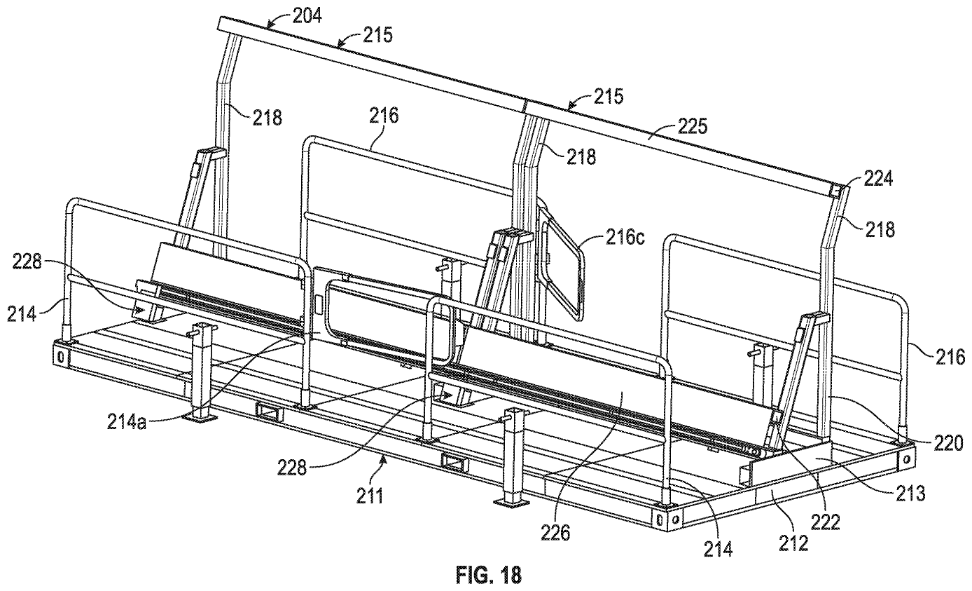

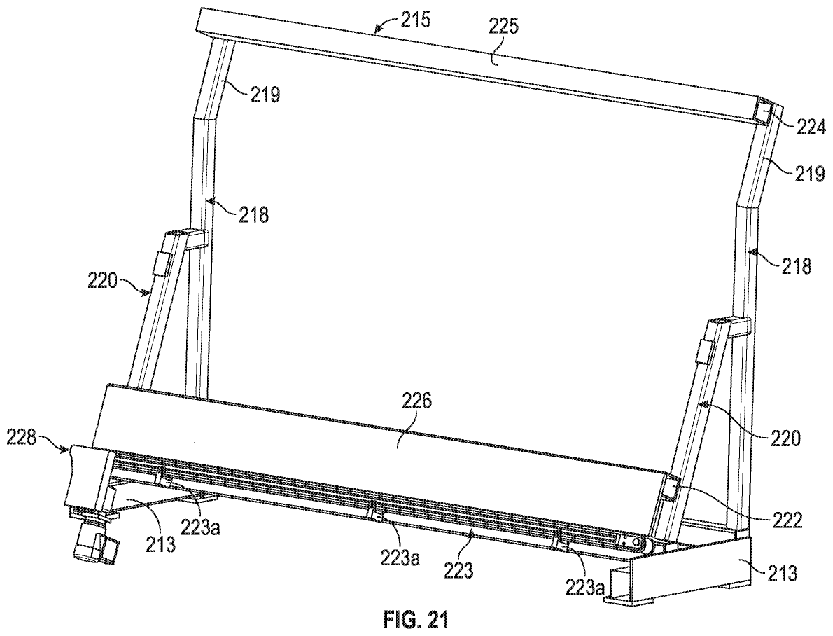

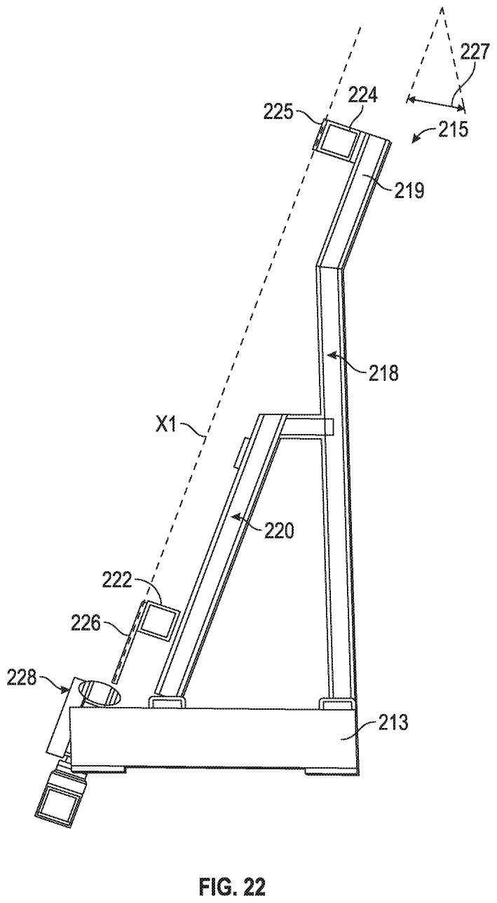

Referring now to FIGS. 21-22, support assembly 215 includes a pair of first frame members 218 longitudinally spaced and extending upwardly from the floor member 212 (FIG. 18). In embodiments, a brace member 213 is coupled between the floor member 212 and each of first frame members 218. In embodiments, a pair of second frame members 220 extend generally upwardly from the floor member 212 and each second frame member 220 couples with each of the first frame members 218, respectively. In embodiments, the second frame member 220 is angled relative to the first frame member 218. Each of the first frame member 218 may include an upper portion 219 which may be angled relative to the first frame member 218. In embodiments, the upper portion 219 is angled relative to normal (e.g., an axis extending perpendicular to the floor member 212 or the ground (not shown)), e.g., the same angle relative to normal as the second frame member 220. That is, referring to FIG. 22, the upper portion 219 of the first frame member 218 and the second frame member 220 may be angled at an angle 227 relative to normal (e.g., an axis extending perpendicular to the floor member 212 or the ground (not shown)).

Referring still to FIGS. 21-22, the support assembly 215 includes a first frame member 222 extending between each of the second frame members 220 and a second frame member 224 extending between each of the upper portions 219 of the first frame members 218. A first panel 226 is coupled to the first frame member 222 and extends along an axis X1. A second panel 225 is coupled to the second frame member 224 and extends along the axis X1. That is, each of the first panel 226 and the second panel 225 are coplanar along the axis X1. In embodiments, each of the first panel 226 and the second panel 225 are formed of a low-friction material. In embodiments, each of the first panel 226 and the second panel 225 include a surface treatment to reduce friction.

Referring still to FIGS. 21-22, support assembly 215 includes a conveyance 228 (e.g., a movement assembly). A frame member 223 is coupled between the second frame members 220 and a plurality of brackets 223a are coupled to the frame member 223. In embodiments, the conveyance 228 is coupled to and supported by brackets 223a and frame member 223.

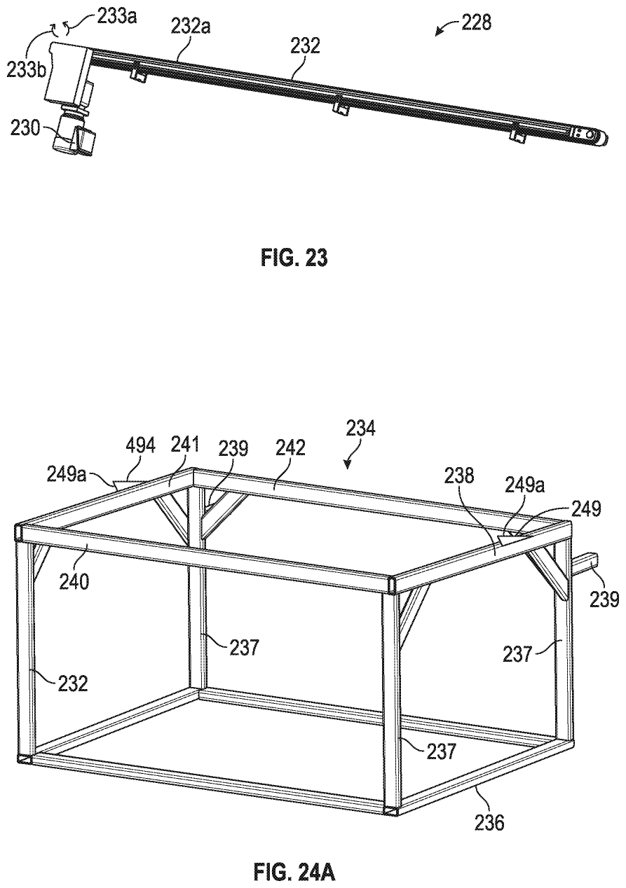

Referring now to FIG. 23, the conveyance 228 includes a motor 230 operably coupled to an endless member or belt 232. In embodiments, the motor 230 is operable to rotate the endless member or belt 232. In embodiments, the endless member or belt 232 defines a surface 232a. In embodiments, the motor 230 is operable to rotate the endless member or belt 232 in a rotational direction 233a. In embodiments, the motor 230 is operable to rotate the endless member or belt 232 in a rotational direction 233b. In embodiments, a surface 232a is positioned adjacent a bottom extent of the first panel 226. In embodiments, a surface 232a is positioned vertically below a bottom extent of the first panel 226. In embodiments, conveyance 228 is angled such that surface 232a is non-parallel with floor member 212. In embodiments, conveyance 228 is angled such that surface 232a extends along a plane that is generally perpendicular to first panel 226.

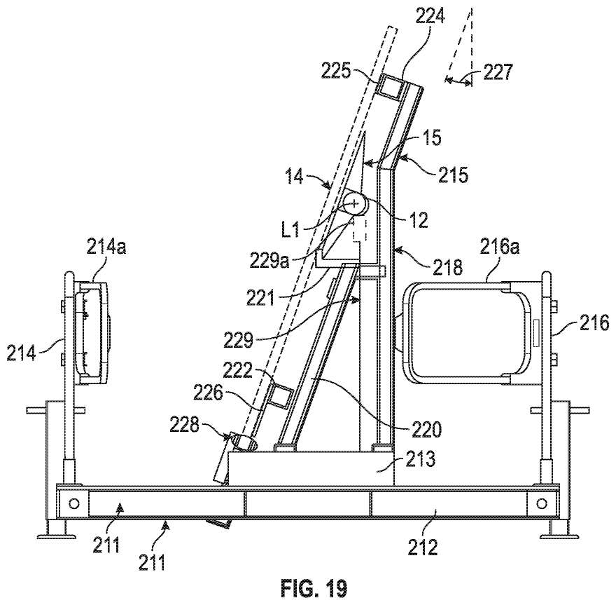

Referring now to FIG. 19, the support assembly 215 is positioned, generally laterally, intermediate the first rail portion 214 and the second rail portion 216. Further, a bracket 15 is coupled between the torque tube 12 and the panel 14. In embodiments, a bracket 15 surrounds the torque tube 12 and couples to the panel 14 on either side of the torque tube 12.

Referring again to FIG. 17, a second portion 202 includes an ingress frame portion 210 and does not include a first rail portion 214 to allow direct access to support assembly 215 from ingress frame portion 210.

Referring still to FIG. 17, a second portion 202 includes a support member 221 coupled to one of the first frame member 218 and a second frame member 220. A support member 221 is generally planar and extending generally parallel to floor member 212.

Referring again to FIG. 17, a second portion 202 of the panel assembly device 200 includes a rotational member 229. In embodiments, a rotational member 229 is positioned adjacent the support member 221. In embodiments, a rotational member 229 is positioned toward a lateral extent of the second portion 202 (e.g., adjacent collection assembly 208). In embodiments, the rotational member 229 includes a surface 229a (e.g., the outer rotating surface) moving along a plane generally parallel to a ground level (e.g., the same as the surface of floor member 212). The rotational member 229 supports the torque tube 12. The torque tube 12 translates through a panel assembly device 200 as the surface 229a rotates.

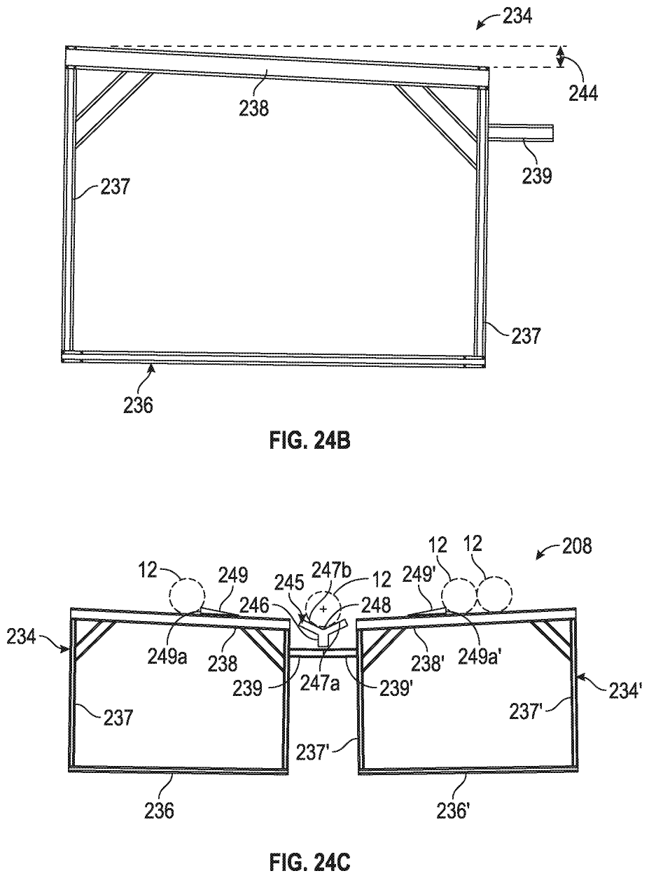

Referring now to FIGS. 24A-24C, the collection frame 234 includes a base 236, a plurality of vertically extending members 237, a first upper longitudinally extending member 240, a second upper longitudinally extending member 242, a first upper laterally extending member 238 and a second upper laterally extending member 241. The collection frame 234 also includes a pair of supports 239 extending laterally outwardly from a pair of the vertically extending members 237 of the plurality of vertically extending members 237. In embodiments, each laterally extending member 238, 241 includes a stop member 249 which may move into and out of the laterally extending member 238, 241 such that in a disengaged position, the stop member 249 is positioned within each of the laterally extending member 238, 241, and in an engaged position, the stop member 249 is positioned above an upper surface of each of the laterally extending member 238, 241. The stop members 249 each include a stop surface 249a facing generally laterally outwardly away from the longitudinal centerline L1 (FIG. 24C).

Referring to FIGS. 24A and 24B, the laterally extending members 238, 241 are angled downwardly toward supports 239 at an angle 244.

Referring to FIG. 24C, the collection assembly 208 includes a first collection frame 234 and a second collection frame 234′ mirrored about the longitudinal axis L1. That is, a second collection frame 234′ includes a base 236′ (e.g., mirrored from base 236), a plurality of vertically extending members 237 (e.g., mirrored from vertically extending members 237), a first upper longitudinally extending member (not shown, mirrored from member 240), a second upper longitudinally extending member (not shown, mirrored from member 242), a first upper laterally extending member 238′ (e.g., mirrored from member 238), and a second upper laterally extending member (not shown, mirrored from member 241). The collection frame 234′ also includes a support 239′ mirrored from support 239. In embodiments, each support 239, 239′ are positioned adjacent a lateral center of the collection assembly 208. In embodiments, the collection frame 234′ includes the stop members 249′ (e.g., mirrored from stop members 249).

Referring still to FIG. 24C, the collection assembly 208 includes a support 245 positioned, generally laterally, aligned with the longitudinal centerline L1. In embodiments, a support 245 is coupled to each of the support 239, support 239′. In embodiments, a support 245 is coupled to support 239. In embodiments, a support 245 is coupled to the support 239′. A support 245 includes a base 246, a first arm 247a, and a second arm 247b. In embodiments, a support 245 is generally shaped in a Y-configuration. A first arm 247a and second arm 247b define a cradle 248 which may receive a torque tube 12.

Still referring to FIG. 24C, the collection assembly 208 may receive a plurality of torque tubes. In embodiments, one or more torque tubes 12 may be received by each of the collection frame 234 and the collection frame 234′. That is, the collection frame 234 may receive one or more torque tubes 12 on laterally extending members 238, 241 at a position laterally outwardly of a stop member 249. Similarly, the collection frame 234′ may receive one or more torque tubes 12 on the laterally extending members 238′, 241′ (i.e., the member opposite member 241) at a position laterally outwardly of a stop member 249′. In embodiments, each of the stop members 249, 249′ are in an engaged position and all the torque tubes 12 are positioned laterally outwardly of the stop members 249, respectively. One stop member 249, 249′ may move into a disengaged position and the respective torque tube may roll down the respective laterally extending member. That is, if a stop member 249 moves into a disengaged position, a torque tube 12 rolls down the laterally extending members 238, 241 and rolls into a cradle 248 of the support 245, and if a stop member 249′ moves into a disengaged position, a torque tube 12 rolls down the laterally extending members 238′, 241′ (i.e., the member opposite member 241) and rolls into a cradle 248 of the support 245.

Referring again to FIG. 16, the collection assembly 208 may include a plurality of longitudinally spaced collection frames 234. In embodiments, the collection assembly 208 includes a plurality of longitudinally spaced collection frames 234′. In embodiments, the collection assembly 208 includes a pair of collection frames 234 and a pair of collection frames 234′, and a torque tube may be supported by two longitudinally spaced supports 245.

Still referring to FIG. 16, a panel assembly device 200 may include a rotational member 250. A rotational member 250 may be positioned within or adjacent the collection assembly 208. A rotational member 250 may be a motorized wheel with a surface 251 operable to contact a torque tube 12 along a plane generally parallel to a ground level (e.g., floor member 212). A rotational member 250 may be operably coupled to a motor (not shown, e.g., an electric motor) and the motor may be operable to rotate a rotational member 250 and move a torque tube 12 along the longitudinal axis L1. In embodiments, a rotational member 250 may be positioned intermediate a pair of longitudinally spaced collection frames 234. In embodiments, a rotational member 250 may be positioned longitudinally intermediate each of the collection frames 234 and a second portion 202 of the panel assembly device 200.

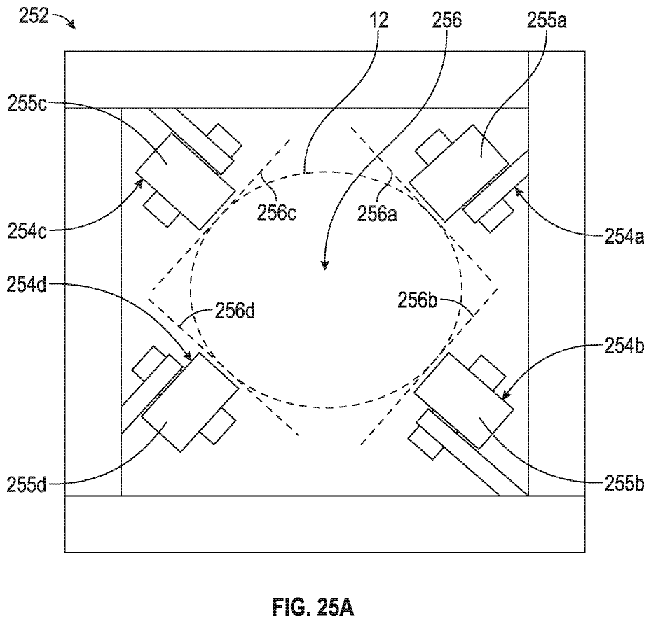

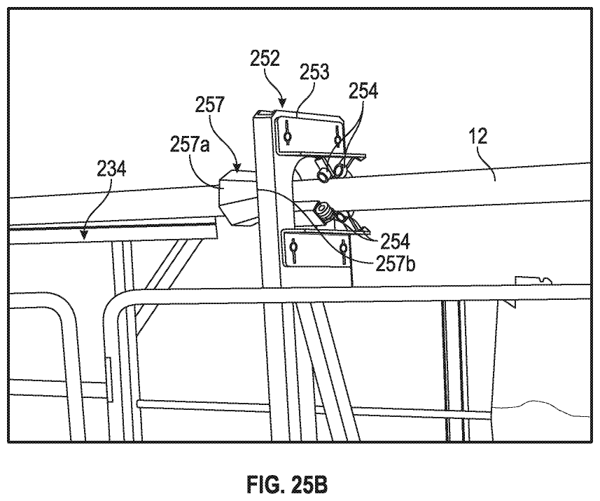

Referring again to FIG. 16 and to FIG. 25A, an alignment frame 252 is positioned longitudinally intermediate the collection assembly 208 and a second portion 202. The alignment frame 252 includes a frame 253 and a plurality of rollers 254 coupled to the frame 253. The plurality of rollers 254 includes a first roller 254a defining a first surface 255a, a second roller 254b defining a second surface 255b, a third roller 254c defining a third surface 255c, and a fourth roller 254d defining a fourth surface 255d. In embodiments, each of the surfaces 255a, 255b, 255c, 255d are non-coplanar. In embodiments, each of the surfaces 255a, 255d are parallel and each of the surfaces 255b, 255c are parallel. In embodiments, each of the surfaces 255a, 255d are perpendicular to each of the surfaces 255b, 255c. In embodiments, each of the rollers 254a, 254b, 254c, 254d are spaced to create an aperture 256 dimensioned to receive a torque tube 12, and a torque tube 12 is operable to slide along the rollers 254a, 254b, 254c, 254d through aperture 256.

Referring to FIG. 25B, an alignment frame 252 may include a funnel 257 including a first end 257a and a second end 257b. A first end 257a may be larger than a second end 257b. A funnel 257 may be coupled to an alignment frame 252. In embodiments, a second end 257b may be coupled to an alignment frame 252 and a first end 257a may extend toward the collection assembly 208. The torque tubes 12 may move from the collection assembly 208, through a funnel 257 and an alignment frame 252 and on to a second portion 202. A funnel 257 may assist in alignment of the torque tube as it arrives at an alignment frame 252.

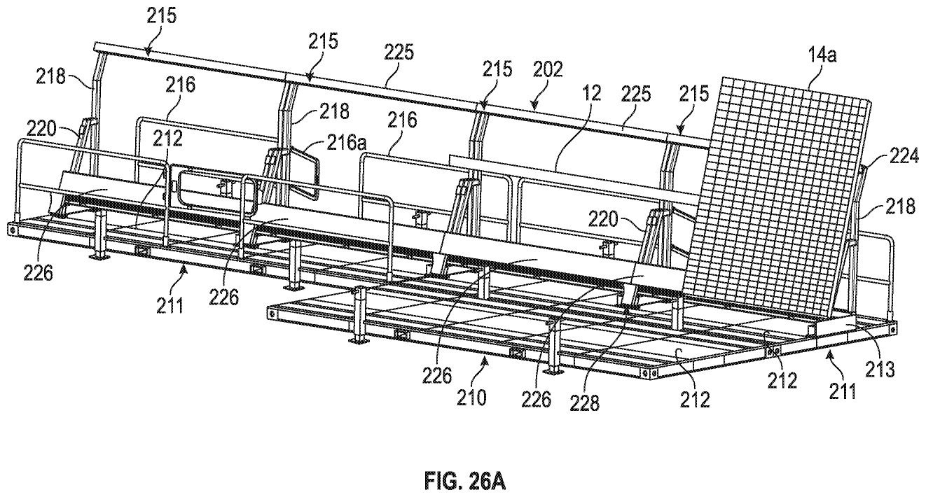

Referring now to FIGS. 26A-26B, a panel 14a may be positioned onto a first support assembly 215 of a panel assembly device 200. A panel 14 may be moved across an ingress frame portion 210 and supported by each of the surface 232a of the belt 232 (see FIG. 23), a first panel 226 and a second panel 225. Referring to FIG. 16, the torque tube 12 is supported by one or more of the collection assembly 208, the rotational member 250, the alignment frame 252 and the rotational member 229. Referring to FIG. 19, a panel 14 may be coupled to a torque tube 12 by a bracket 15. After the panel 14 is positioned onto a first support assembly 215 and the torque tube 12 is positioned along axis L1, adjacent the panel 14, a bracket 15 may be positioned on, and supported by a support member 221. A support member 221 is positioned such that the bracket 15 is properly aligned to couple with each of the torque tube 12 and the panel 14 when the bracket 15 is supported by a support member 221. A support member 221 is positioned to provide both support and alignment needs to the bracket 15 relative to each of the torque tube 12 and the panel 14.

In embodiments, the torque tube 12 is being moved along a panel assembly device 200 by one or more of the rotational member 229, 250 at a first speed and a panel 14 is being moved along a panel assembly device 200 by a conveyance 228 at the first speed. Operators, or assemblers, may stand on a floor member 212 and couple the bracket 15 to each of the torque tube 12 and panel 14 (e.g., by a fastener) and operators may move along with the torque tube 12 and the panel 14 as the assembly (e.g., torque tube 12, panel 14, bracket 15) moves along the panel assembly device 200.

Still referring to FIGS. 26A-26B, the first panel 14 (e.g., panel 14a) may move along a panel assembly device 200 and a second panel (e.g., panel 14b) may be placed on a support assembly 215 of the panel assembly device 200. In embodiments, a second panel 14b is longitudinally spaced but adjacent to a first panel 14a. A bracket 15 (e.g., a second bracket 15) may be coupled between a torque tube 12 and the second panel 14b. In embodiments, a torque tube 12 and the panels 14 may continue to move along a panel assembly device 200 and allow a plurality of panels 14 to be coupled to a torque tube 12. In embodiments, each torque tube 12 may couple to two panels 14. In embodiments, each torque tube 12 may couple to three panels 14, four panels 14, five panels 14, six panels 14, seven panels 14, eight panels 14, or more panels.

Referring again to FIG. 16, the panels 14 and the torque tube 12 move along a panel assembly device 200 from the second portion 202 and through the third portion 204 as each panel 14 is coupled to the torque tube 12. In embodiments, a conveyance 228 moves the panels 14 and the torque tube 12 through a second portion 202 and a third portion 204 at the first speed. A final assembly (e.g., a plurality of panels on a torque tube) moves through the third portion 204 and into the fourth portion 206. In embodiments, the third portion 204 includes a movement device or a rotational device 260. A rotational device 260 includes a surface 260a, operable to contact the torque tube 12 and move along a plane generally parallel to a ground level (e.g., parallel to floor member 212). In embodiments, a motor 261 is operably coupled to a rotational device 260 to provide motive force (e.g., rotational movement) to a rotational device 260.

The final assembly (e.g., a plurality of panels 14 on a torque tube 12) may move through a third portion 204 and onto a third portion 204 under the power of one or more of the conveyance 228 and a rotational device 260. In embodiments, the final assembly is motivated (e.g., contacted and moved) by the conveyance 228 when the final assembly is within the second portion, and may become unmotivated (e.g., uncontacted and unmoved) by the conveyance 228 when the final assembly moves into the third portion 204. In embodiments, final assembly may be motivated (e.g., contacted and moved) by a rotational device 260 when the final assembly is within the third portion 204. In embodiments, a rotational device 260 is operable to move the final assembly at a second speed. In embodiments, the second speed is greater than the first speed (e.g., the first speed of the conveyance 228 and a rotational device 250). In embodiments, the rotational device 260 is operable to move the final assembly through the third portion 205 and into the fourth portion 206. The final assembly may be moved through the third portion 204 and into the fourth portion 206 at the second speed greater than the first speed to create a transition or buffer zone between a first final assembly positioned in the fourth portion 206 and a second assembly (e.g., a second assembly of the panels 14 on the torque tubes 12) being assembled within the second portion 202 and the third portion 204.

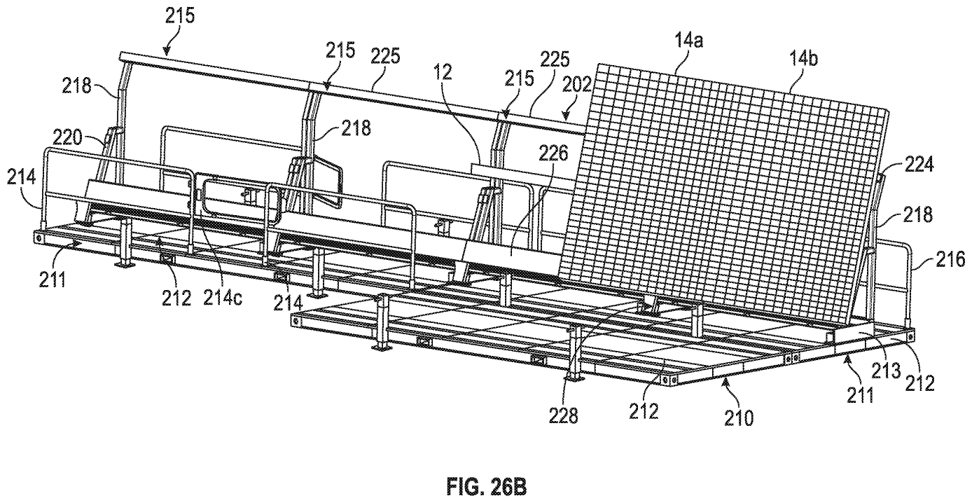

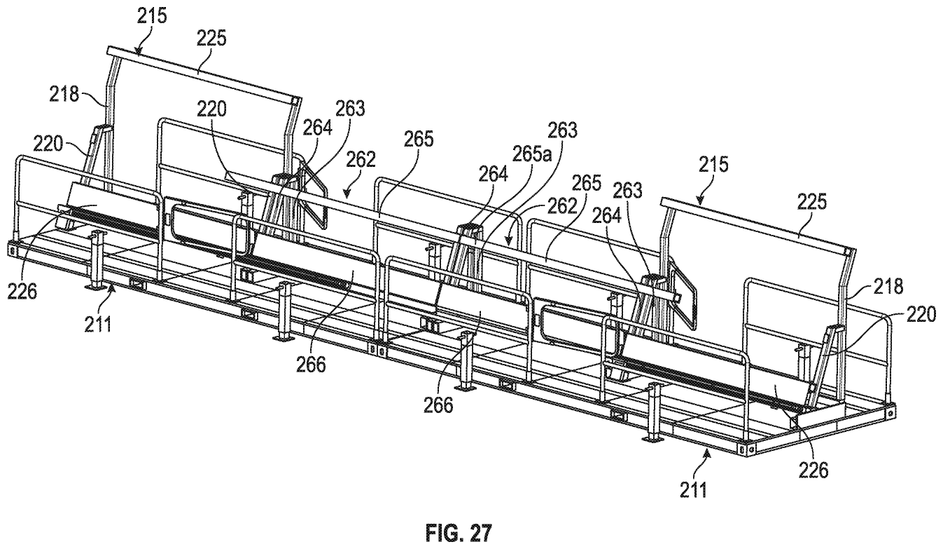

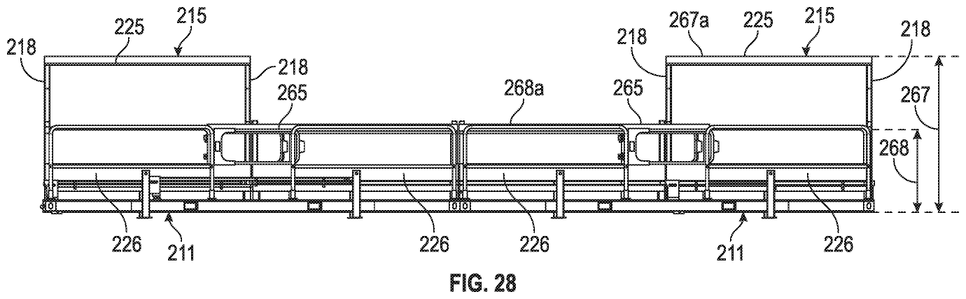

Referring now to FIGS. 27-28, the fourth portion 206 includes the base assemblies 211 which support a pair of longitudinally spaced support assemblies 215. A pair of support assemblies 262 are positioned longitudinally intermediate the support assemblies 215. The support assemblies 262 include a pair of vertically extending members 263 and a pair of angled members 264 coupled between the floor member 212 of the base assemblies 211 and the vertically extending members 263. A laterally extending member 265 (e.g., a first panel) is coupled between the pair of angled members 264. In embodiments, the laterally extending member 265 includes a surface 265a which may be a low friction surface. In embodiments, the surface 265a is treated by a surface treatment, a processing treatment or another type of treatment to lower the coefficient of friction of the surface. In embodiments, a laterally extending member 266 (e.g., a second panel) is coupled between the pair of angled members 264 and the laterally extending member 266 is positioned vertically lower than the laterally extending member 265. In embodiments, the laterally extending member 266 is positioned at the same height as the first panel 226.

Referring to FIG. 28, support assemblies 215 define an upper extent 267a and the support assemblies 262 define an upper extent 268a. Further, the support assemblies 215 define a height 267 and the support assemblies 262 define a height 268. In embodiments, a height 268 is less than height 267. In embodiments, a height 268 is between 40%-60% of the height 267. In embodiments, an aperture 269 is defined between support assemblies 215 and above support assemblies 262.

Referring again to FIG. 16 and FIGS. 27-28, a final panel assembly 18 may move from the third portion 204 into the fourth portion 206. The final panel assembly 18 may be positioned within the fourth portion 206 by a rotational device 260 (FIG. 16) such that a longitudinal center of the final panel assembly 18 is positioned adjacent the aperture 269. In embodiments, the torque tube 12 of a final assembly is positioned above the upper extent 268a so that the final assembly may be grabbed or picked from the panel assembly device 200 and delivered to a final installation position (e.g., by resource management platform 100).

Another aspect of the disclosure relates to a temporary bracket 300 that is implemented to fasten a panel 14 to a torque tube 12 prior to final assembly at the installation position. A temporary bracket 300 may be implemented when the torque tube 12 with the fastened panels 14 is being delivered to the installation position, but the panel 14 will be finally secured to a structure (e.g., an already placed torque tube) at the installation position. The temporary bracket 300 allows for the panel 14 to be quickly and simply secured to the torque tube at the assembly position, to securely fasten the panel 14 during transport, to easily and quickly remove the bracket during placement of the torque tube at the installation site, and to be returned for repeated use for additional torque tubes. The temporary bracket 300 may be provided so that it can securely fasten the panel 14 to the torque tube 12 and be removed without the use of tools.

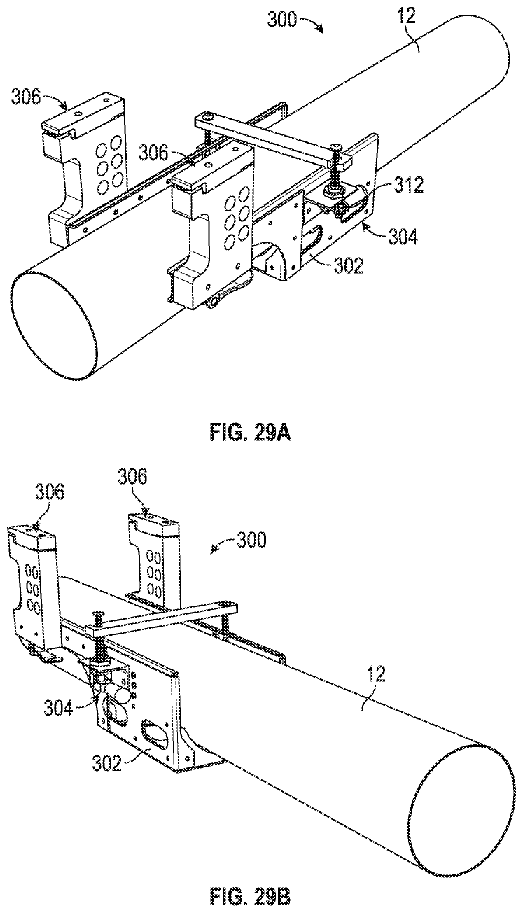

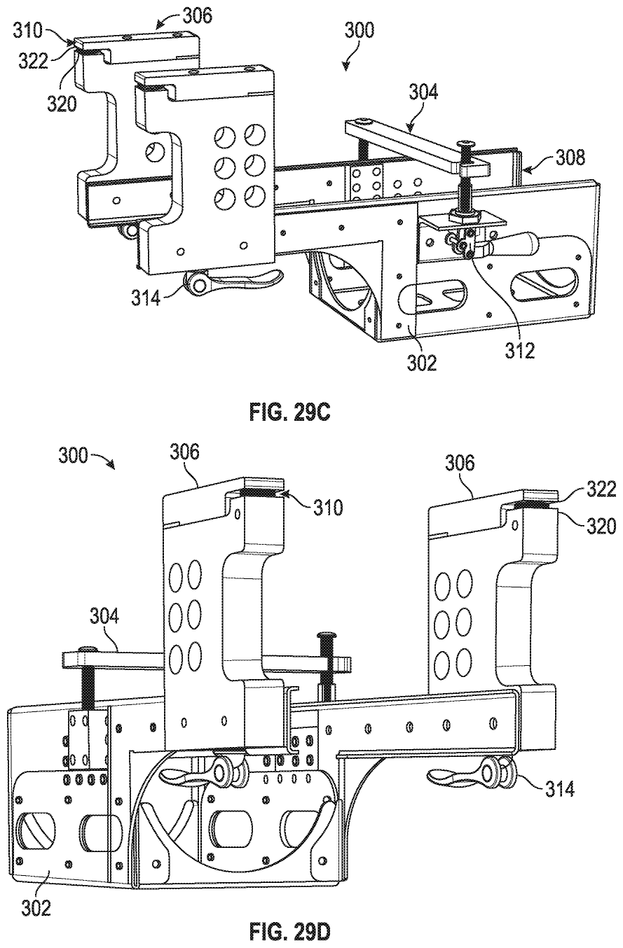

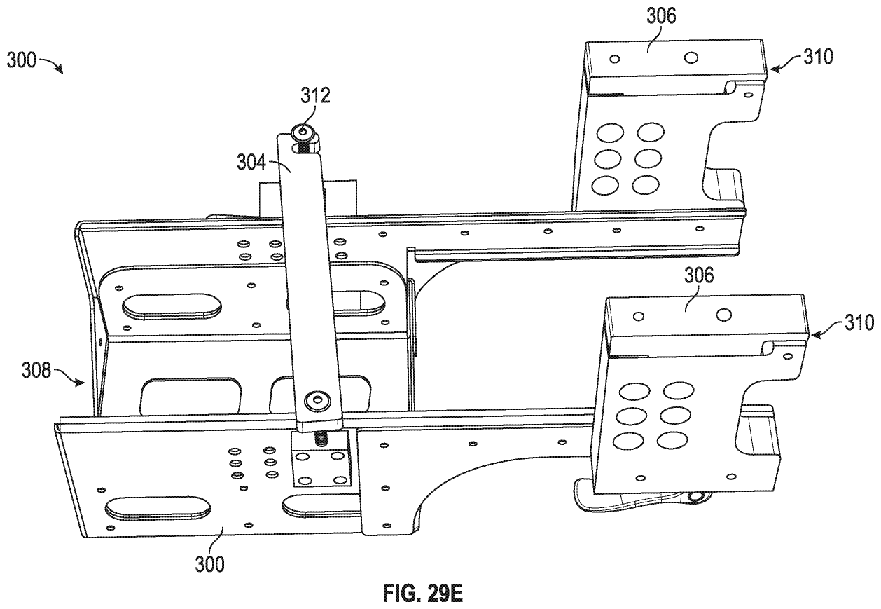

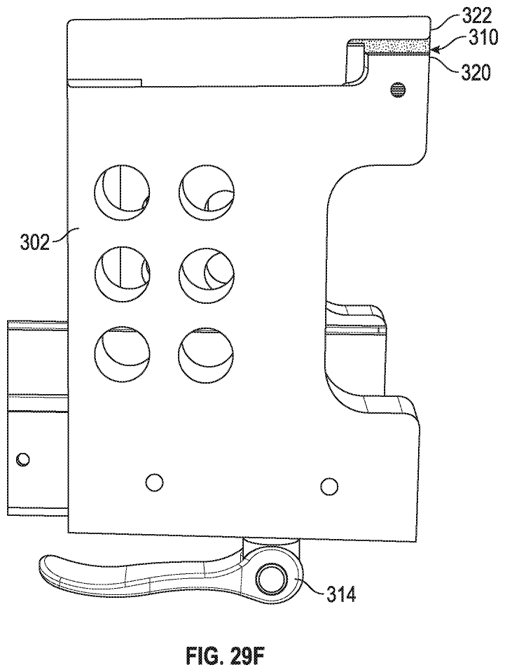

Referring to FIGS. 29A and 29B, the bracket 300 is illustrated coupled to a torque tube 12. The bracket 300 that is used for temporarily securing the panel 14 to a support member such as a torque tube 12 includes a body 302, a first clamping member 304, and a second clamping member 306. The first clamping member 304 is operable to secure the torque tube 12 and the second clamping member 306 is operable to secure the panel 14. Although the first and second clamping members 304, 306 are shown positioned with respect to the body 302 in a certain manner, it is understood that the relative positions may be changed for various applications. For example, FIG. 29A illustrates the second clamping member 306 being positioned extending from the body 302 such that the second clamping member 306 is at least partially cantilevered. It is understood that the second clamping member 306 may be positioned with respect to the body 302 such that it is not cantilevered.

Referring to FIGS. 29C and 29D, the bracket 300 defines a first receiving portion 308 configured to receive a portion of the support member (e.g., the torque tube 12) and a second receiving portion 310 configured to receive a portion of the panel 14. For example, the first receiving portion 308 may be at least partially defined by the body 302 of the bracket 300. In some embodiments, the first receiving portion 308 is defined by the body 302 of the bracket and the first clamping member 304. More specifically, the first receiving portion 308 may be defined as a trough within the body 302 of the receiving member along which surfaces of the torque tube 12 may be received and retained, and the first clamping member 304 is operable to engage and retain the torque tube 12 within the first receiving portion 308. The first clamping member 304 is moveably coupled to the body 302 such that the bracket 300 may be installed onto the torque tube 12 and removed from the torque tube 12 without interference and then be moved to a closed position to secure the bracket 300 to the torque tube 12. When the first clamping member 304 is in the closed position to secure the torque tube 12, the body 302 and the first clamping member 304 secure and surround a portion of the torque tube 12.

Referring to FIGS. 29C and 29E, in some embodiments, the bracket 300 includes a first fastener 312 operable to restrict movement of the first clamping member 304 relative to the body 302 when in an engaged configuration. The first fastener 312 may be any number of various fasteners, including but not limited to, screws, clamps, levers, cams, and so forth. As illustrated in FIG. 29A, the first fastener 312 includes a bolt coupled to a cammed lever which is configured to pull the bolt in to engage and retain the first clamping member 304. For example, the first clamping member 304 may be hinged or rotatable relative to the body 302 which allows for the bracket 300 to be inserted onto the torque tube 12, after which the first clamping member 304 can be rotated into a closed position to retain the torque tube 12. Once the first clamping member 304 is rotated to the closed position, the first fastener 312 can be actuated to restrict movement of the first clamping member 304 in the closed position. The first fastener 312 may be supported by either the body 302 or the first clamping member 304. The first fastener 312 may be a tool-less fastener, which allows the operator to quickly fasten and release the bracket 300 from the torque tube 12 including during assembly and at delivery. This also allows the bracket 300 to be quickly and easily swapped out for reuse in construction at the assembly site. For example, after an assembled torque tube 12 is delivered, the bracket 300 may be removed and taken back to the assembly position to be reused. In some embodiments, the first fastener 312 and first clamping member 304 may be similar to or retrofitted from a pipe clamp which is manufactured onto the body 302 of the bracket 300.

Referring to FIGS. 29D and 29F, regarding the second receiving portion 310, the second receiving portion 310 may be defined by a portion of the body 302 and a portion of the second clamping member 306. The second receiving portion 310 is configured to receive and retain the panel 14. The second clamping member 306 is moveably coupled to the body 302 such that the second receiving portion 310 is defined between or at a position between the second clamping member 306 and the body 302. When the second clamping member 306 engages the panel 14, the panel is positioned at the second receiving portion 310 such that the panel 14 (e.g., the frame or another portion of the panel 14) is sandwiched between the second clamping member 306 and the body 302.

In some embodiments, the second receiving portion 310 of the body 302 includes a first substantially planar surface 320 and the second clamping member 306 includes a second substantially planar surface 322 that is positioned substantially parallel to and moveable relative to the first substantially planar surface 320. This provides surfaces within which the panel 14 may be retained. However, it is understood that the surfaces may be provided in any shape that matches the shape of the portion of the panel 14 that is retained by the bracket 300 or may be configured to conform to the shape of the panel 14. In some embodiments, at least one of the first substantially planar surface 320 and the second substantially planar surface 322 includes at least one of a surface texture and surface treatment configured to increase friction or grip on the portion of the panel 14.

The bracket 300 further includes a second fastener 314. The second fastener 314 is configured to restrict movement of the second clamping member 306 relative to the body 302, which allows for the panel 14 to be securely retained by the bracket 300. The second fastener 314 may include any number of different fasteners, including but not limited to screws, clamps, levers, cams, ratchet bars, and so forth. In some embodiments, the second fastener 314 includes a bolt that is coupled to or extends from the second clamping member 306. The second fastener 314 can be actuated to pull the second clamping member 306 toward the body 302 (e.g., via a cammed lever, rotation, wing nuts, and so forth). It is understood that the second fastener 314 may be a tool-less fastener, which allows for the panel to be quickly, securely, and easily secured and removed at the assembly site and installation site. It is also understood that the bracket 300 may include a plurality of second clamping members 306 and second fasteners 314 in order to secure the panels 14 securely and without exerting undue force and stress to the panel 14.

Various features my be provided to provide easy functionality of the bracket 300 such as the tool-less fasteners discussed. Additionally, the bracket 300 may include reliefs, apertures, and other features to reduce weight of the overall bracket in order to provide ease of use at the installation site.

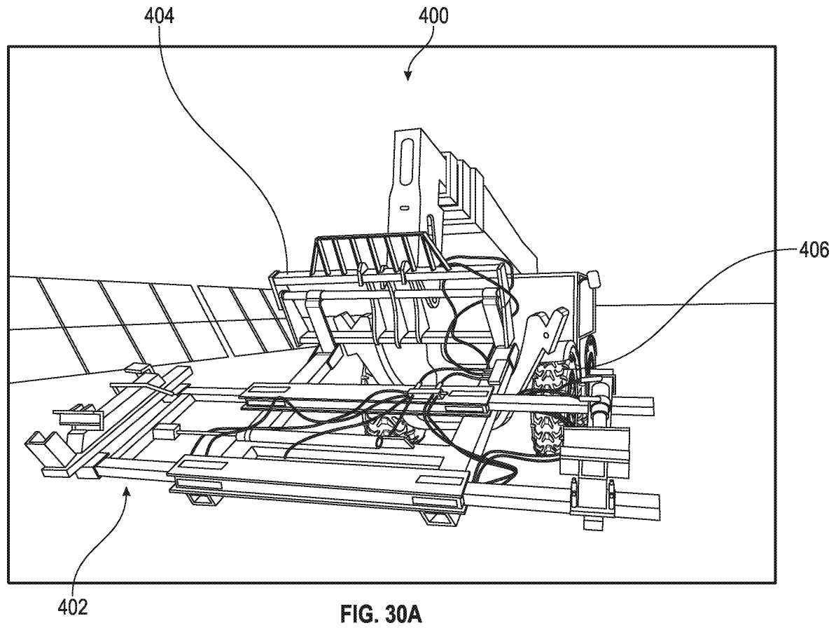

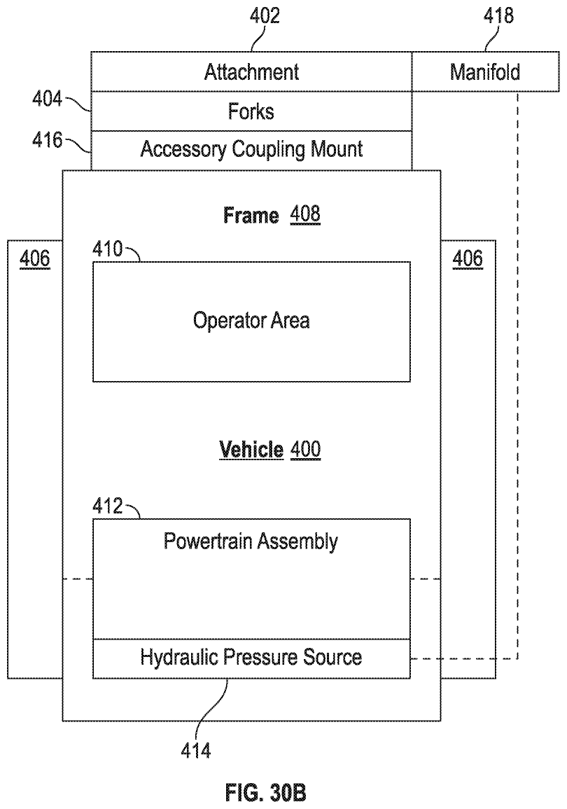

Another aspect of the disclosure relates to moving and installing assembled torque tubes (e.g., torque tubes with panels coupled thereto) at the installation site. A vehicle 400 and attachment 402 are provided for grabbing, transporting, and positioning assembled torque tubes (e.g., torque tubes 12 with panels 14 installed thereon, not shown) at the final installation position (e.g., installed on the piles and with the previously installed assembled torque tubes. FIG. 30A illustrates the vehicle 400 (e.g., a telehandler) with the attachment 402 coupled thereto. The attachment 402 may be positioned on existing structure of the vehicle 400, for example, on the forks 404, or the attachment 402 may replace the other components as an integral part of the vehicle 400.

Referring to FIG. 30B, the vehicle 400 is illustrated with ground engaging members 406 (e.g., tracks, although other ground engaging members such as tires and so forth may be implemented). The vehicle 400 further includes a frame 408 supported by the ground engaging members 406 which supports an operator area 410, a powertrain assembly 412 operably coupled to the ground, engaging members 406, a hydraulic pressure source 414, and an accessory coupling mount 416. The accessory coupling mount 416 may be provided in various forms. For example, on some vehicles, the accessory coupling mount 416 may be provided as a bucket mount, a fork mount, an auger mount, a trencher mount, a broom mount, a blade mount, and so forth. The accessory coupling mount 416 may be fixed or moveable relative to the frame 408. The accessory coupling mount 416 includes at least one interface member (e.g., mount position such as mount plates, brackets, etc.) for coupling an attachment 402 for distribution of materials at a worksite. A manifold 418 is provided for hydraulically coupling the attachment 402 to the hydraulic pressure source 414.

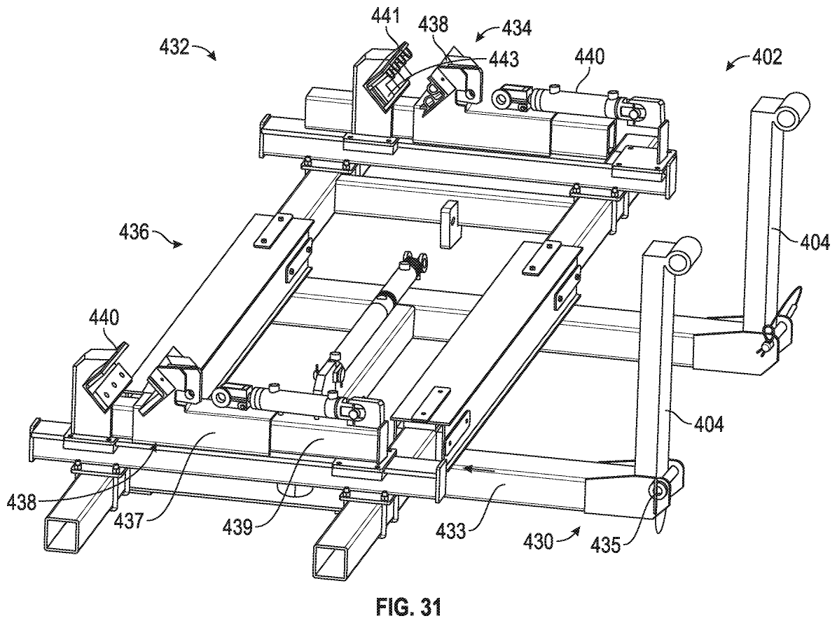

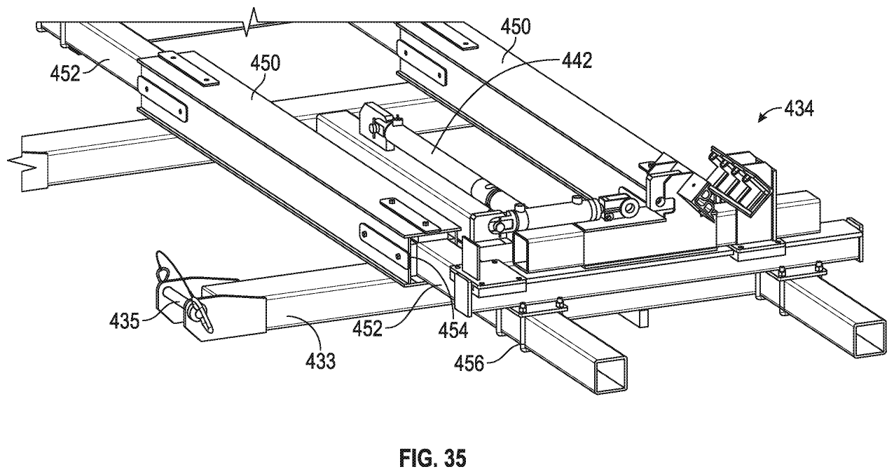

Referring to FIG. 31, the attachment 402 for distribution of materials at a worksite is shown as an accessory that is configured to be mounted to the vehicle 400. It is understood that the attachment 402 may be provided as a device or a kit that can be installed onto and removed from the vehicle 400 or the vehicle 400 may be provided with the attachment 402. The attachment 402 includes a mounting portion 430 configured to couple (e.g., removably couple) to the accessory coupling mount 416 (e.g., via the interface member of the vehicle 400) or to other structure of the vehicle 400. For example, in some embodiments, the mounting portion 430 may couple to the forks 404 of the vehicle 400. Referring to FIG. 35, the mounting portion 430 includes at least one hollow tube member 433 within which the forks 404 of the vehicle 400 (e.g., a telehandler) are received. This allows the attachment 402 to be supported by the existing structure of the vehicle and allows the attachment to be easily installed and universally attachable to various vehicles. In order to secure the attachment 402 to the forks 404, at least one pin 435 may be provided, which is operable to constrain the forks 404 of the vehicle 400 within the hollow tube member 433. For example, the horizontal portion of the forks 404 may be positioned within the hollow tube member 433 and the pin 435 is inserted through the hollow tube member 433 behind the back of the vertical portion of the fork 404, thus preventing the forks 404 from pulling out from the hollow tube member 433. The hollow tube member 433 extends in the same direction as the forks 404, that is longitudinally. The hollow tube member 433 may support other components of the attachment 402 which are discussed hereafter such as the material handling assembly 432.

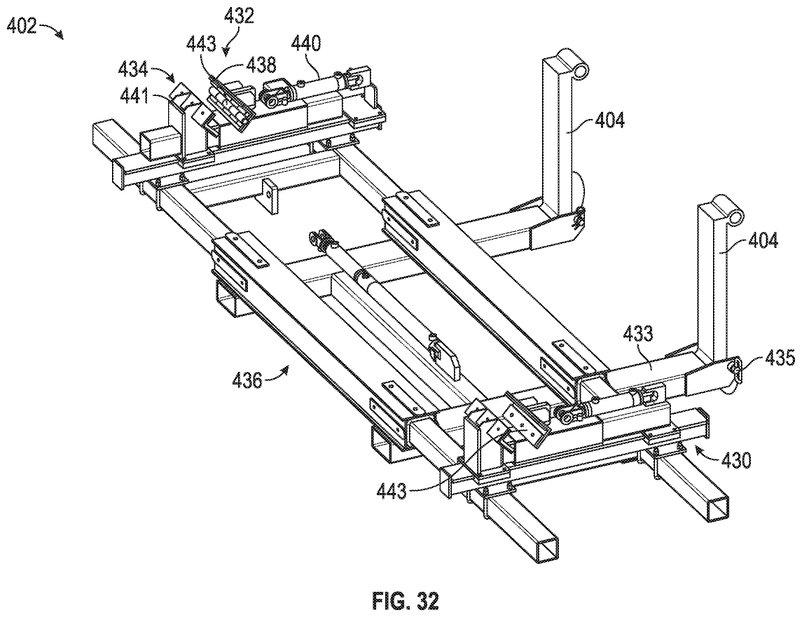

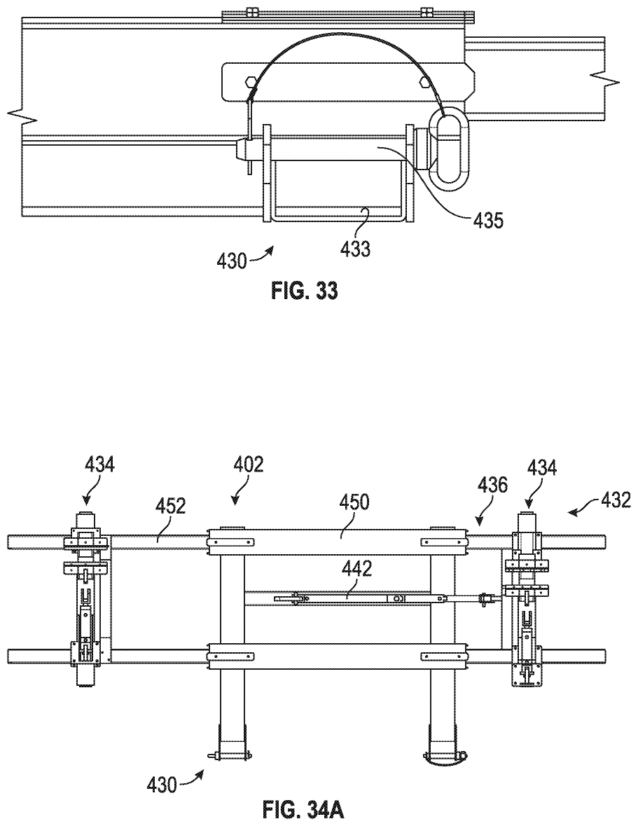

Referring again to FIGS. 31 and 32, the attachment 402 further includes a material handling assembly 432 that is configured to support the objects and materials that are to be distributed across the worksite. The attachment 402 is configured to secure objects such as torque tubes 12, including assembled torque tubes (e.g., torque tubes 12 with panels 14 secured thereto), during transportation and assist with placement at the final installation position. The attachment 402 is configured such that in can engage directly with the torque tube 12 when on the panel assembly device 200 (see FIG. 16) such that the vehicle 400 can move the torque tube 12 without any manual lifting or positioning by workers. The attachment 402 also facilitates the ability to move the torque tube 12 laterally at the position of installation. Because the vehicle 400 typically operates with forward and reverse movement and is steered via turning the wheel or relative movement of tracks, it is not possible for the vehicle to move laterally during use. Thus, the lateral movement afforded by the attachment 402 facilitates more seamless installation at the installation site. For example, when an assembled torque tube 12 is being placed at the installation site, one end of the torque tube 12 is installed into the other end of the torque tube that is already installed (male-female arrangement). The assembled torque tube 12 may travel within the installed torque tube about 10-30 inches before fully seated within the installed torque tube. Without the lateral movement of the attachment 402, installation would require manual labor for seating the assembled torque tube 12.

Turning to a discussion of the material handling assembly 432 of the attachment 402, a grasping assembly 434 is provided to interface with and secure the torque tube 12 and a lateral movement assembly 436 is provided to cause lateral movement of the grasping assembly 434. The grasping assembly 434 is configured to secure the object (e.g., the assembled torque tube 12) for transport and installation at the installation site. The grasping assembly 434 includes a contact portion 438 and at least one first actuator 440 coupled to the contact portion 438. The first actuator 440 is operable to actuate the contact portion 438, meaning to cause longitudinal movement of the contact portion 438. As the contact portion 438 is actuated, it moves to a corresponding contact portion 441, between which the torque tube 12 may be positioned and restrained. In some embodiments, the contact portion 438 rides along a support member 439. For example, the contact portion 438 may include a hollow tube 437 that surrounds at least a portion of the support member 439 and is operable to move along the longitudinal length of the support member 439. In some embodiments, the contact portion 438 and the corresponding contact portion 441 include profiles that are capable of grasping an object such as a torque tube 12. The contact portion 438 and the corresponding contact portion 441 may also include grippers or pads 443 that interface with the object. The grippers or pads 443 may be exchanged due to wear or for providing different levels of friction or cushioning. It is understood that any number of grasping assemblies 434 may be provided. For example, the figures illustrate two grasping assemblies 434 that may work together to restrain two portions of an object (e.g., the torque tube 12 at two different positions along its longitudinal length).

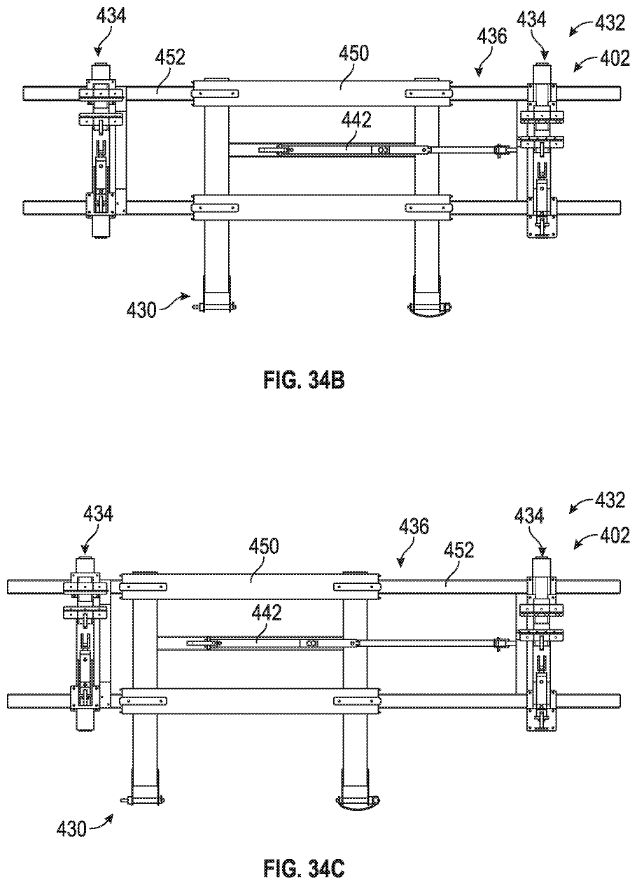

Referring to FIGS. 34A-34C, the lateral movement assembly 436 is capable of actuating for lateral movement of the grasping assembly 434 and thus any objects restrained by the grasping assembly 434. The lateral movement assembly 436 supports the grasping assembly 434 and causes lateral movement in order to position the grasping assembly 434 for grasping a torque tube and/or positioning the torque tube in place for final assembly as discussed above. The lateral movement assembly 436 includes a second actuator 442 coupled to the grasping assembly 434 in order to cause lateral movement of the grasping assembly 434.

The lateral movement assembly 436 is supported by the mounting portion 430. The lateral movement assembly 436 includes support members 450 that coupled to the mounting portion 430 and are positioned extending laterally or substantially perpendicularly to the mounting portion 430 (e.g., the hollow tube member 433 that receives the forks 404). The support members 450 provide a rail or track along which a portion of the lateral movement assembly 436 is able to ride. For example, the support members 450 may be hollow tubular members through which lateral tubes 452 extend. The lateral tubes 452 may slide within the support members 450 to allow for lateral movement. The grasping assembly 434 is supported on the lateral tubes 452 such that as the lateral tubes move relative to the support members 450, the grasping assembly 434 moves with the lateral tubes 452. The second actuator 442 is positioned to contact one of the lateral tubes 452 (e.g., indirectly via a cross member or directly) or the grasping assembly 434. The second actuator 442 is coupled to an anchor point (e.g., the support members 450 or the mounting portion 430).

As seen in FIG. 34A, the second actuator is 442 is positioned substantially retracted such that the lateral tubes 452 and the grasping assembly 434 are positioned to a first side. As the second actuator 442 is extended, the lateral tubes 452 and the grasping assembly 434 moved toward the second side, as seen in FIG. 34B. FIG. 34C illustrates the second actuator 442 in an extended configuration such that the lateral tubes 452 and the grasping assembly 434 are positioned at the second side. The lateral movement allows for installation of the torque tubes 12 as previously described as well as movement of the grasping assembly 434 for alignment for picking up torque tubes 12.

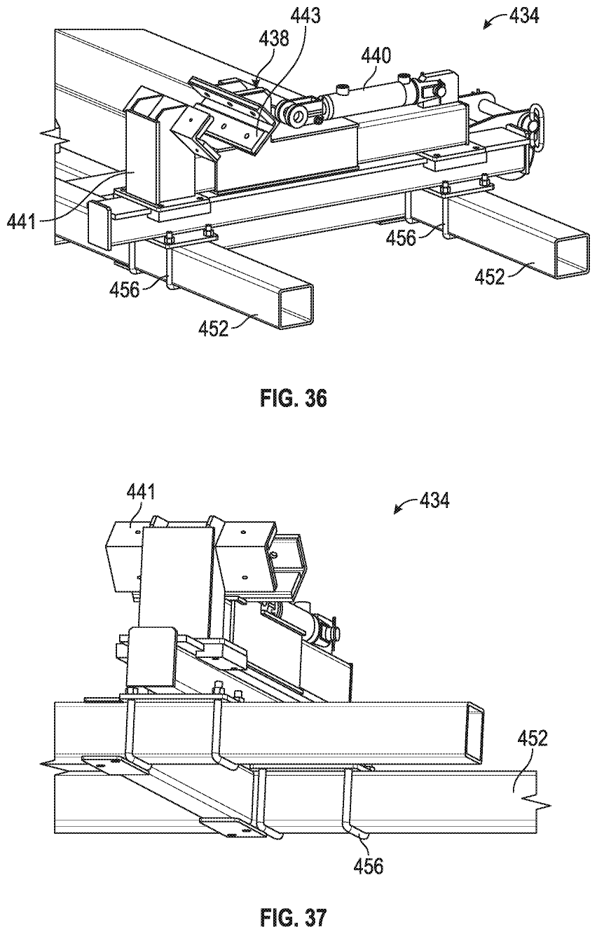

Referring to FIG. 35, the lateral tubes 452 include shims 454. The shims 454 are positioned and replaceable to provide a secure fit between the lateral tubes 452 and the support members 450. The shims 454 provide a surface along which the lateral tubes 452 may slide. As the shims 454 wear, they may be advanced further in to maintain the secure fit and may eventually be replaced. Referring to FIGS. 35-37, in some embodiments, the grasping assembly 434 may be coupled to the lateral tubes 452 via moveable coupling members 456. For example, the moveable coupling members 456 may include U-bolts that can be fastened around the lateral tubes 452. This allows the grasping assembly 434 to be positioned along the tubes at different lengths. This is beneficial to allow for those embodiments with multiple grasping assemblies 434 to be positioned along the lateral tubes 452 at customizable lengths to accommodate different objects which will be picked up. For example, the spacing of panels 14 on the torque tube 12 may require different distances between grasping assemblies 434 than other objects or a different torque tube holding different sized panels.

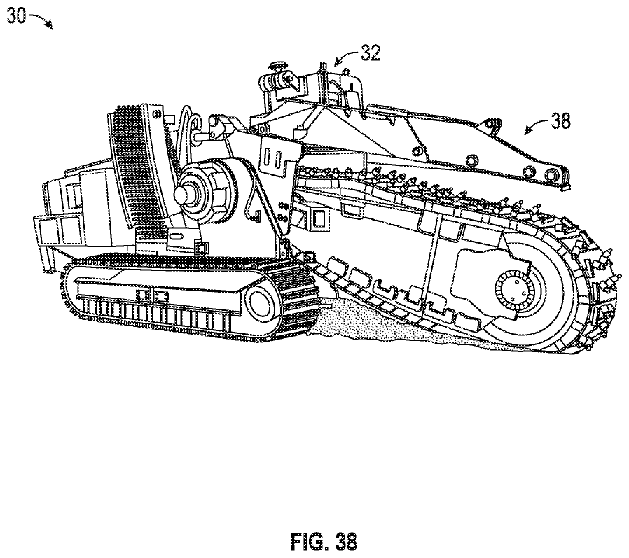

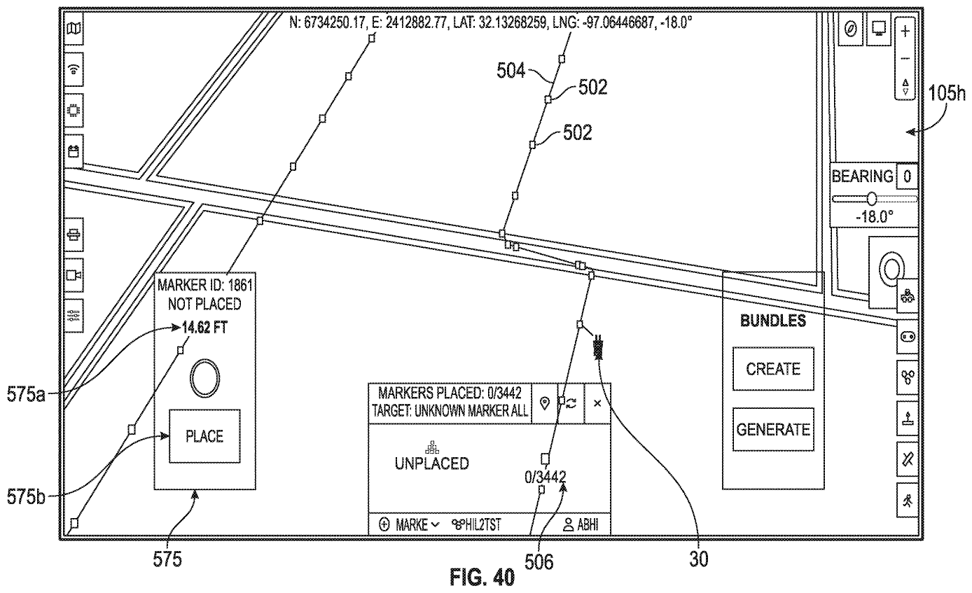

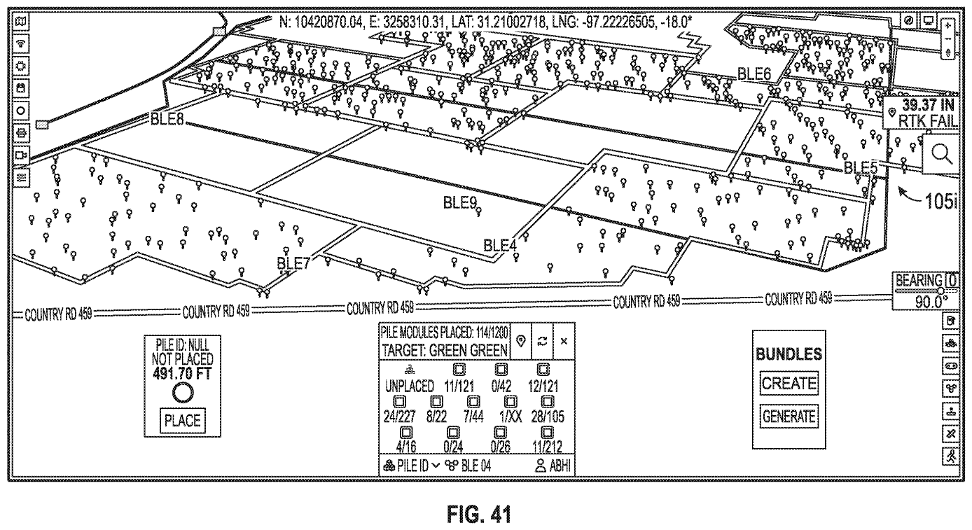

FIG. 38 is another example of a utility vehicle 21 in which the display 104 of the resource management platform 100 may be installed. In some example, the utility vehicle 21 is a trencher, which is used to dig trenchers for laying, for example, pipes, conduit or electrical cables. In some examples, the utility vehicle 21 is similar in many aspects to the utility vehicle 20. In some examples, as shown in FIG. 40, the utility vehicle 30 includes a cab portion 32 and an implement 38. In some examples the implement 38 comprises a trench digging portion.

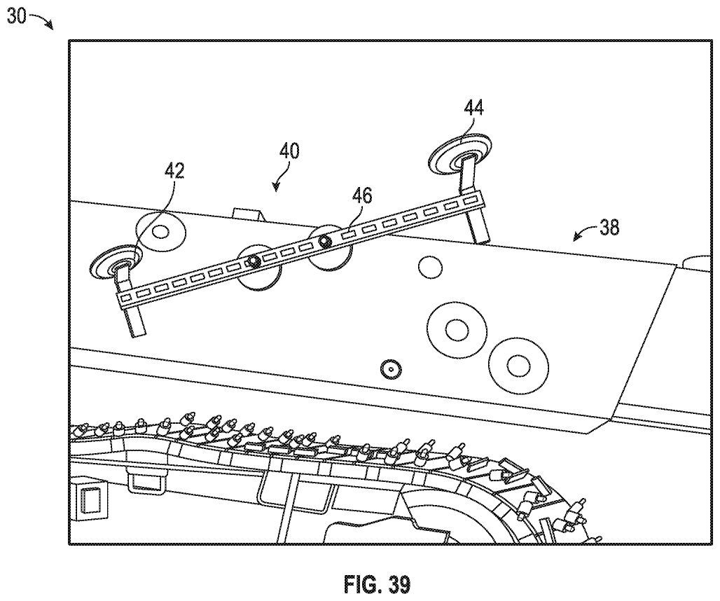

FIG. 39 is a detail view of the implement 38 of the utility vehicle 30. In some examples, the implement 38 comprises an antenna assembly 40 mounted thereto. The antenna assembly 40 comprises a first antenna 42, a second antenna 44, and a mounting bracket 46. In some examples, each of the first antenna 42 and the second antenna are attached to the mounting bracket 46. In some examples, the mounting bracket 46 is configured to position the first antenna 42 and the second antenna at approximately the same vertical height while the implement is used to dig a trench.

FIG. 40 depicts an eighth screen layout 105h that the controller 102 (see FIG. 2) of the resource management platform 100 may be operable to display. In some examples, the eighth screen layout 105h is similar in many aspects to the seventh screen layout 105g. In some examples, the eighth screen layout 105h includes a representation of the utility vehicle 30 (see FIG. 39). In some embodiments, the eighth screen layout 105h includes a plurality of trench marker locations 502. The trench marker locations 502 represent locations on a map displayed on the eighth screen layout 105h at which a trench is to be dug. In some examples, the eighth screen layout 105h also includes a trench route 504. In some examples, the trench route 504 is a continuous line on the map that represents a path of a trench that is to be dug between the trench marker locations 502. In some examples, the eighth screen layout 105h is configured to display a location of the utility vehicle 30 on the map as the utility vehicle travels along the trench route 504. In some examples, the controller 102 is configured to record various metrics, such as how much of a trench has been dug, how much of a trench is left to dig, and how fast the trench digging process has been going. In some examples, the eighth screen layout 105h includes a component status indicator 575. In some examples, the component status indicator 575 includes a distance 575a between the vehicle 30 and the trench route 504. In some examples, the component status indicator 575 includes a selectable input 575b. In some examples, when a user selects the selectable input and begins driving the vehicle 30 along the trench route 504 over various trench marker locations 502, the eighth screen layout 105h displays on a trench marker location indicator 506 how many of the trench marker locations 502 have been passed by the vehicle 30.

FIG. 41 is a ninth screen layout 105i that the controller 102 (see FIG. 2) of the resource management platform 100 may be operable to display. In some examples, the ninth screen layout 105i comprises a pre-distribution layout of materials at a project worksite. In some examples, the ninth screen layout 105i is similar in many aspects to one or more of the fourth screen layout 105d through the eighth screen layout 105h. In some examples, the ninth screen layout 105i displays the number of pre-distribution bundles that have been placed in each region of a worksite. In some examples, after receiving input from a user regarding the number of components to be placed within a given region of a worksite, the controller 102 is configured to generate a layout of pre-distribution bundles to be placed about the worksite and to display the layout on a geographical map shown on the ninth screen layout 105i.

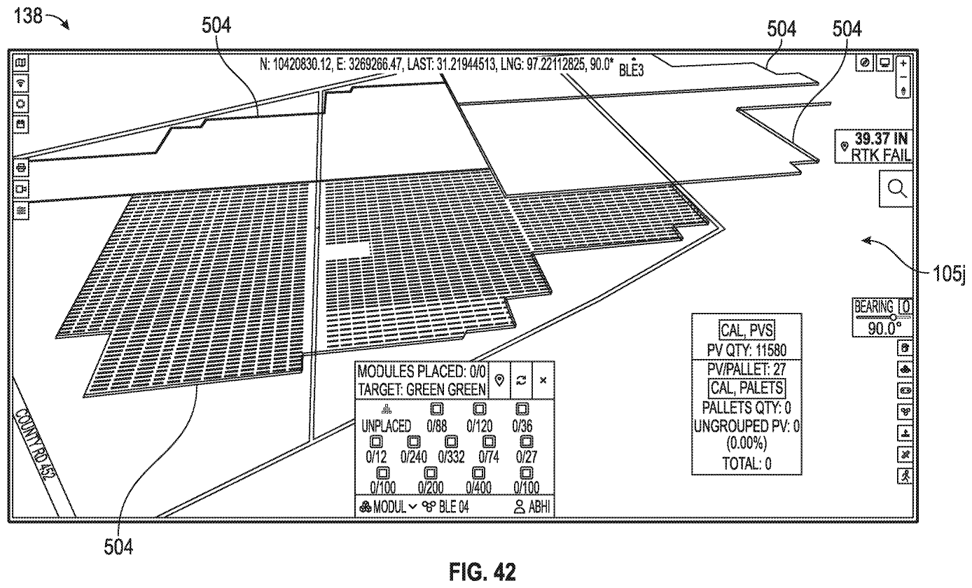

FIG. 42 is a tenth screen layout 105j that the controller 102 (see FIG. 2) of the resource management platform 100 may be operable to display. In some examples, the tenth screen layout 105j is similar in many aspects to one or more of the fourth screen layout 105d through the ninth screen layout 105i. In some examples, the tenth screen layout 105j is operable to display a plurality of regions 512 of a worksite on a geographical map 138. In some examples, each region 512 corresponds to a geographical area that contains an inverter for connection to one or more panels. In some examples, the tenth screen layout 105j is operable to receive a user input comprising the a desired wattage to be produced by the panels within a particular region 512. In some examples, based one or more of the size of the region 512, the user input, the length of the torque tubes, and the size of the panels, the controller 102 determines and displays the most efficient way of placing the panels, piles, and torque tubes within the region 512. In other examples, the controller 102 determines and displays the most efficient way of distributing boxes of panels around the region 512 for unpacking and assembly.

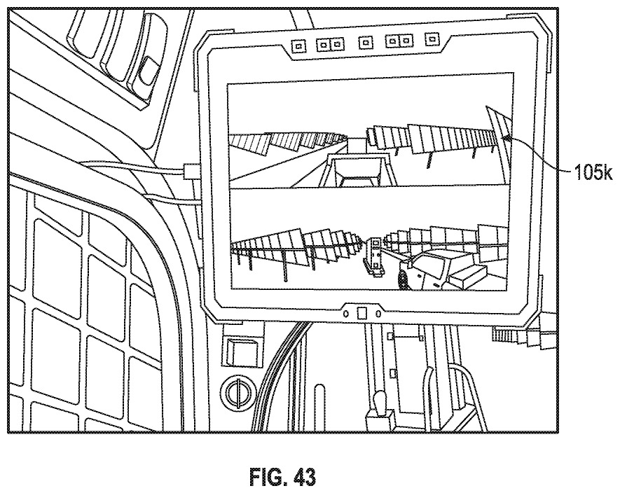

FIG. 43 is a eleventh screen layout 105k that the controller 102 (see FIG. 2) of the resource management platform 100 may be operable to display. In some examples, the eleventh screen layout 105k is similar in many aspects to the second screen layout 105b. In some examples, the eleventh screen layout 105k is configured to display a view from the sensor 134. In some examples, the sensor 134 comprises multiple cameras positioned about the vehicle 20 or vehicle 30. In some examples, the eleventh screen layout 105k is configured to simultaneously display a view from the multiple cameras. In some examples, the eleventh screen layout 105k is configured to display a 360-degree view around the vehicle 20 or vehicle 30.

In some examples, the controller 102 is operable to receive input from the sensor 134 and identify various objects displayed on the eleventh screen layout 105k. In some examples, the controller 102 is operable to determine whether an object is one of a person, a vehicle, a panel, a torque tube, or a pile. In some examples, the controller 102 is operable to generate an alert to a user if the object is within a certain proximity of the vehicle 20 or vehicle 30. In some examples, the determination of whether to generate an alert is made based on the type of object that is determined to be within a certain proximity of the vehicle 20 or vehicle 30. In some examples, the determination of whether to generate an alert is further made based on input from the location determiner 108, including whether the vehicle 20 or vehicle 30 is determined to be in a location adjacent to where the detected type of object is expected to be.

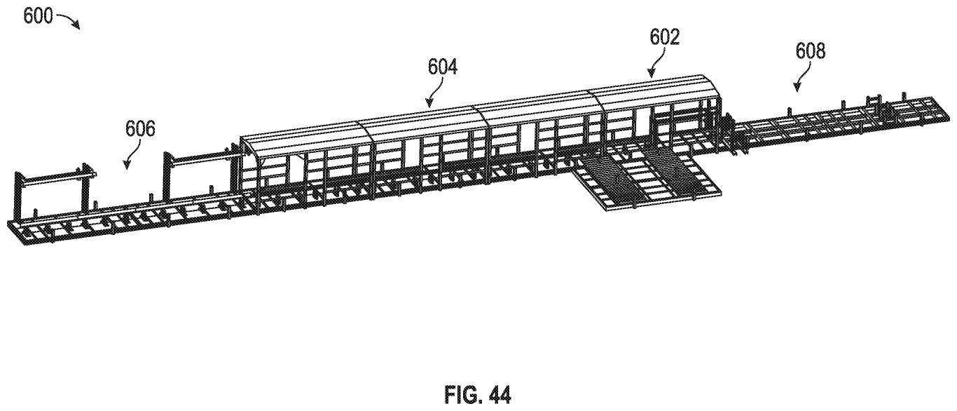

FIG. 44 is a perspective view of a second embodiment of a panel assembly device 600. In some examples, the panel assembly device 600 and its constituent components are similar in many aspects to the panel assembly device 200 and its constituent components. In some examples, the panel assembly device comprises a first portion or collection assembly 608, a second or assembly portion 602, a third or transition portion 604, and a fourth or egress portion 606. In some examples, the panel assembly device 600 comprises a controller 603. The controller 603 receives input from sensors on the panel assembly device 600 or users working with the panel assembly device 600. Based on the received input, the controller 603 provides signals to initiate certain functions on the panel assembly device 600, as detailed below.

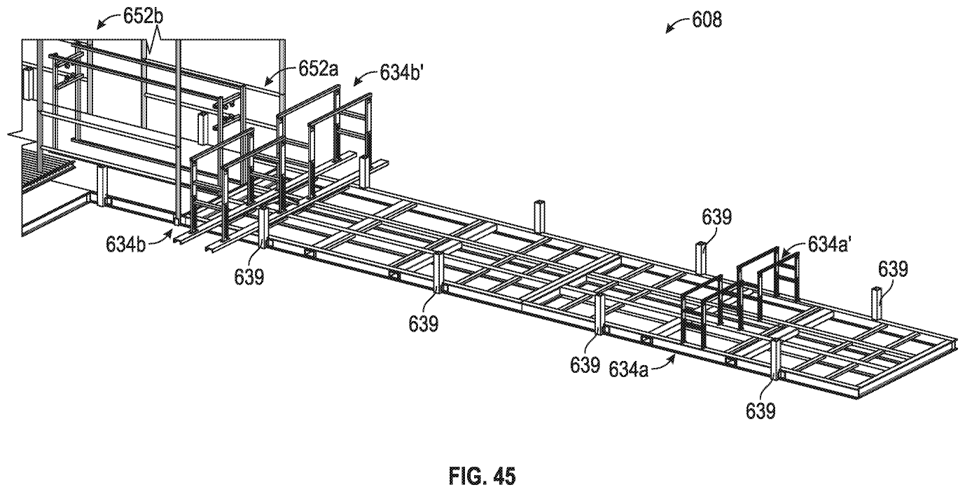

FIG. 45 is a perspective view of the first portion or collection assembly 608. In some examples, the first portion is similar in many aspects to the first portion 208. In some examples, the first portion 208 comprises a plurality of collection frames 634. The collection frames 634 are spaced longitudinally along the first portion 208 similarly to the collection frames 234. In some examples the collection frames 634 are similar in many aspects to the collection frames 234. In some examples, the collection frames 634 comprise a plurality of upstream collection frames 634a, 634a′ and a plurality of downstream collection frames 634b, 634b′. In some examples, the collection frames 634 comprise a first upstream collection frame 634a and a second upstream collection frame 634a′. Similarly, in some examples, the collection frames 634 comprise a first downstream collection frame 634b and a second downstream collection frame 634b′.

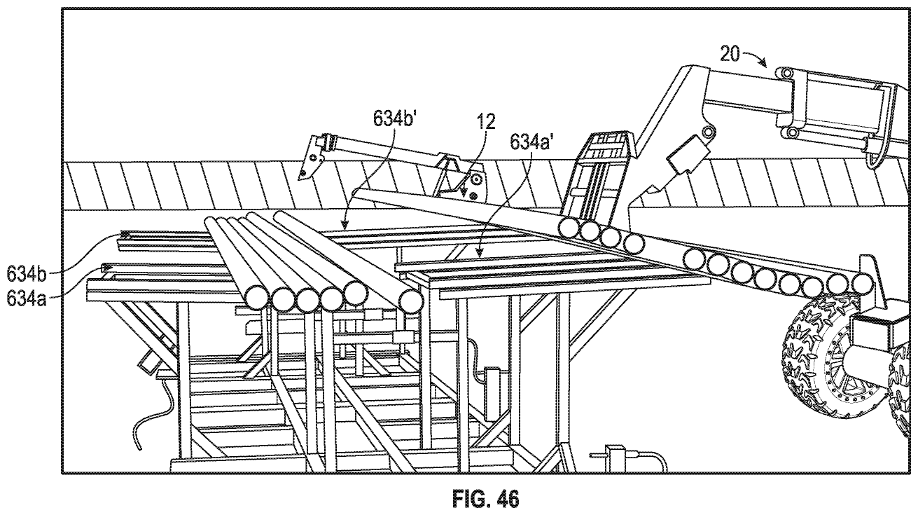

FIG. 46 is another perspective view of the first portion 608. In some examples, the upstream collection frames 634a, 634a′ are longitudinally spaced apart from the downstream collection frames 634b, 634b′ such that a utility vehicle (such as a fork lift) can carry a plurality of torque tubes up to the first portion 608 and deposit the plurality of torque tubes 12 onto the collection frames 634a, 634b or the collection frames 634a′, 634b′. In some examples, the longitudinal spacing of the collection frames 634a′, 634b′ and collection frames 634a, 634b allows for the forks of the forklift to move between the collection frames 634a, 634b and between collection frames 634a′, 634b′.

In some examples, the first portion 608 further comprises a support 645 with a cradle 648. In some examples, the support 645 and cradle 648 are similar in many aspects to the support 245 and cradle 248. In some examples, the cradle 648 comprises one or more sensors. In some examples, the sensors are inductive sensors. The sensors are configured to sense the presence of a torque tube 12 on the cradle 648. The sensors are further configured to generate a signal to the controller 603 indicating the presence or absence of a torque tube 12 upon the cradle 648.

In some examples, like the collection frames 234, the collection frames 634 comprise a stop member 249. The collection frames 634 further comprise one or more sensors. In some examples, the sensors are inductive sensors. The sensors are configured to sense the presence of a torque tube 12 on one or more of the collection frames 634. The sensors are further configured to generate a signal to the controller 603 indicating the presence or absence of a torque tube 12 upon the collection frames 634.

In some examples, based on the input from one or more of the sensors, the controller 603 is configured to generate a signal to actuate the stop member 249 and move the stop member into an engaged or a disengaged position. In some examples, if the controller 603 receives a signal from the sensor of the cradle 648 indicating the absence of a torque tube 12 upon the cradle 648 and if the controller 603 also receives a signal from the sensor of the collection frames 634 indicating the presence of a torque tube 12, The stop member 249 may be actuated and moved into the disengaged position such that a torque tube 12 is permitted to roll into the cradle 648.

Referring back to FIG. 45, In some examples, the first portion 608 includes a first alignment frame 652a and a second alignment frame 652b. In some examples, each of the first alignment frame 652a and the second alignment frame 652b are similar in many aspects to the alignment frame 252 of the first portion 208. In some examples the first alignment frame 652a and the second alignment frame 652b are longitudinally spaced from each other. In some examples, the inclusion of both the first alignment frame 652a and the second alignment frame 652b prevents bending and deflection of the torque tubes 12 along the length of the torque tubes 12 as the torque tubes pass through the alignment frame 652a.

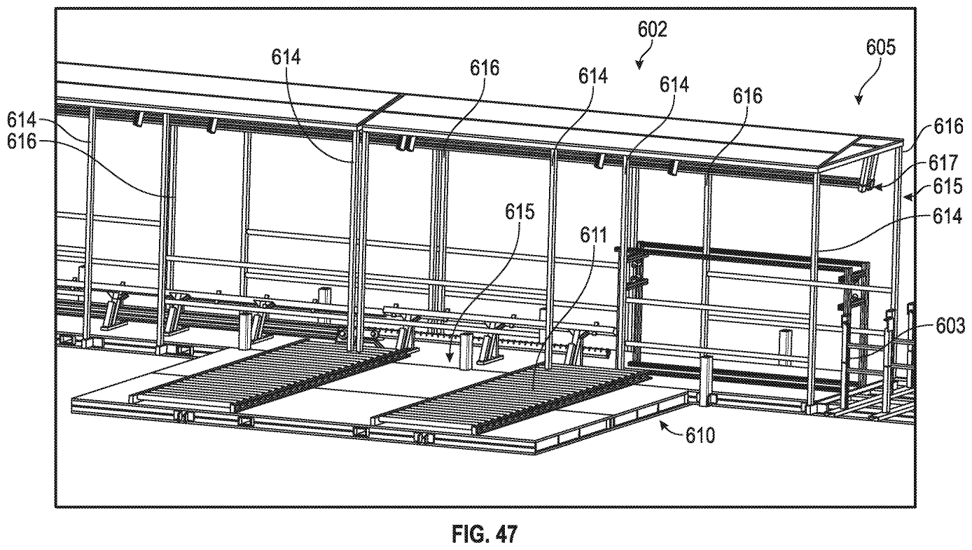

FIG. 47 is a perspective view of the second portion 602 of the panel assembly device 600. In some examples, the second portion 602 is similar in many aspects to the second portion 202 of the panel assembly device 600. In some examples, the second portion 602 comprises a support assembly 615 with a plurality of vertical columns that support an enclosure roof 605. In some examples, the plurality of vertical columns comprise a first rail portion 614 and a second rail portion 616 arranged on front and rear sides of the second portion 602, respectively. In some examples, the enclosure roof 605 extends between the first rail portion 614 and the second rail portion 616. In some examples, one or more horizontally arranged railings extend between the first rail portions 614. Likewise, in some examples, one or more horizontally arranged railings extend between the second rail portions 616.

In some examples, the support assembly 615 further comprises a plurality of walls. In some examples, the walls comprise solid panels. In other examples, the walls comprise one or more curtains. In some examples, the support assembly 615 provides shelter for workers and solar panel components working in and around the panel assembly device 600. Specifically, the support assembly 615 provides sun, wind, and rain shelter to the workers and/or solar panel components. In some examples, the support assembly 615 extends along the second portion 602 and the third portion 604.

In some examples, the second portion 602 comprises an ingress frame portion 610. The ingress frame portion 610 extends from the front of the second portion 602. In some examples, the ingress frame portion 610 provides a pathway for panels 14 to be moved into the second portion 602 of the panel assembly device 600. In some examples, the ingress frame portion 610 comprises a plurality of rollers 611 on which panels 14 may be placed. The rollers 611 facilitate placement of the panels 14 into the second portion 602. In some examples, the plurality of rollers 611 allow for a pallet of panels to be rolled onto the second portion 602 so that they can be easily accessed by a worker within the panel assembly device 600.

In some examples, the second portion further includes a lower panel support portion 613 and an upper panel support portion 617.

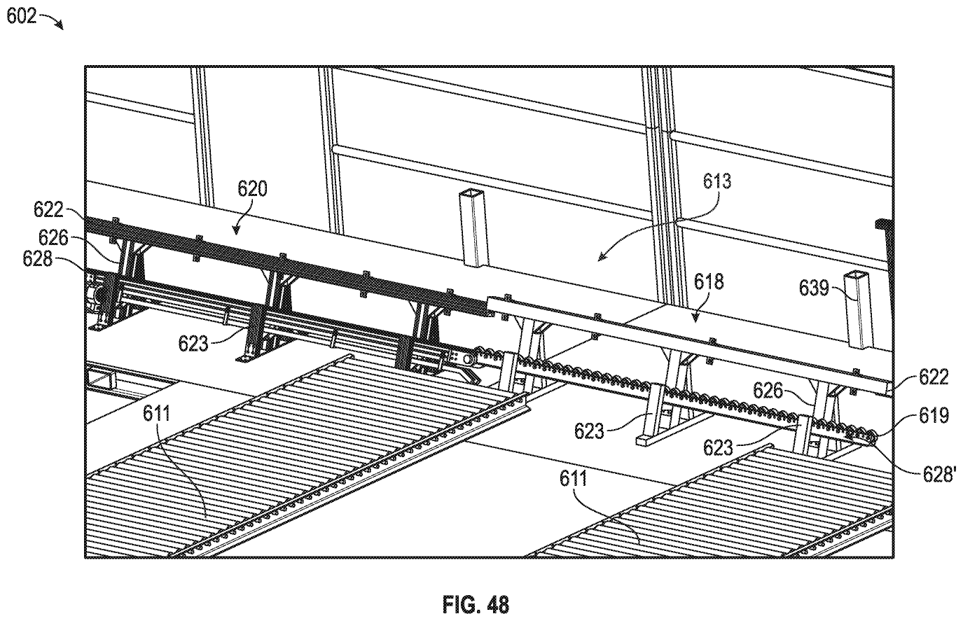

FIG. 48 is a perspective view of the lower panel support portion 613. In some examples, the lower panel support portion 613 comprises a panel placement portion 618 and a panel movement portion 620.

In some examples, the panel movement portion 620 comprises a frame member 622, a first panel 626, and a conveyance 628, which are similar in many aspects to the first frame member 222, the first panel 226, and the conveyance 228. In some examples, the panel movement portion 620 is configured to support and move the panel along the panel assembly device 600. In some examples, the controller 603 is configured to initiate movement of the conveyance 228 to move panels along the panel movement portion 620. In some examples, the controller 603 is configured to receive input from one or more sensors positioned about the panel assembly device 600 that detect the location of one or more components of the final panel assembly 18. In some examples, based on this input, the controller 603 is configured to initiate movement of the conveyance 228.

In some examples, the panel placement portion 618 is similar in many aspects to the panel movement portion 620. In some examples, the panel placement portion 618 comprises a conveyance 628′ which comprises a plurality of rollers 619. In some examples, the plurality of rollers 619 allow for the panel to be moved along the panel assembly device onto the panel movement portion 620. In some examples, the plurality of rollers 619 are less susceptible to damage than the conveyance 628 of the panel movement portion 620. Thus, the panel placement portion 618 is configured to withstand repeated forcible placement of the panels 14 onto the panel placement portion 618. In some examples, the panel placement portion 618 is arranged on the second portion 602 between the panel movement portion 620 and the first portion 208.

In some examples, each of the panel placement portion 618 and the panel movement portion 620 comprise one or more panel retention posts 623. In some examples, the panel retention posts 623 are arranged in front of the conveyance 628 to prevent a bottom edge of the panel 14 from sliding off of the conveyance 628.

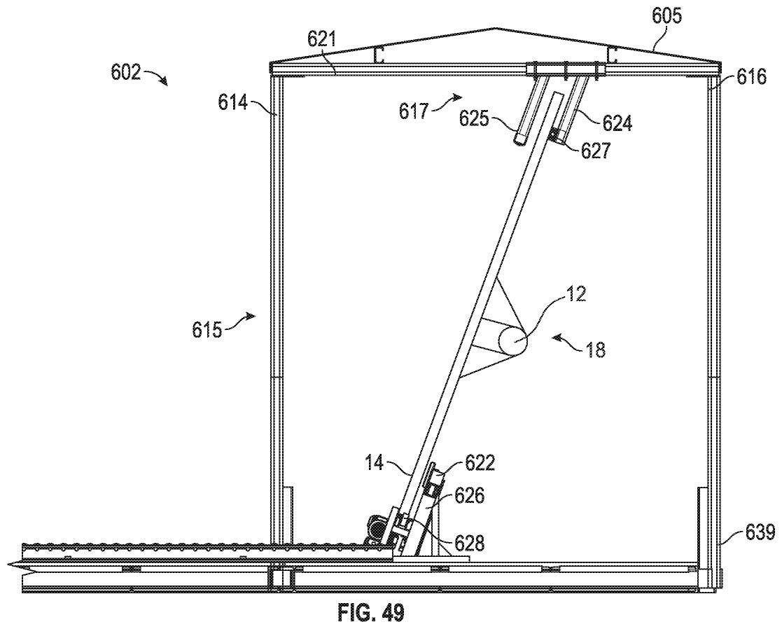

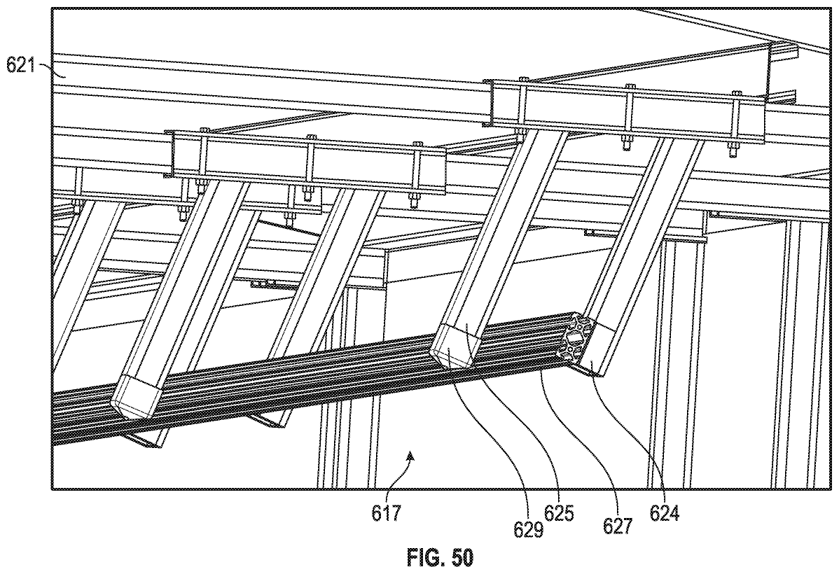

FIG. 49 is a side view of the second portion 602 with a panel 14 inserted therein. As shown in FIG. 49, in some examples, the second portion further comprises one or more horizontal beams 621 that extend between the first rail portion 614 and the second rail portion 616. In some examples the horizontal beams 621 further support the roof 605. In some examples the horizontal beams 621 further support a upper panel support portion 617.

In some examples, the upper panel support portion 617 comprises a upper panel support surface 624, an upper panel contacting beam 627, a upper panel retention surface 625. In some examples, each of the upper panel support surface 624 and the upper panel retention surface 625 extend down from the horizontal beam 621. In some examples, each of the upper panel support surface 624 and the upper panel retention surface 625 extend towards the front of the panel assembly device 600. In some examples, a plurality of upper panel support surfaces 624 and upper panel retention surfaces 625 extend along the length of the second portion 602. In some examples, each of the upper panel support surfaces 624 and the upper panel retention surfaces 625 comprise a beam. In some examples, one or more upper panel contacting beams 627 is connected to and extends between a lower end of two or more upper panel support surfaces 624. In some examples, the upper panel support portion 617 is arranged such that when a panel 14 is inserted into the second portion 602, the panel 14 is supported at a rear side thereof by the upper panel support surface 624. Specifically, the upper end of the panel 14 contacts the upper panel contacting beam 627, which is supported by the upper panel support surface 624. Furthermore, the upper panel retention surface 625 extends over an upper end of the front side of the panel 14. The upper panel retention surface 625 prevents the panel 14 from being blown (by wind) or knocked (by an operator or piece of equipment) off of the upper panel contacting beam 627.

FIG. 50 is a perspective view of the upper panel support portion 617. As shown in the examples of FIG. 50, in some examples the upper panel retention surface 625 comprises a panel shield 629. The panel shield 629 prevents damage to the panel 14 when the panel 14 contacts the upper panel retention surface 625. In some examples, the panel shield 629 comprises a rubber sleeve that extends over the upper panel retention surface 625.

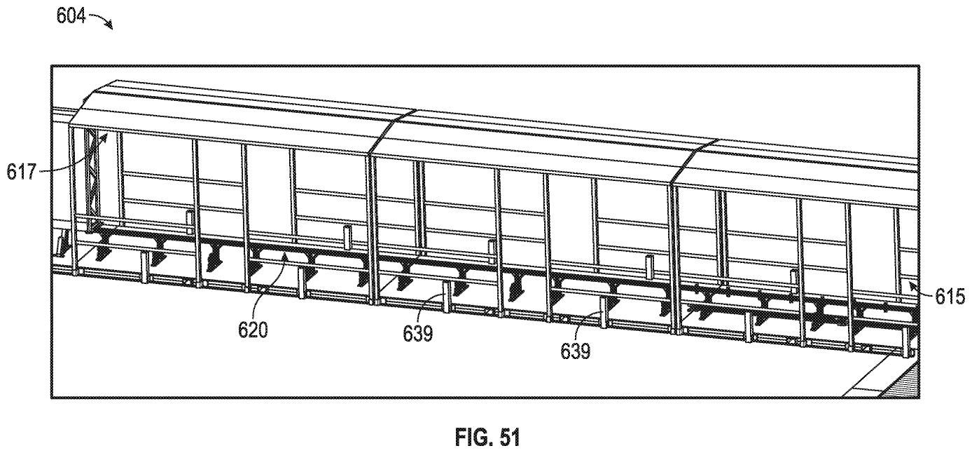

FIG. 51 is a perspective view of the third portion 604 of the panel assembly device 600. In some examples, the third portion 604 is similar in many aspects to the third portion 204. In some examples, the third portion 604 is similar in many aspects to the second portion 602. Specifically, the third portion 604 comprises a support assembly 615 that is similar to the support assembly 615 of the second portion 602. In some examples, the third portion further comprises a upper panel support portion 617. In some examples, the upper panel support portion 617 of the third portion 604 is similar in many aspects to the upper panel support portion 617 of the second portion 602. Furthermore, the third portion 604 comprises a panel movement portion 620. The panel movement portion 620 is similar in many aspects to the panel movement portion 620 of the second portion 602.

In some examples, the third portion 604 serves as a staging area into which the torque tube 12 and the panel 14 as the assembly (e.g., torque tube 12, panel 14, bracket 15) can be moved after being assembled in the second portion 602. After moving through the third portion 604, the torque tube 12 and the panel 14 as the assembly (e.g., torque tube 12, panel 14, bracket 15) moves into the fourth portion 606.

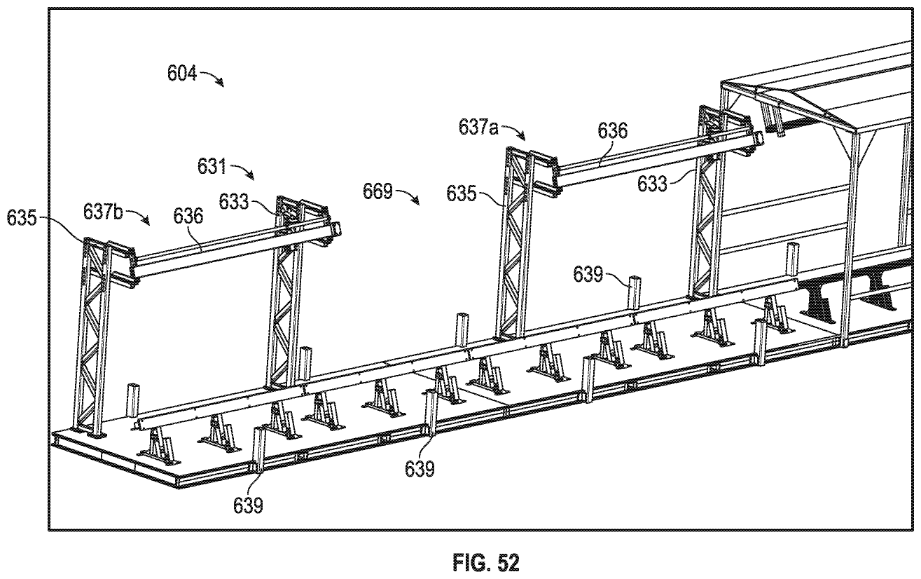

FIG. 52 is a perspective view of the fourth portion 606. In some examples, the fourth portion 606 is similar in many aspects to the third portion 604. The fourth portion comprises a panel movement portion 620. The panel movement portion 620 is similar in many aspects to the panel movement portion 620 of the third portion 604. In some examples, the fourth portion 606 comprises an upper panel support portion 631. The upper panel support portion 631 comprises a first tower assembly 637. The first tower assembly 637a comprises a first tower 633, a second tower 635, and a upper panel contacting beam 636 extending between the first tower 633 and the second tower 635. In some examples, the upper panel contacting beam 636 is configured similarly to the upper panel contacting beam 627 of the upper panel support portion 617 in that the upper panel contacting beam 636 is held by the first tower 633 and second tower 635 at relatively the same height, fore-aft distance, and angle as the upper panel contacting beam 627. In some examples, the upper panel support portion 631 further comprises a second tower assembly 637b. In some examples, the second tower assembly 637b is similar in many aspects to the first tower assembly 637a. In some examples, the first tower assembly 637a and the second tower assembly 637b are separated by an aperture 669. In some examples, the torque tube 12 and the panel 14 as the assembly (e.g., torque tube 12, panels 14, brackets 15) extend between the first tower assembly 637a and the second tower assembly 637b across the gap. The aperture 669 provides a location through which the torque tube 12 and the panel 14 as the assembly (e.g., torque tube 12, panels 14, brackets 15) may be grasped through the rear side of the panel assembly device 600.

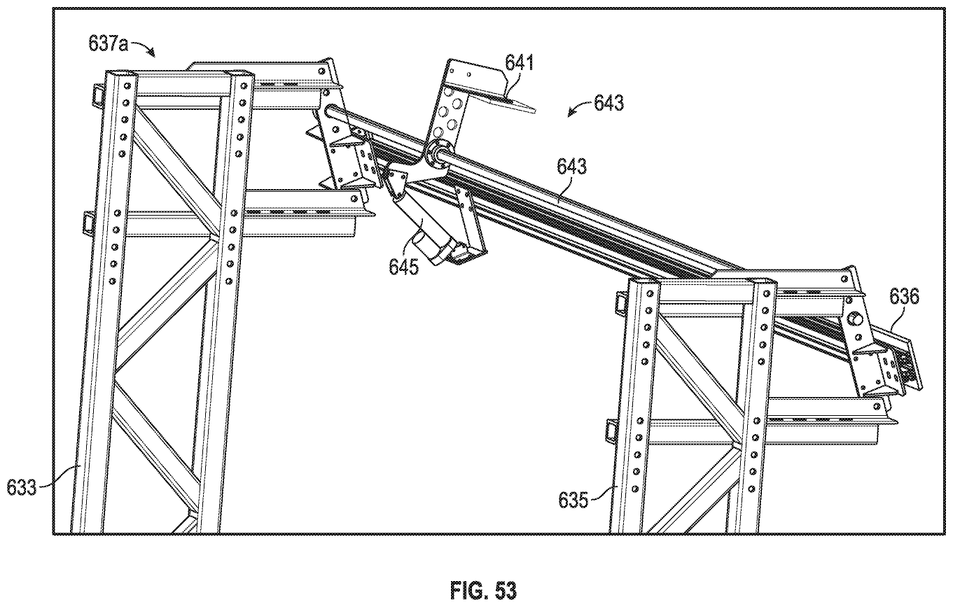

FIG. 53 is a rear perspective view of the first tower assembly 637a. In some examples, the first tower assembly comprises a retractable upper panel retention surface 643. In some examples, the retractable upper panel retention surface 643 is configured to be in a lowered, retaining position, in which it is positioned over a final panel assembly 18 to prevent the final panel assembly from being blown or knocked off of the upper panel contacting beam 636 as the final panel assembly 18 is moved onto the fourth portion 606. The retractable upper panel retention surface 643 is further configured to be in a raised, non-retaining position once the final panel assembly 18 is ready to be lifted off of the fourth portion 606. In some examples, the retractable upper panel retention surface comprises a retaining arm 641, a pivot beam 647, and a cylinder 649. In some examples, the retaining arm 641 is configured to be rotated between a lowered, retaining position and a raised, non-retaining position. In some examples, the retaining arm 641 is coupled to the pivot beam 647. The pivot beam extends between the first tower 633 and the second tower 635. The pivot beam is configured to be rotatable along its longitudinal axis as the retaining arm 641 rotates between a raised and a lowered position. The cylinder 649 is coupled between the retaining arm 641 and the upper panel contacting beam 636 and drives the rotation of the retaining arm 641. In some examples, the cylinder 649 is a hydraulic, pneumatic, or electric cylinder.

Referring back to FIGS. 44-52, in some examples, each of the first portion 608, second portion 602, third portion 604, and fourth portion 606 comprise a lifting device 639. In some examples, each of the first portion 608, second portion 602, third portion 604, and fourth portion 606 comprise multiple lifting devices 639 arranged around each of the first portion 608, second portion 602, third portion 604, and fourth portion 606. In some examples, the lifting devices 639 are connected to a floor member of each of the first portion 608, second portion 602, third portion 604, and fourth portion 606 and function to lift the floor member and the respective first portion 608, second portion 602, third portion 604, and fourth portion 606 to a desired height. In some examples, the lifting devices 639 contact a surface on which the panel assembly device 600 is placed and are each able to lift the first portion 608, second portion 602, third portion 604, and fourth portion 606 to the same level height. In some examples, the lifting devices 639 each comprise a sleeve and a leveling jack. In some examples, the leveling jack utilizes a self-locking worm drive for height adjustment.

In some examples, each of the first portion 608, second portion 602, third portion 604, and forth portion 606 are separate modular portions that can be broken apart from each other and connected back together. In some examples, each of the first portion 608, second portion 602, third portion 604, and fourth portion 606 comprise separate modular sub-portions that can be broken apart from each other and connected together. In some examples, the modular structure of the panel assembly device 600 enables the panel assembly device 600 to be quickly and easily transported, constructed, and deconstructed. This is because each modular unit is able to be separately transported to or from the location in which it is to be placed. In some examples, the easy deconstruction and construction of the panel assembly device 600 is beneficial, because it allows for the panel assembly device to be more easily deconstructed moved and constructed in close proximity to the location at which each of the solar panel assemblies 18 is to be installed. In some examples, the modular units of the first portion 608, second portion 602, third portion 604, and fourth portion 606 each comprise one or more lifting devices 639 that allow each of the modular units to be separately raised and lowered.

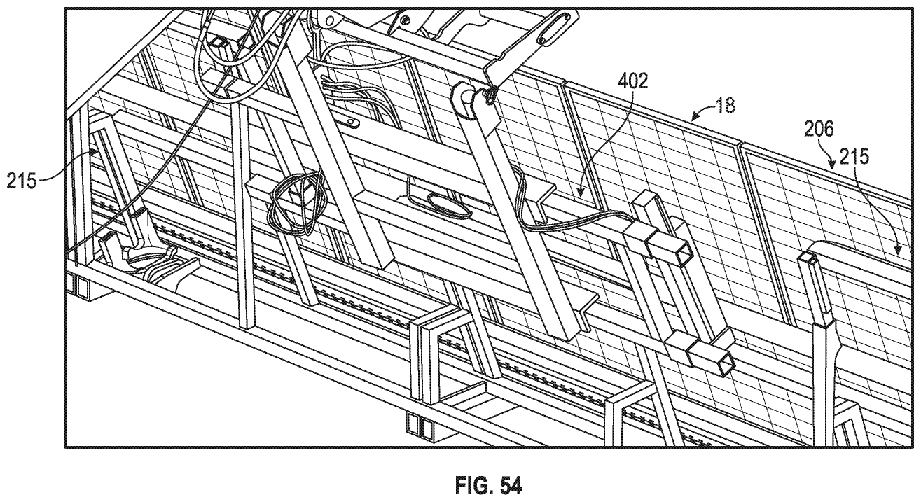

FIG. 54 is a rear view of the fourth portion 206 of the panel assembly device 200 through which the vehicle 400 can pick up and grab the panel 14 as the assembly (e.g., torque tube 12, panel 14, bracket 15). In the example of FIG. 53, the vehicle attachment 402 is inserted through the space between the longitudinally spaced support assemblies 215 to grab onto the torque tube 12 of the torque tube 12, panel 14, bracket 15 assembly.

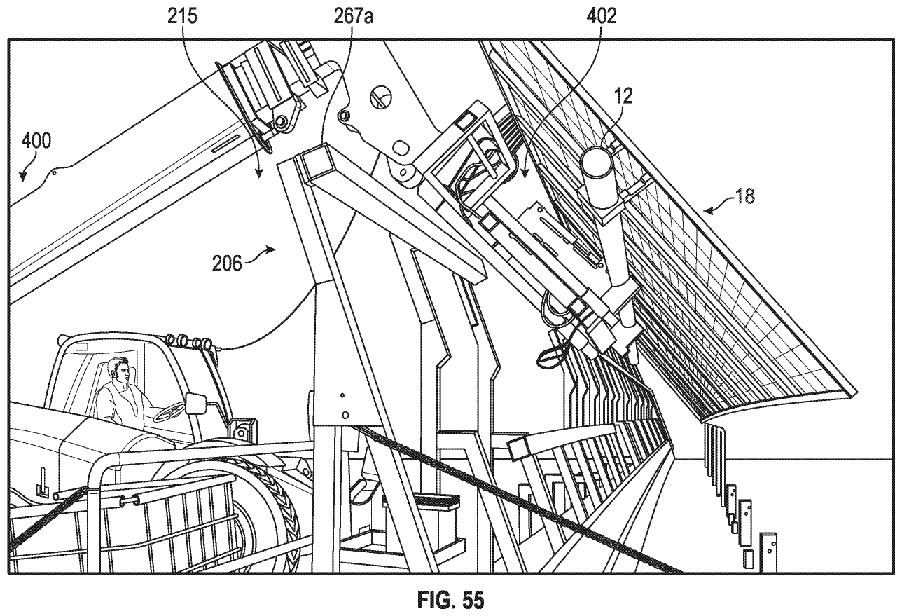

FIG. 55 is a side view of the fourth portion 206 of the panel assembly device 200 through which the vehicle 400 can pick up and grab the final panel assembly 18. As shown in FIG. 54, after the vehicle attachment 402 is secured around the torque tube 12 of the final panel assembly 18, the vehicle attachment 402 and final assembly can be lifted upwards. Specifically, after the vehicle attachment 402 is secured around the torque tube 12 of the final panel assembly 18, the vehicle attachment 402 is moved upwardly through the aperture 269 and lifts the final panel assembly 18 above the upper extent 267a of the support assemblies 215.

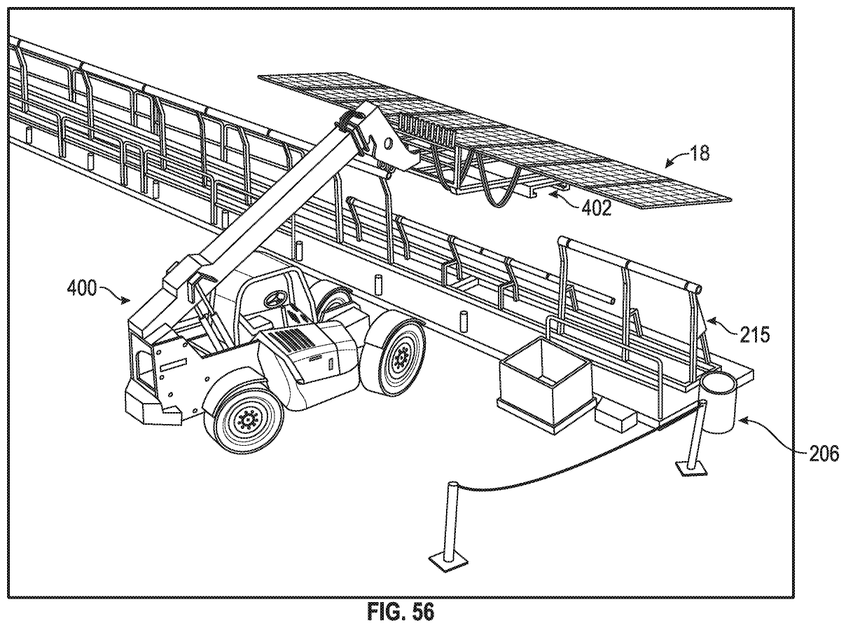

FIG. 56 is a rear perspective view of fourth portion 206 of the panel assembly device 200. Specifically, FIG. 55 depicts the vehicle 400 lifting the final panel assembly 18 over the upper extent 267a of the support assemblies 215 to a position where the entire final panel assembly 18 can be moved over the upper extent 267a of the support assemblies 215. In this manner, the vehicle 400 is able to move the final panel assembly 18 to another location away from the fourth portion 206 and the panel assembly device 200.

While certain features are described above with reference to one of the panel assembly device 200 or the panel assembly device 600, such features may be incorporated between either of the panel assembly device 200 or the panel assembly device 600.

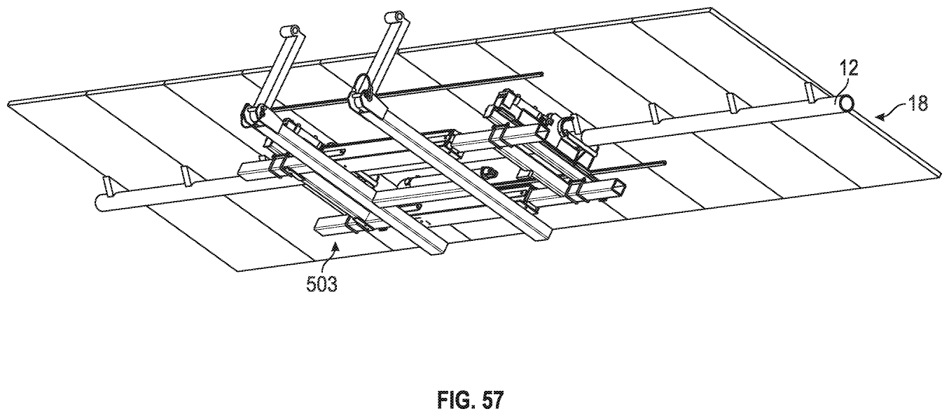

FIG. 57 is a rear perspective view of another example attachment 503. In some examples, the attachment 503 is similar in many aspects to the attachment 402. In some examples, like the attachment 402, the attachment 503 is configured to be used in connection with the vehicle 400. As shown in the example of FIG. 57, like the attachment 402, the attachment 503 is configured to grasp a torque tube 12 of a final panel assembly 18 in order to deliver the final panel assembly 18 to a desired location.

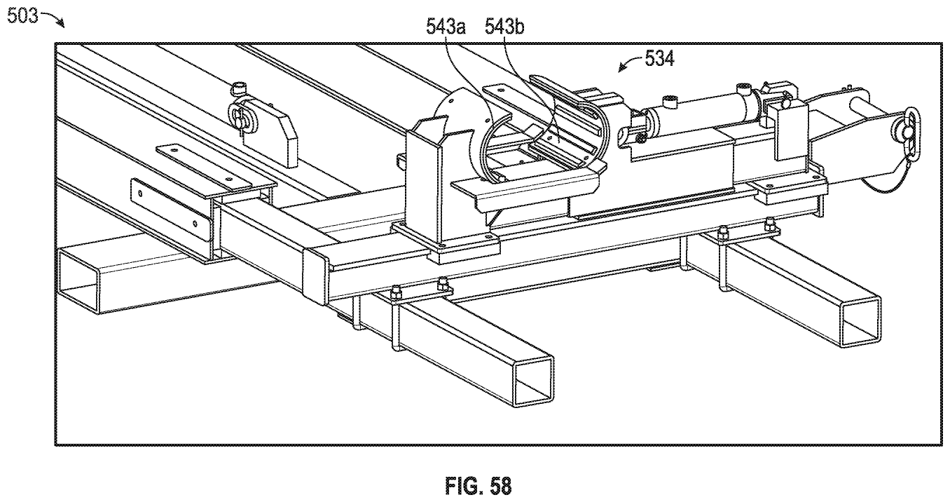

FIG. 58 is a perspective view of the example attachment 503. Like the attachment 402, the attachment 503 comprises a grasping assembly 534. The grasping assembly 534 is similar in many aspects to the grasping assembly 434 of the attachment 402. For example, like the grasping assembly 434, the grasping assembly 534 comprises a plurality of pads 543 for gripping a torque tube 12. The pads 543, however, differ from the pads 443 of the grasping assembly 434 in that the pads 543 are shaped semi-cylindrically. In some examples the pads 543 comprise a first pad 543a and the second pad 543b, each of which are shaped as a semi-cylinder. In some examples, the diameter of each of the pads 543 is shaped slightly larger, but generally similar in diameter to the torque tube 12 of the final panel assembly 18. In some examples, the pads 543 each comprise one or more retaining ribs 545. In some examples, the pads 543 comprise a soft, non-metallic material, such as, for example, rubber. In some examples, when moved together to grasp a torque tube 12, the pads 543a, 543b mate together form a cylinder around the torque tube 12. In some examples, the shape and material makeup work together to limit any rotation of the torque tube 12 and final panel assembly 18 that is grasped by the attachment 503 as the final panel assembly 18 is moved by the vehicle to the desired location.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

This disclosure should be understood to include (as illustrative and not limiting) the subject matter set forth in the following numbered clauses:

Clause 1. A resource management system, comprising: a user interface;
a controller communicably coupled with the user interface, the controller operable to obtain a geographical map including a plurality of target locations for at least one component; and
a location determiner operably coupled to the controller, the location determiner operable to determine a first location of at least a portion of the resource management system;
the user interface operable to display at least one screen layout comprising:
   (i) a first indicator representing the first location;
   (ii) a second indicator representing a current location of a first component of the at least one component; and
   (iii) a third indicator representing at least one target location of the plurality of target locations of the at least one component.

Clause 2. The resource management system of any of the preceding clauses, further comprising a memory storing instructions that, when executed by the controller, cause the resource management system to receive a first communication from a remote network, the first communication including a status of the at least one component.

Clause 3. The resource management system of any of the preceding clauses, wherein the at least one screen layout comprises a fourth indicator representing the status of the at least one component.

Clause 4. The resource management system of any of the preceding clauses, wherein the status of the at least one component is one of a ready status and a not-ready status.

Clause 5. The resource management system of any of the preceding clauses, wherein the plurality of target locations comprises a first class of target locations and a second class of target locations, and the at least one component comprises a first component associated with the first class of target locations and a second component associated with the second class of target locations, and the third indicator represents a first target location of the first class of target locations when the at least one component is the first component.

Clause 6. The resource management system of any of the preceding clauses, wherein the memory stores additional instructions that, when executed by the controller, cause the resource management system to perform a set of operations comprising providing a prompt to a user via the user interface when the location determiner is sensed at a position proximate to one of the current location of the first component and the at least one target location.

Clause 7. The resource management system of any of the preceding clauses, wherein the prompt is selected from a plurality of prompts, wherein each of the plurality of prompts is associated with one of the current location of the at least one component and a target location of the at least one target location of the at least one component.

Clause 8. The resource management system of any of the preceding clauses, wherein the set of operations further comprises: providing a confirmation of pickup prompt when the first location is sensed proximate to the current location of the at least one component.

Clause 9. The resource management system of any of the preceding clauses, wherein the set of operations further comprises: to providing a confirmation of placement prompt when the first location is sensed proximate to the target location.

Clause 10. The resource management system of any of the preceding clauses, further comprising a memory storing instructions that, when executed by the controller, cause the system to perform a set of operations comprising determining pre-staging positions for delivery of a bundle of a plurality of the at least one component.

Clause 11. The resource management system of any of the preceding clauses, further comprising a database communicably coupled to the controller, wherein the database is operable to store component information.

Clause 12. The resource management system of any of the preceding clauses, wherein the component information comprises an inventory count of the at least one component.

Clause 13. The resource management system of any of the preceding clauses, wherein the component information comprises a location of the at least one component.

Clause 14. The resource management system of any of the preceding clauses, wherein the at least one component includes a first class of components and a second class of components, and the component information includes a first inventory count of the first class of components and a second inventory count of the second class of components.

Clause 15. The resource management system of any of the preceding clauses, further comprising a memory storing instructions that, when executed by the controller, cause the resource management system to perform a set of operations comprising providing instructions to the user interface to display a first indicator on the at least one screen layout representative of the first class of components and a second indicator on the at least one screen layout representative of the second class of components.

Clause 16. The resource management system of any of the preceding clauses, wherein the at least one component includes a third class of components, and wherein the set of operations further comprises operating according to a first module associated with the first class of components and a second module associated with the third class of components.

Clause 17. The resource management system of any of the preceding clauses, wherein the set of operations further comprises switching between the first module and the second module based upon a user input from a user.

Clause 18. The resource management system of any of the preceding clauses, further comprising an optical sensor operably coupled to the controller, wherein the at least one screen layout is a first screen layout, and the set of operations further comprises operating according to a third module displaying a second screen layout including a view of the optical sensor.

Clause 19. The resource management system of any of the preceding clauses, wherein the at least one screen layout is a first screen layout, and the set of operations further comprises operating according to a third module displaying a second screen layout, and the second screen layout includes viewing a path traveled by a remote vehicle.

Clause 20. The resource management system of any of the preceding clauses, further comprising a memory storing instructions that, when executed by the controller, cause the resource management system to perform a set of operations comprising determining a pre-staging position and displaying the pre-staging position on the geographical map.

Clause 21. The resource management system of any of the preceding clauses, wherein the set of operations further comprises generating a route map on the geographical map for moving the at least one component between the current location of the at least one component and the at least one target location.

Clause 22. The resource management system of any of the preceding clauses, wherein the set of operations further comprises determining a pre-staging position based on the current location of the at least one component and the at least one target location.

Clause 23. A method, comprising:
obtaining, at a controller, a geographical map from a remote network, the geographical map including a plurality of target locations for at least one component, the plurality of target locations comprises a first class of target locations for a first component of the at least one component and a second class of target locations for a second component of the at least one component;
obtaining, at the controller, a first communication from a remote communication device, the first communication comprising a component identifier indicating the at least one component is one of the first component and the second component;
determining, using a GPS sensor, a first location of a utility vehicle;
determining a first intended location of the first class of intended locations when the component identifier is the first component; and
displaying on a display at least one screen layout, the at least one screen layout including:
   (i) a marker indicating the first location;
   (ii) a marker indicating a current location of the at least one component; and
   (iii) a marker indicating the first target location.

Clause 24. The method of any of the preceding clauses, wherein the at least one component is a solar assembly.

Clause 25. The method of any of the preceding clauses, wherein the first communication comprises a status of the at least one component.

Clause 26. The method of any of the preceding clauses, wherein the at least one screen layout further includes: (iv) the status of the at least one component.

Clause 27. The method of any of the preceding clauses, further comprising determining a second target location of a second class of target locations when the component identifier is the second component.

Clause 28. The method of any of the preceding clauses, further comprising generating a route between the current location of the at least one component and the first target location.

Clause 29. The method of any of the preceding clauses, wherein the at least one screen layout includes at least one indicator representative of an inventory of the at least one component.

Clause 30. The method of any of the preceding clauses, wherein the at least one indicator comprises a first indicator representative of a first inventory of the first class of components and a second indicator representative of a second inventory of the second class of components.

Clause 31. A conveying system for assembly of a plurality of solar panels onto a torque tube, the conveying system comprising:
a frame assembly configured to support the torque tube and plurality of solar panels during assembly of the plurality of solar panels onto the torque tube, the frame assembly comprising:
   a first portion including a torque tube support member and a panel support member, the torque tube support member being configured to support at least a portion of the torque tube at a predetermined height as the torque advances along the first portion and the panel support member to position each panel of the plurality of panels proximate the torque tube for securing of each panel to the torque tube,
   a second portion positioned adjacent to the first portion, and
   a third portion positioned adjacent to the second portion and defining an egress configured to provide access to the torque tube for removal from the frame assembly;
a first conveyance positioned with the first portion of the frame assembly, the first conveyance operable to move at least one of the torque tube and plurality of solar panels at a first rate;
a second conveyance positioned with the second portion of the frame assembly, the second conveyance operable to move the torque tube and plurality of solar panels at a second rate that is greater than the first rate.

Clause 32. The conveying system of any of the preceding clauses, wherein panel support member of the first portion of the frame assembly includes a first rail and a second rail, the first rail defining a trough operable to receive an end of each of the plurality of solar panels and the second rail configured to receive a surface of the each of the plurality of solar panels.

Clause 33. The conveying system of any of the preceding clauses, wherein the first conveyance is positioned adjacent to the trough.

Clause 34. The conveying system of any of the preceding clauses, wherein the second rail provides a surface along which the plurality of panels are configured to translate.

Clause 35. The conveying system of any of the preceding clauses, wherein the first portion of the frame assembly includes a bracket support rail configured to support a bracket during assembly of a panel of the plurality of panels onto the torque tube.

Clause 36. The conveying system of any of the preceding clauses, wherein the frame extends along a longitudinal axis, and wherein the second conveyance includes a rotating member defining a surface, wherein at least a portion of the surface is configured to move generally parallel to the longitudinal axis toward the third portion of the frame assembly.

Clause 37. The conveying system of any of the preceding clauses, wherein the torque tube support member includes a free rotating member.

Clause 38. The conveying system of any of the preceding clauses, wherein the frame assembly comprises a fourth portion coupled to the first portion, the fourth portion comprises a collection assembly, and the collection assembly comprises a laterally extending frame member.

Clause 39. The conveying system of any of the preceding clauses, wherein the collection assembly defines a collection torque tube raceway extending along a first axis.

Clause 40. The conveying system of any of the preceding clauses, wherein the laterally extending frame member is angled downwardly between a position laterally outwardly of the first axis and a position adjacent the first axis.

Clause 41. The conveying system of any of the preceding clauses, wherein the collection assembly comprises a stop member extending upwardly from the laterally extending frame member.

Clause 42. The conveying system of any of the preceding clauses, wherein the collection assembly further comprises a third conveyance, and the third conveyance includes a rotating member defining a surface, wherein at least a portion of the surface is configured to move generally parallel to the first axis toward the first portion of the frame assembly.

Clause 43. The conveying system of any of the preceding clauses, further comprising a sprocket rotatably coupled to the rotating member about a sprocket axis, a motor offset from the sprocket axis, and an endless member coupled between the motor and the sprocket.

Clause 44. The conveying system of any of the preceding clauses, further comprising a frame member defining a portion of an aperture, and the aperture is generally aligned with the first axis.

Clause 45. The conveying system of any of the preceding clauses, further comprising at least one roller positioned adjacent the aperture, the at least one roller defining a rolling axis non-parallel to the first axis.

Clause 46. The conveying system of any of the preceding clauses, wherein the at least one roller includes a first roller and a second roller, the first roller defines a first roller axis, the second roller defines a second roller axis offset from the first roller axis, and each of the first roller axis and the second roller axis are non-parallel to the first axis.

Clause 47. The conveying system of any of the preceding clauses, further comprising a funnel extending outwardly from the frame member, the funnel generally coaxial with the first axis.

Clause 48. The conveying system of any of the preceding clauses, wherein the frame assembly extends along a longitudinal axis and the frame assembly defines a first frame side on a first lateral side of the longitudinal axis and a second frame side on a second lateral side of the longitudinal axis opposite the first frame side, an ingress is positioned on the first frame side, the egress is positioned on the second frame side, and the torque tube support member is positioned on the second frame side and extending generally parallel to the longitudinal axis.

Clause 49. The conveying system of any of the preceding clauses, wherein the torque tube support member defines a face with a low coefficient of friction.

Clause 50. A bracket for temporarily securing a panel to a support member, the bracket comprising:
a body defining a first receiving portion configured to receive a portion of a support member and a second receiving portion configured to receive a portion of a panel;
a first clamping member moveably coupled to the body proximate the first receiving portion, wherein the first clamping member and the body are configured to be secured to and surround the portion of the support member; and
a second clamping member moveably coupled to the body proximate the second receiving portion, wherein the second clamping member and the body are configured to sandwich the portion of the panel.

Clause 51. The bracket of any of the preceding clauses, further comprising a first fastener operable to restrict movement of the first clamping member relative to the body when in an engaged configuration.

Clause 52. The bracket of any of the preceding clauses, wherein the first clamping member is hinged relative to the body.

Clause 53. The bracket of any of the preceding clauses, wherein the first fastener is supported by one of the body and the first clamping member.

Clause 54. The bracket of any of the preceding clauses, wherein the first fastener is a tool-less fastener.

Clause 55. The bracket of any of the preceding clauses, wherein the second receiving portion of the body includes a first substantially planar surface and the second clamping member includes a second substantially planar surface that is positioned substantially parallel to and moveable relative to the first substantially planar surface.

Clause 56. The bracket of any of the preceding clauses, further comprising a second fastener, wherein the second fastener is configured to restrict movement of the second clamping member relative to the body.

Clause 57. The bracket of any of the preceding clauses, wherein the second fastener is a tool-less fastener.

Clause 58. The bracket of any of the preceding clauses, wherein at least one of the first substantially planar surface and the second substantially planar surface includes at least one of a surface texture and surface treatment configured to increase friction or grip on the portion of the panel.

Clause 59. A removable attachment configured to be removably coupled to a vehicle for transportation of an object at a worksite, the vehicle including a mount and a hydraulic pressure source, the removable attachment comprising:
a mounting portion including at least one coupling member configured to be removably coupled to the mount of the vehicle; and
a material handling assembly including:
a grasping assembly configured to secure the object, the grasping assembly including a contact portion and at least one first actuator coupled to the contact portion and operable to actuate the contact portion; and
a lateral movement assembly supporting the grasping assembly, the lateral support member including a second actuator operably coupled to the grasping assembly and operable to cause lateral movement of the grasping assembly.

Clause 60. The removable attachment of any of the preceding clauses, wherein the mounting portion includes at least one hollow tube member within which forks of a telehandler are received.

Clause 61. The removable attachment of any of the preceding clauses, wherein the mounting portion further includes at least one pin operable to constrain the forks of the telehandler within the at least one hollow tube member.

Clause 62. The removable attachment of any of the preceding clauses, wherein the at least one hollow tube member extends longitudinally, and material handling assembly includes at least one secondary hollow tube member extending laterally and supported by the at least one hollow member of the mounting portion.

Clause 63. The removable attachment of any of the preceding clauses, wherein the material handling assembly includes at least one sliding tube slidably received within the at least one secondary hollow tube member, the at least on sliding tube supporting the grasping assembly.

Clause 64. The removable attachment of any of the preceding clauses, wherein the second actuator is operable to cause the at least one sliding tube to slide within the at least one secondary hollow tube member.

Clause 65. The removeable attachment of any of the preceding clauses, wherein the lateral movement assembly includes wear pads positioned between the at least on sliding tube and the at least one secondary hollow tube member.

Clause 66. The removeable attachment of any of the preceding clauses, wherein the wear pads are shims that are configured to be repositioned after wear.

Clause 67. The removable attachment of any of the preceding clauses, wherein the contact portion of the grasping assembly includes a first arm and a second arm, wherein the first arm is stationary relative to the at least one sliding member of the lateral movement assembly and the second arm is moveable relative to the at least one sliding member of the lateral movement assembly.

Clause 68. The removable attachment of any of the preceding clauses, wherein the at least one actuator is operable to translate the second arm toward and away from the first arm.

Clause 69. The removable attachment of any of the preceding clauses, wherein the first and second arms of the contact portion include receiving surfaces, the receiving surfaces including replaceable grip pads.

What is claimed is:

1. A resource management system, comprising:
a user interface;
a controller communicably coupled with the user interface, the controller operable to obtain a geographical map including a plurality of target locations for at least one component; and
a location determiner operably coupled to the controller, the location determiner operable to determine a first location of at least a portion of the resource management system;
the user interface operable to display at least one screen layout comprising:
(i) a first indicator representing the first location;
(ii) a second indicator representing a current location of a first component of the at least one component; and
(iii) a third indicator representing at least one target location of the plurality of target locations of the at least one component.

2. The resource management system of claim 1, further comprising a memory storing instructions that, when executed by the controller, cause the resource management system to receive a first communication from a remote network, the first communication including a status of the at least one component, wherein the at least one screen layout comprises a fourth indicator representing the status of the at least one component, and wherein the status of the at least one component is one of a ready status and a not-ready status.

3. The resource management system of claim 1, wherein the plurality of target locations comprises a first class of target locations and a second class of target locations, and the at least one component comprises a first component associated with the first class of target locations and a second component associated with the second class of target locations, and the third indicator represents a first target location of the first class of target locations when the at least one component is the first component.

4. The resource management system of claim 2, wherein the memory stores additional instructions that, when executed by the controller, cause the resource management system to perform a set of operations comprising providing a prompt to a user via the user interface when the location determiner is sensed at a position proximate to one of the current location of the first component and the at least one target location, wherein the prompt is selected from a plurality of prompts, wherein each of the plurality of prompts is associated with one of the current location of the at least one component and a target location of the at least one target location of the at least one component.

5. The resource management system of claim 4, wherein the set of operations further comprises: providing a confirmation of pickup prompt when the first location is sensed proximate to the current location of the at least one component; and providing a confirmation of placement prompt when the first location is sensed proximate to the target location.

6. The resource management system of claim 1, further comprising a memory storing instructions that, when executed by the controller, cause the system to perform a set of operations comprising determining pre-staging positions for delivery of a bundle of a plurality of the at least one component.

7. The resource management system of claim 1, further comprising a database communicably coupled to the controller, wherein the database is operable to store component information, the component information comprising an inventory count of the at least one component and a location of the at least one component.

8. The resource management system of claim 7, wherein the at least one component includes a first class of components and a second class of components, and the component information includes a first inventory count of the first class of components and a second inventory count of the second class of components.

9. The resource management system of claim 7, further comprising a memory storing instructions that, when executed by the controller, cause the resource management system to perform a set of operations comprising providing instructions to the user interface to display a first indicator on the at least one screen layout representative of the first class of components and a second indicator on the at least one screen layout representative of the second class of components, wherein the at least one component includes a third class of components, and wherein the set of operations further comprises operating according to a first module associated with the first class of components and a second module associated with the third class of components.

10. The resource management system of claim 9, wherein the set of operations further comprises switching between the first module and the second module based upon a user input from a user.

11. The resource management system of claim 9, further comprising an optical sensor operably coupled to the controller, wherein the at least one screen layout is a first screen layout, and the set of operations further comprises operating according to a third module displaying a second screen layout including a view of the optical sensor.

12. The resource management system of claim 9, wherein the at least one screen layout is a first screen layout, and the set of operations further comprises operating according to a third module displaying a second screen layout, and the second screen layout includes viewing a path traveled by a remote vehicle.

13. The resource management system of claim 1, further comprising a memory storing instructions that, when executed by the controller, cause the resource management system to perform a set of operations comprising determining a pre-staging position and displaying the pre-staging position on the geographical map, and generating a route map on the geographical map for moving the at least one component between the current location of the at least one component and the at least one target location.

14. The resource management system of claim 13, wherein the set of operations further comprises determining a pre-staging position based on the current location of the at least one component and the at least one target location.

15. A method, comprising:
obtaining, at a controller, a geographical map from a remote network, the geographical map including a plurality of target locations for at least one component, the plurality of target locations comprises a first class of target locations for a first component of the at least one component and a second class of target locations for a second component of the at least one component;
obtaining, at the controller, a first communication from a remote communication device, the first communication comprising a component identifier indicating the at least one component is one of the first component and the second component;
determining, using a GPS sensor, a first location of a utility vehicle;
determining a first intended location of the first class of intended locations when the component identifier is the first component;
displaying on a display at least one screen layout, the at least one screen layout including:
(i) a marker indicating the first location;
(ii) a marker indicating a current location of the at least one component; and
(iii) a marker indicating the first target location.

16. The method of claim 15, wherein the at least one component is a solar assembly.

17. The method of claim 15, wherein the first communication comprises a status of the at least one component, and wherein the at least one screen layout further includes: (iv) the status of the at least one component.

18. The method of claim 15, further comprising determining a second target location of a second class of target locations when the component identifier is the second component.

19. The method of claim 15, further comprising generating a route between the current location of the at least one component and the first target location.

20. The method of claim 15, wherein the at least one screen layout includes at least one indicator representative of an inventory of the at least one component, and wherein the at least one indicator comprises a first indicator representative of a first inventory of the first class of components and a second indicator representative of a second inventory of the second class of components.
